(19) United States
(12) Patent Application Publication
(10) Pub. No.: US 2023/0394161 A1
(43) Pub. Date: Dec. 7, 2023

(54) DATA ASSURANCE IN THREE-DIMENSIONAL FORMING

(71) Applicant: Velo3D, Inc., Campbell, CA (US)

(72) Inventors: Benyamin Buller, Cupertino, CA (US); Tsvetan Tsvetanov, Santa Cruz, CA (US); Daniel Russel, Palo Alto, CA (US); Kyle Joseph Smith, Campbell, CA (US); Tasso Lappas, Pasadena, CA (US)

(21) Appl. No.: 18/144,278

(22) Filed: May 8, 2023

Related U.S. Application Data
(63) Continuation of application No. 18/098,304, filed on Jan. 18, 2023.
Application No. 18/098,304 is a continuation of application No. 17/956,961, filed on Sep. 30, 2022, now abandoned.
Application No. 17/956,961 is a continuation of application No. 17/844,928, filed on Jun. 21, 2022, now abandoned.
Application No. 17/844,928 is a continuation of application No. 17/695,130, filed on Mar. 15, 2022, now abandoned.
Application No. 17/695,130 is a continuation of application No. 17/541,552, filed on Dec. 3, 2021, now abandoned.
Application No. 17/541,552 is a continuation of application No. 17/411,588, filed on Aug. 25, 2021, now abandoned.
Application No. 17/411,588 is a continuation of application No. 17/322,060, filed on May 17, 2021, now abandoned.
Application No. 17/322,060 is a continuation of application No. 17/163,799, filed on Feb. 1, 2021, now abandoned.
Application No. 17/163,799 is a continuation of application No. 16/183,557, filed on Nov. 7, 2018, now abandoned.

(51) Int. Cl. G06F 21/60; B29C 64/393; B29C 64/153; B33Y 50/02; B33Y 30/00; G05B 19/4099; B33Y 10/00; B22F 10/25; B22F 10/28; B22F 10/80

(52) U.S. Cl. CPC G06F 21/608; B29C 64/393; B29C 64/153; B33Y 50/02; B33Y 30/00; G05B 19/4099; G06F 21/602; B33Y 10/00; B22F 10/25; B22F 10/28; B22F 10/80; G05B 2219/49007; G05B 2219/35134; B22F 12/41

(57) ABSTRACT

Provided herein are apparatuses, and non-transitory computer readable media regarding data assurance for instructions data utilized in forming at least one requested 3D object, and methods associated therewith. Data assurance may comprise (i) security, (ii) certification, (iii) validation, (iv) integrity, or (v) authentication. Data assurance may be implemented in a pre-formation environment and/or by a manufacturing device that forms the requested 3D object(s). The pre-formation environment may include one or more stages, and/or modules of a pre-formation environment (e.g., application).

### CROSS REFERENCE TO RELATED APPLICATIONS

This application is a continuation of U.S. patent application Ser. No. 18/098,304 filed Jan. 18, 2023, which is a continuation of U.S. patent application Ser. No. 17/956,961 filed Sep. 30, 2022, which is a continuation of U.S. patent application Ser. No. 17/844,928 filed Jun. 21, 2022, which is a continuation of U.S. patent application Ser. No. 17/695,130 filed Mar. 15, 2022, which is a continuation of U.S. patent application Ser. No. 17/541,552 filed Dec. 3, 2021, which is a continuation of U.S. patent application Ser. No. 17/411,588 filed Aug. 25, 2021, which is a continuation of U.S. patent application Ser. No. 17/322,060 filed May 17, 2021, which is a continuation of U.S. patent application Ser. No. 17/163,799 filed Feb. 1, 2021, which is a continuation of U.S. patent application Ser. No. 16/183,557 filed Nov. 7, 2018, which is entirely incorporated herein by reference.

### BACKGROUND

Three-dimensional (3D) forming (e.g., additive manufacturing) is a process for making a three-dimensional object of any shape from a design. The design may be in the form of a data source, such as an electronic data source, or may be in the form of a hard copy. The hard copy may be a two-dimensional representation of a 3D object. The data source may be an electronic 3D model. 3D forming (e.g., printing) may be accomplished through an additive process in which successive layers of material are laid down one on top of another. This process may be controlled (e.g., computer controlled, manually controlled, or both). A manufacturing device that is suitable for 3D forming can be an industrial robot.

3D forming can generate custom parts. A variety of materials can be used in a 3D printing process including elemental metal, metal alloy, ceramic, elemental carbon, or polymeric material. In some 3D printing processes (e.g., additive manufacturing), a first layer of hardened material is formed, and thereafter successive layers of hardened material are added one by one, wherein each new layer of hardened material is added on a pre-formed layer of hardened material, until the entire designed three-dimensional structure (3D object) is layer-wise materialized.

3D models may be generated with a computer aided design package, via a 3D scanner, or manually. The modeling process of preparing geometric data for 3D computer graphics may be similar to those of the plastic arts, such as sculpting or animating. 3D scanning is a process of analyzing and collecting digital data on the shape and appearance of a real object (e.g., real-life object). Based on these data, 3D models of the scanned object can be produced.

Many additive processes are currently available. They may differ in the manner layers are deposited and/or formed to create the materialized structure. They may vary in the material(s) that are used to generate the designed structure. Some methods melt and/or soften material to produce the layers. Examples of 3D printing methods include selective laser melting (SLM), selective laser sintering (SLS), direct metal laser sintering (DMLS), shape deposition manufacturing (SDM) or fused deposition modeling (FDM). Other methods cure liquid materials using different technologies such as stereo lithography (SLA). In the method of laminated object manufacturing (LOM), thin layers (made inter alia of paper, polymer, and/or metal) are cut to shape and joined together.

Sometimes, a (e.g., virtual) pre-formation environment provides a formation model to assist in preparing a requested 3D object for formation by one or more manufacturing devices. The pre-formation environment may comprise a software and/or computing environment. The pre-formation environment may provide a capability of displaying a (e.g., virtual) model of the requested 3D object. At times, a pre-formation environment may provide a capability of specifying various formation variable category options (e.g., process parameters) related to the formation of the requested 3D object, and/or various properties of the requested 3D object. The specification of the process parameter(s) may be to at least a surface and/or volumetric portion of the requested 3D object. The pre-formation environment may generate forming (e.g., printing) instructions data (e.g., for the requested 3D object) considering the specification of the process parameter(s). The forming instructions data may comprise commands for at least one manufacturing device to form the requested 3D object. The pre-formation environment may generate (e.g., layout) instructions data considering a build volume of a given manufacturing device that is suitable for forming the requested 3D object. The instructions data may be transmitted between the pre-formation environment and at least one manufacturing device that is suitable for 3D forming. The manufacturing device may be suitable for forming a plurality of 3D objects (e.g., in parallel, and/or serially).

Manufacturing devices may be configured to receive forming directions devoid of assurance. For example, non-assured printing instructions may comprise non-secured and non-encrypted (or unencrypted) forming directions for forming 3D objects. Some files associated with forming directions for forming a 3D object may be devoid of assurance such as protection (such as, e.g., encryption). The non-assured forming instruction may be compatible with a variety of manufacturing devices. The variety of manufacturing devices may be of various types, made by one or more entities (e.g., manufacturers), controlled by one or more entities, and/or owned by one or more entities. One or more modules that generate the non-assured forming instructions may be compatible with the variety of manufacturing devices.

At times, a lack of data security during the reading, writing, storing, and/or transmission of the instructions data (e.g., to the manufacturing device) may promote unauthorized access, and/or unauthorized tampering (e.g., data alteration), to a computer or electronic file containing or associated with forming instructions. A forming instructions related file may be any file related to the forming instructions and/or any file used in the generation of the forming instructions. Unauthorized access to the forming instructions related file(s) may lead to breach, damage and/or loss. For example, alteration to the forming instructions related file(s) may lead to generation of a defective 3D object, lead to material harm, and/or an unsafe operating condition of the manufacturing device. A defective 3D object may be unfit for its intended purpose. The material harm may be to the forming equipment, forming environment, forming facility, and/or personnel involved with the formation of the 3D object and/or disposed at a location in which the 3D object is formed.

### SUMMARY

At times, it is requested to provide data assurance (e.g., measures) to (e.g., at least a portion of) instructions data for forming at least a portion of a requested 3D object. Data assurance may comprise (i) security, (ii) certification, (iii) validation, (iv) integrity, or (v) authentication. Data security (e.g., a security level) may comprise encryption and/or error verification (e.g., detection). The instructions data may be generated in a pre-formation (e.g., virtual) environment. A pre-formation environment may comprise an application. A pre-formation environment may comprise one or more stages. In some embodiments, at least one (e.g., any) of the stages comprises one or more modules (e.g., software modules). A module may receive, process, and/or generate data related to the requested 3D object and/or to its formation. The instructions data may comprise forming instructions and/or layout instructions. The forming instructions may comprise commands for a manufacturing device to form a requested 3D object. The commands may be for control of at least one apparatus and/or component of the manufacturing device (e.g., manufacturing system). The layout instructions may comprise commands for a given manufacturing device to form at least one requested 3D object (i) according to a requested arrangement, (ii) according to a specified sequence with which one or more transforming agents (e.g., and/or generators thereof) are operated, and/or (iii) to have a requested marking (e.g., label). Data assurance may be implemented for (e.g., during) generation of instructions data, and/or for (e.g., during) the process (e.g., virtual and/or physical) formation of a requested 3D object. Data assurance may be implemented for a (e.g., first) file that comprises and/or is related to forming instructions. Data assurance may generate at least one assured file, e.g., for use by a manufacturing unit for forming at least one three-dimensional object. In some embodiments, data security may deter (e.g., restrain and/or prevent) unauthorized access to at least a portion of the instructions data. The security may comprise encryption of at least one forming instructions related file.

The operations of any of the methods, non-transitory computer readable media, and/or controller directions described herein can be in any order. At least two of the operation in any of the methods, non-transitory computer readable media, and/or controller(s) can be performed simultaneously.

In another aspect, a system for processing a first file associated with instructions for forming at least one three-dimensional object, comprises: computer memory configured to store the first file associated with the instructions for forming the at least one three-dimensional object; and one or more computer processors operatively coupled to the computer memory, wherein the one or more computer processors are individually or collectively programmed to: (i) assure the first file to yield at least one assured file usable by a manufacturing unit that is configured to form the at least one three-dimensional object, and (ii) output the at least one assured file for use by the manufacturing unit.

In some embodiments, to assure the first file comprises (i) to encrypt, (ii) to certify, (iii) to validate, (iv) to verify an integrity, or (v) to authenticate, the first file. In some embodiments, to output the at least one assured file comprises: to store the at least one assured file in a computer memory device. In some embodiments, to output the at least one assured file comprises: to transmit the at least one assured file to the manufacturing unit. In some embodiments, the manufacturing unit is configured to process the at least one assured file to print the at least one three-dimensional object using three-dimensional printing. In some embodiments, the manufacturing unit is configured to process the at least one assured file to form the at least one three-dimensional object. In some embodiments, to process the at least one assured file comprises to execute at least a portion of the at least one assured file. In some embodiments, the at least one assured file comprises at least one encrypted file, and wherein to process the at least one assured file comprises to decrypt at least a portion of the at least one encrypted file. In some embodiments, the computer memory comprises a decryption key. In some embodiments, the decryption key is configured to decrypt the at least the portion of the at least one encrypted file. In some embodiments, the decryption key is included in the output of the at least one assured file for use by the manufacturing unit. In some embodiments, the at least one assured file is usable by the manufacturing unit upon decryption. In some embodiments, the manufacturing unit comprises a manufacturing device or a manufacturing system. In some embodiments, the manufacturing unit comprises at least one computer operatively coupled with the manufacturing device and/or with the manufacturing system. In some embodiments, the manufacturing unit is a three-dimensional printer. In some embodiments, the computer memory comprises: a non-transitory computer-readable medium, an electrical circuit, or a socket. In some embodiments, the one or more computer processors are configured to generate the first file. In some embodiments, the computer memory is a first computer memory, wherein (a) the first computer memory or (b) a second computer memory that is operatively coupled to the first computer memory, comprises a pre-formation application that is operable to instruct the one or more computer processors to assure the first file. In some embodiments, the pre-formation application is a non-transitory computer readable media. In some embodiments, the pre-formation application comprises (i) at least one stage or (ii) at least one module; and wherein the (I) at least one stage, and/or (II) the at least one module, is operable to instruct the one or more computer processors to assure the first file. In some embodiments, the at least one module comprises operations associated with: (A) a requested three-dimensional object model, (B) a region of interest designation in the requested three-dimensional object model, (C) an estimation of a likelihood of formation failure of the requested three-dimensional object model, (D) a simulation of forming the requested three-dimensional object model, and/or (E) processing instructions for a forming apparatus to form the requested three-dimensional object model, wherein the requested three-dimensional object model is associated with a three-dimensional object of the at least one three-dimensional object. In some embodiments, instructions to assure the first file precede or occur during (a) a transmission from a first stage to a second stage, and/or (b) a transmission from a first module to a second module, of the pre-formation application. In some embodiments, the pre-formation application is further configured to implement an assurance scheme, wherein the assurance scheme comprises: (I) an encryption scheme, (II) a validation scheme, or (III) an integrity verification scheme. In some embodiments, the encryption scheme comprises a symmetric encryption scheme or an asymmetric encryption scheme. In some embodiments, at least a portion of the at least one assured file is encrypted. In some embodiments, the assurance scheme is associated with a given stage and/or a given module. In some embodiments, the assurance scheme is associated with operations performed in a given stage and/or a given module. In some embodiments, the system further comprises a first computing device and a second computing device, wherein the first computing device comprises a first computer processor of the one or more computer processors, and the second computing device comprises a second computer processor of the one or more computer processors. In some embodiments, a first portion of the first file is assured by the first computer processor to yield a first portion of the at least one assured file, and wherein a second portion of the first file is assured by the second computer processor to yield a second portion of the at least one assured file. In some embodiments, a first portion of the first file is generated by the first computer processor, and wherein a second portion of the first file is generated by the second computer processor. In some embodiments, the first computer processor and the second computer processor are operatively coupled by a communication component. In some embodiments, the communication component is configured to communicate by a wired or a wireless connection. In some embodiments, the communication component comprises an optical fiber, or electrical wire. In some embodiments, operatively coupled comprises a local connection. In some embodiments, operatively coupled comprises a network connection. In some embodiments, operatively coupled comprises a connection through a firewall. In some embodiments, the firewall is hosted by the first computing device or by the second computing device. In some embodiments, the firewall is hosted by a network that comprises the first computing device and/or the second computing device. In some embodiments, the network further comprises the manufacturing unit. In some embodiments, at least two of the first computing device, the second computing device, and the manufacturing unit are operatively coupled by a local connection. In some embodiments, at least two of the first computing device, the second computing device, and the manufacturing unit are operatively coupled by a remote connection. In some embodiments, remote is with respect to a location of the manufacturing unit. In some embodiments, remote is with respect to a location of the computer memory, or a location of the one or more computer processors. In some embodiments, the location of the computer memory is remote with respect to the location of the one or more computer processors. In some embodiments, the at least one assured file comprises an implementation of at least two security levels. In some embodiments, the at least one assured file comprises a first assured file and a second assured file, and wherein a first security level is implemented for the first assured file, and a second security level is implemented for the second assured file. In some embodiments, the pre-formation application comprises at least two stages and at least two modules, wherein a first security level is implemented in a first stage and/or in a first module, and a second security level is implemented in a second stage and/or in a second module. In some embodiments, operations of the first stage and/or of the first module precede operations of the second stage and/or of the second module. In some embodiments, to assure the first file comprises implementation of a first security level for a first portion of the at least one assured file, and implementation of a second security level for a second portion of the at least one assured file. In some embodiments, to assure the first file increases a (e.g., file) size and/or complexity of the at least one assured file, which increase is relative to the first file associated with the instructions. In some embodiments, the system further comprises an archive, wherein the archive comprises the first assured file and the second assured file. In some embodiments, the computer memory comprises the archive. In some embodiments, the archive comprises an archive file (e.g., compressed folder). In some embodiments, the at least one assured file comprises a specification of at least one of a plurality of process parameters. In some embodiments, the plurality of process parameters comprises one or more settings of the manufacturing unit. In some embodiments, the plurality of process parameters comprises (i) a characteristic of a transforming agent, (ii) a characteristic of a transforming agent generator, (iii) or a metrology. In some embodiments, the at least one assured file comprises layout instructions of the at least one three-dimensional object in a volume and/or above a platform, and wherein the manufacturing unit comprises the volume and/or the platform. In some embodiments, the layout instructions comprise commands for the manufacturing unit to form the at least one three-dimensional object (i) according to a requested arrangement, (ii) according to a specified sequence with which one or more transforming agents (e.g., and/or generators thereof) of the manufacturing unit are operated, and/or (iii) to have a requested marking (e.g., label). In some embodiments, the at least one assured file comprises authentication of an identity prior to use thereof to form the three-dimensional object. In some embodiments, the identity comprises an identity of an accessing party of the at least one assured file. In some embodiments, the identity of the accessing party comprises data associated with a (i) manufacturing party, (ii) owning party, (iii) controlling party, or (iv) operating party, of the manufacturing unit. In some embodiments, the identity of the accessing party comprises data associated with a (I) developing party, (II) owning party, (III) controlling party, or (IV) operating party, of a pre-formation application that processes the at least one assured file. In some embodiments, the identity is associated with the at least one assured file. In some embodiments, the at least one assured file comprises a representation of the identity. In some embodiments, the computer memory comprises the at least one assured file that comprises the representation of the identity, which representation of the identity is usable to authenticate the identity, wherein the representation of the identity is output in (ii). In some embodiments, to authenticate the identity comprises to verify the representation of the identity to be of a same manufacture, type, and/or model, of an (e.g., manufacturing) entity that is authorized to process the at least one assured file. In some embodiments, an authorized identity comprises a model (e.g., serial) number. In some embodiments, to authenticate the identity comprises to verify the representation of the identity to be of any manufacturing unit that is controlled, owned, and/or operated, by a same legal (e.g., business) entity, the legal entity being authorized to process the at least one assured file. In some embodiments, to authenticate the identity comprises to verify a pre-formation application that accesses the at least one assured file to be any pre-formation application that is of a same (i) type of, or (ii) version of, or (iii) that is developed by, a (e.g., development) entity that is authorized to process the at least one assured file. In some embodiments, to authenticate the identity comprises to verify a pre-formation application that accesses the at least one assured file to be any pre-formation application that is (i) owned, (ii) controlled, and/or (iii) operated, by a same legal (e.g., business) entity, the legal entity that is authorized to process the at least one assured file.

In another aspect, a method for processing a first file associated with instructions for forming at least one three-dimensional object, comprises: providing the first file associated 1 with the instructions for forming the at least one three-dimensional object; assuring the first file to yield at least one assured file usable by a manufacturing unit that is configured to form the at least one three-dimensional object; and outputting the at least one assured file for use by the manufacturing unit.

In some embodiments, the method is a computer-implemented method for three-dimensional printing, wherein the method comprises using at least one processor to perform (a), (b), and/or (c). In some embodiments, assuring the file comprises (i) encrypting, (ii) certifying, (iii) validating, (iv) verifying an integrity, or (v) authenticating, the file. In some embodiments, providing the first file comprises (i) receiving the first file or (ii) generating the first file. In some embodiments, outputting the at least one assured file comprises storing the at least one assured file in a computer memory device. In some embodiments, outputting the at least one assured file comprises transmitting the at least one assured file to the manufacturing unit. In some embodiments, the manufacturing unit is configured for processing the at least one assured file to form the at least one three-dimensional object. In some embodiments, providing the first file comprises executing the first file. In some embodiments, the at least one assured file is usable by the manufacturing unit upon decryption. In some embodiments, the manufacturing unit comprises a manufacturing device or a manufacturing system. In some embodiments, the manufacturing unit comprises at least one computer operatively coupled with the manufacturing device and/or with the manufacturing system. In some embodiments, the method further comprises authenticating an identity prior to processing the at least one assured file to form the at least one three-dimensional object. In some embodiments, authenticating the identity comprises authenticating an identity of an accessing party. In some embodiments, authenticating the identity of the accessing party comprises authenticating data associated with a (i) manufacturing party, (ii) owning party, (iii) controlling party, or (iv) operating party, of the manufacturing unit. In some embodiments, the method further comprises accessing the at least one assured file with a pre-formation application, wherein authenticating the identity of the accessing party comprises authenticating data associated with a (I) developing party, (II) owning party, (III) controlling party, or (IV) operating party, of the pre-formation application. In some embodiments, authenticating the identity comprises authenticating data associated with the at least one assured file. In some embodiments, the at least one assured file comprises a representation of the identity. In some embodiments, the representation of the identity is stored in a computer memory device. In some embodiments, authenticating the identity comprises verifying the manufacturing unit to be of a same manufacture, type, and/or model, of an (e.g., manufacturing) entity that is authorized for processing the at least one assured file. In some embodiments, authenticating an authorized identity comprises authenticating a model (e.g., serial) number of a (e.g., single) manufacturing unit. In some embodiments, authenticating the identity comprises verifying the manufacturing unit to be any manufacturing unit that is controlled, owned, and/or operated, by a same legal (e.g., business) entity, the legal entity (e.g., in the relevant jurisdiction) being authorized for processing the at least one assured file. In some embodiments, authenticating the identity comprises verifying a pre-formation application that accesses the at least one assured file to be any pre-formation application that is of a same (i) type, or (ii) version, or (iii) that is developed by an (e.g., development) entity that is authorized for processing the at least one assured file. In some embodiments, authenticating the identity comprises verifying a pre-formation application that accesses the at least one assured file to be any pre-formation application that is (i) owned, (ii) controlled, and/or (iii) operated, by a same legal (e.g., business) entity, the legal entity being authorized for processing the at least one assured file. In some embodiments, assuring the at least one file is performed by a pre-formation application. In some embodiments, the pre-formation application comprises (i) at least one stage or (ii) at least one module, and wherein an operation is performed during: the (I) at least one stage, and/or (II) at least one module, for assuring the first file. In some embodiments, the at least one module performs operations associated with: (A) a requested three-dimensional object model, (B) a region of interest designation in the requested three-dimensional object model, (C) an estimation of a likelihood of formation failure of the requested three-dimensional object model, (D) a simulation of forming the requested three-dimensional object model, and/or (E) processing instructions for the manufacturing unit to form the requested three-dimensional object model, wherein the requested three-dimensional object model is associated with a three-dimensional object of the at least one three-dimensional object. In some embodiments, assuring the first file is performed prior to or during: (a) a first stage to a second stage, and/or (b) a first module to a second module, of the pre-formation application. In some embodiments, assuring the first file is performed prior to or during: (a) a transmission from a first stage to a second stage, and/or (b) a transmission from a first module to a second module, of the pre-formation application. In some embodiments, assuring the first file is according to an assurance scheme, wherein the assurance scheme comprises implementing: (I) an encryption scheme, (II) a validation scheme, or (III) an integrity verification scheme. In some embodiments, implementing the encryption scheme comprises implementing: (a) a symmetric encryption scheme or (b) an asymmetric encryption scheme. In some embodiments, implementing the encryption scheme comprises implementing a first assurance scheme for the first stage and a second assurance scheme for the second stage. In some embodiments, the first assurance scheme and the second assurance scheme are different. In some embodiments, implementing the encryption scheme comprises implementing a same assurance scheme for the first module and the second module. In some embodiments, the assurance scheme is associated with a given stage and/or a given module. In some embodiments, the assurance scheme is associated with operations performed in a given stage and/or a given module. In some embodiments, assuring the first file comprises implementing at least two security level s. In some embodiments, implementing the at least two security levels comprises implementing a first security level in a first stage and/or a first module, and implementing a second security level in a second stage and/or a second module. In some embodiments, implementing the at least two security levels comprises performing operations of the first stage and/or of the first module prior to performing operations of the second stage and/or of the second module. In some embodiments, assuring the first file comprises implementing a first security level for a first portion of the at least one assured file, and implementing a second security level for a second portion of the at least one assured file. In some embodiments, the at least one assured file comprises a first assured file and a second assured file, wherein assuring the first file comprises implementing a first security level for the first assured file, and implementing a second security level for the second assured file. In some embodiments, the method further comprises storing the first assured file and the second assured file in an archive. In some embodiments, assuring the first file increases a (e.g., file) size and/or complexity of the at least one assured file, which increase is as compared to the first file associated with the instructions that is not assured. In some embodiments, the instructions comprise a specification of at least one of a plurality of process parameters. In some embodiments, the plurality of process parameters comprises one or more settings of the manufacturing unit. In some embodiments, the one or more settings comprise (a) a voltage setpoint, (b) a current setpoint, (c) a (e.g., activation) timing (e.g., duty cycle), or (d) a power (e.g., output), of an apparatus of the manufacturing unit. In some embodiments, the plurality of process parameters comprises (i) a characteristic of a transforming agent, (ii) a characteristic of a transforming agent generator, (iii) or a metrology. In some embodiments, the plurality of process parameters comprises (I) a position of a footprint of an energy beam at a target surface, (II) a power of an energy source that generates the energy beam, (III) a power density of the energy beam, (IV) a fluence of the energy beam, or (V) a focus of the footprint of the energy beam at the target surface. In some embodiments, the instructions comprise layout instructions for the manufacturing unit. In some embodiments, the layout instructions comprise commands for the manufacturing unit to form at least the at least one three-dimensional object (i) according to a requested arrangement, (ii) according to a specified sequence with which one or more transforming agents (e.g., and/or generators thereof) of the manufacturing unit are operated, or (iii) to have a requested marking (e.g., label). The method of claim 48, wherein the requested arrangement comprises a location of the at least one three-dimensional object within a build volume of the manufacturing unit.

In another aspect, a non-transitory computer-readable medium, comprises: machine-executable code that comprises commands according to any of the methods for processing the first file associated with instructions for forming at least one three-dimensional object as described herein (e.g., the methods described above).

In another aspect, a non-transitory computer-readable medium comprises machine-executable code that, upon execution by one or more processors, implement any of the methods (e.g., the methods described above) for processing at least one file associated with instructions for forming at least one three-dimensional object.

In another aspect, a computer-implemented method for processing at least one file associated with instructions for forming at least one three-dimensional object, comprises any of the methods (e.g., the methods described above).

In another aspect, a computer software product, comprises: a non-transitory computer-readable medium storing program instructions that comprise commands according to any of the methods for processing the first file associated with instructions for forming at least one three-dimensional object as described herein (e.g., the methods described above).

In another aspect, one or more computer-readable non-transitory storage media embodying software that comprises: commands according to any of the methods for processing the first file associated with instructions for forming at least one three-dimensional object as described herein (e.g., the methods described above).

In another aspect, a non-transitory computer-readable medium comprises machine-executable code that, upon execution by one or more processors, implement a method for processing a first file associated with instructions for forming at least one three-dimensional object, the machine-executable code comprises commands for: providing the first file associated with the instructions for forming the at least one three-dimensional object; assuring the first file to yield at least one assured file usable by a manufacturing unit that is configured to form the at least one three-dimensional object; and outputting the at least one assured file for use by the manufacturing unit.

In another aspect, a system for forming at least one three-dimensional object, comprises: a target surface configured to support the at least one three-dimensional object during formation; a transforming agent generator that is configured to generate a transforming agent that transforms a pre-transformed material to a transformed material to form at least a portion of the at least one three-dimensional object; and one or more controllers that are operatively coupled with the transforming agent generator, wherein the one or more controllers are collectively or individually configured to: (i) process at least one assured file to yield instructions for forming the at least one three-dimensional object; and (ii) using at least the instructions, direct the transforming agent generator to generate the transforming agent that transforms the pre-transformed material to the transformed material to form the at least the portion of the at least one three-dimensional object.

In some embodiments, to process the at least one assured file comprises to receive the at least one assured file. In some embodiments, to process the at least one assured file comprises to read at least a portion of the at least one assured file. In some embodiments, the at least one assured file comprises a file that is (i) encrypted, (ii) certified, (iii) validated, (iv) of a verified integrity, and/or (v) authenticated. In some embodiments, to process the at least one assured file comprises to decrypt at least a portion of at least one encrypted file. In some embodiments, the system further comprises a data storage unit that comprises a decryption key, wherein the one or more controllers are operatively coupled with the data storage unit, which one or more controllers are configured to use the decryption key to decrypt the at least the portion of the at least one encrypted file. In some embodiments, the data storage unit comprises a computer memory, a non-transitory computer-readable medium, an electrical circuit, or a socket. In some embodiments, to process the at least one assured file comprises to execute at least a portion of the at least one assured file. In some embodiments, usage of the instructions comprises executing the instructions. In some embodiments, the target surface is configured to indirectly or directly support the at least one three-dimensional object during formation. In some embodiments, the system further comprises at least one computer, wherein the one or more controllers are operatively coupled with the at least one computer. In some embodiments, the one or more controllers are further configured to authenticate an identity prior to (i) or (ii). In some embodiments, the identity comprises an identity of an accessing party. In some embodiments, the identity of the accessing party comprises data associated with a (i) manufacturing party, (ii) owning party, (iii) controlling party, and/or (iv) operating party, of the system. In some embodiments, the identity of the accessing party comprises data associated with a (I) developing party, (II) owning party, (III) controlling party, and/or (IV) operating party, of a pre-formation application that processes the at least one assured file. In some embodiments, the identity is associated with and/or embedded in the at least one assured file. In some embodiments, the at least one assured file comprises a representation of the identity. In some embodiments, the system further comprises a computer memory device that stores the representation of the identity, wherein the one or more controllers are operatively coupled with the computer memory device, and wherein the one or more controllers are configured to use the representation of the identity to authenticate the identity. In some embodiments, to authenticate the identity comprises to verify the representation of the identity to be of a same manufacture, type, and/or model, of an (e.g., manufacturing) entity that is authorized to process the at least one assured file. In some embodiments, an authorized identity comprises a model (e.g., serial) number. In some embodiments, to authenticate the identity comprises to verify the representation of the identity to be of any manufacturing unit that is controlled, owned, and/or operated, by a same legal (e.g., business) entity, which legal entity (e.g., in the relevant jurisdiction) is authorized to process the at least one assured file. In some embodiments, to authenticate the identity comprises to verify a pre-formation application that accesses the at least one assured file to be any pre-formation application that is of a same (i) type of, or (ii) version of, or (iii) that is developed by, a (e.g., development) entity that is authorized to process the at least one assured file. In some embodiments, the authenticating the identity comprises verifying a pre-formation application that accesses the at least one assured file to be any pre-formation application that is (i) owned, (ii) controlled, and/or (iii) operated, by a same legal (e.g., business) entity, the legal entity being authorized for processing the at least one assured file. In some embodiments, at least a portion of the at least one assured file is generated by a pre-formation application. In some embodiments, the system further comprises a non-transitory computer-readable medium operatively coupled with the one or more controllers, which non-transitory computer-readable medium is processing: (i) at least one stage and/or (ii) at least one module, of the pre-formation application, and wherein the non-transitory computer-readable medium generates the at least the portion of the at least one assured file. In some embodiments, the system further comprises a computer system that is operatively coupled with the one or more controllers, wherein the computer system comprises the non-transitory computer-readable medium. In some embodiments, the computer system comprises one or more processors, the one or more processors configured to perform at least one operation of the at least one stage or the at least one module. In some embodiments, the computer system is operatively coupled with the one or more controllers by a communication component. In some embodiments, the communication component is configured to communicate by a wired or a wireless connection. In some embodiments, the wired communication comprises optical fiber, or electrical wire. In some embodiments, the computer system is configured to communicate locally or over a network. In some embodiments, the at least one assured file comprises an assurance scheme, wherein the assurance scheme comprises (I) an encryption scheme, (II) a validation scheme, or (III) an integrity verification scheme. In some embodiments, the encryption scheme comprises a symmetric encryption scheme, or an asymmetric encryption scheme. In some embodiments, the encryption scheme comprises at least two security level s. In some embodiments, a first security level is implemented for a first portion of the at least one assured file, and a second security level is implemented for a second portion of the at least one assured file. In some embodiments, a first security level is implemented for a first encrypted file, and a second security level is implemented for a second encrypted file. In some embodiments, the system further comprises an archive, wherein the archive comprises the first encrypted file and the second encrypted file. In some embodiments, the instructions comprise a specification of at least one of a plurality of process parameters. In some embodiments, the plurality of process parameters comprises one or more system settings. In some embodiments, the one or more system settings comprise at least one characteristic of the (i) transforming agent and/or (ii) transforming agent generator. In some embodiments, the system further comprises a guidance system that is coupled with the transforming agent generator, wherein the guidance system is configured to direct the transforming agent toward the target surface, wherein the one or more controllers are operatively coupled with the guidance system, which one or more controllers are configured to direct the guidance system to move the generated transforming agent along a path. In some embodiments, the one or more system settings comprise (a) a voltage setpoint, (b) a current setpoint, (c) a (e.g., activation) timing (e.g., duty cycle), or (d) a power (e.g., output), of the transforming agent generator and/or the guidance system. In some embodiments, the plurality of process parameters comprises (I) a motion command of a guidance element (e.g., a scanner) of the guidance system, or (II) a power profile of a transforming agent generator. In some embodiments, the transforming agent is an energy beam, and wherein the plurality of process parameters comprises (I) a position of a footprint of an energy beam at a target surface, (II) a power of an energy source that generates the energy beam, (III) a power density of the energy beam, (IV) a fluence of the energy beam, or (V) a focus of the footprint of the energy beam at the target surface. In some embodiments, the instructions comprise layout instructions associated with the target surface. In some embodiments, the layout instructions comprise commands to form the at least one three-dimensional object (i) according to a requested arrangement, (ii) according to a specified sequence with which one or more transforming agents (e.g., and/or generators thereof) are operated, or (iii) to have a requested marking (e.g., label). In some embodiments, the requested arrangement comprises a location of the at least one three-dimensional object within a build volume of the manufacturing unit.

In another aspect, a method for forming at least one three-dimensional object, comprises: providing at least one assured file associated with instructions for forming the at least one three-dimensional object; computer processing the at least one assured file to yield the instructions in a computer memory; and using at least the instructions from the computer memory to form the at least one three-dimensional object.

In some embodiments, computer processing the at least one assured file comprises receiving the at least one assured file. In some embodiments, computer processing the at least one assured file comprises reading at least a portion of the at least one assured file. In some embodiments, the at least one assured file comprises a file that is: (i) encrypted, (ii) certified, (iii) validated, (iv) of a verified integrity, and/or (v) authenticated. In some embodiments, the at least one assured file comprises at least one encrypted file, and wherein computer processing the at least one assured file comprises decrypting at least a portion of the at least one encrypted file. In some embodiments, wherein computer processing comprises using a decryption key for decrypting the at least the portion of the at least one encrypted file. In some embodiments, computer processing the at least one assured file comprises executing at least a portion of the at least one assured file. In some embodiments, using the instructions comprises executing the instructions. In some embodiments, the method further comprises authenticating an identity prior to using the instructions to form the at least one three-dimensional object. In some embodiments, authenticating the identity comprises authenticating the identity of an accessing party. In some embodiments, authenticating the identity of the accessing party comprises authenticating data associated with a (i) manufacturing party, (ii) owning party, (iii) controlling party, or (iv) operating party, of a manufacturing unit that is configured to form the at least one three-dimensional object. In some embodiments, the method further comprises a pre-formation application that accesses the at least one assured file, wherein authenticating the identity of the accessing party comprises authenticating data associated with a (I) developing party, (II) owning party, (III) controlling party, or (IV) operating party, of the pre-formation application. In some embodiments, authenticating the identity authenticating data is associated with and/or embedded in the at least one assured file. In some embodiments, the at least one assured file comprises a representation of the identity. In some embodiments, the method further comprises storing the representation of the identity in a computer memory device. In some embodiments, authenticating the identity comprises verifying the manufacturing unit to be of a same manufacture, type, and/or model, of an (e.g., manufacturing) entity that is authorized for processing the at least one assured file. In some embodiments, authenticating an authorized identity comprises verifying a model (e.g., serial) number of a (e.g., single) manufacturing unit. In some embodiments, authenticating the identity comprises verifying the manufacturing unit to be any manufacturing unit that is controlled, owned, and/or operated, by a same legal (e.g., business) entity, the legal entity (e.g., in the relevant jurisdiction) being authorized for processing the at least one assured file. In some embodiments, authenticating the identity comprises verifying a pre-formation application that accesses the at least one assured file to be any pre-formation application that is of a same (i) type, or (ii) version, or (iii) that is developed by an (e.g., development) entity that is authorized for processing the at least one assured file. In some embodiments, authenticating the identity comprises verifying a pre-formation application that accesses the at least one assured file to be any pre-formation application that is (i) owned, (ii) controlled, and/or (iii) operated, by a same legal (e.g., business) entity, the legal entity being authorized for processing the at least one assured file. In some embodiments, providing the at least one assured file comprises (i) receiving the at least one assured file or (ii) generating the at least one assured file. In some embodiments, providing the at least one assured file comprises storing the at least one assured file in the computer memory or in another computer memory. In some embodiments, providing the at least one assured file comprises transmitting the at least one assured file to a manufacturing unit that is configured to form the at least one three-dimensional object. In some embodiments, computer processing the instructions is by the manufacturing unit to form the at least one three-dimensional object. In some embodiments, computer processing the instructions comprises executing the instructions. In some embodiments, the manufacturing unit comprises a manufacturing device or a manufacturing system. In some embodiments, the manufacturing unit comprises a three-dimensional printer. In some embodiments, the manufacturing unit comprises at least one computer operatively coupled with the manufacturing device and/or with the manufacturing system. In some embodiments, the at least one assured file is generated by a pre-formation application. In some embodiments, the pre-formation application comprises (i) at least one stage or (ii) at least one module, and wherein the at least one assured file is generated during an operation of the (I) at least one stage, and/or (II) at least one module. In some embodiments, the at least one assured file further comprises an assurance scheme, wherein the assurance scheme comprises (I) an encryption scheme, (II) a validation scheme, or (III) an integrity verification scheme. In some embodiments, the encryption scheme comprises a symmetric encryption scheme or an asymmetric encryption scheme. In some embodiments, the at least one assured file comprises at least two security level s. In some embodiments, a first security level is implemented for a first portion of the at least one assured file, and a second security level is implemented for a second portion of the at least one assured file. In some embodiments, the at least one assured file further comprises a first assured file and a second assured file, wherein a first security level is implemented for the first assured file, and a second security level is implemented for the second assured file. In some embodiments, the method further comprises an archive, wherein the archive comprises the first assured file and the second assured file. In some embodiments, the instructions comprise a specification of at least one of a plurality of process parameters. In some embodiments, the plurality of process parameters comprises one or more settings of a manufacturing unit that computer processes the instructions to form the at least one three-dimensional object. In some embodiments, one or more settings comprise at least one characteristic of a (i) transforming agent and/or (ii) a transforming agent generator, of the manufacturing unit. In some embodiments, the plurality of process parameters comprises (i) a characteristic of the transforming agent, (ii) a characteristic of the transforming agent generator, (iii) or a metrology. In some embodiments, the transforming agent is an energy beam, and wherein the plurality of process parameters comprises (I) a position of a footprint of the energy beam at a target surface, (II) a power of an energy source that generates the energy beam, (III) a power density of the energy beam, (IV) a fluence of the energy beam, or (V) a focus of the footprint of the energy beam at the target surface. In some embodiments, the one or more settings of the manufacturing unit comprise (a) a voltage setpoint, (b) a current setpoint, (c) a (e.g., activation) timing (e.g., duty cycle), or (d) a power (e.g., output), of an apparatus of the manufacturing unit. In some embodiments, the instructions comprise layout instructions, the method further comprises computer processing the layout instructions by the manufacturing unit to form the at least one three-dimensional object. In some embodiments, the layout instructions comprise commands causing the manufacturing unit to form at least the at least one three-dimensional object (i) according to a requested arrangement, (ii) according to a specified sequence with which one or more transforming agents (e.g., and/or generators thereof) of the manufacturing unit are operated, or (iii) to have a requested marking (e.g., label). In some embodiments, the requested arrangement comprises a location of the at least one three-dimensional object within a build volume of the manufacturing unit.

In another aspect, a non-transitory computer-readable medium, comprises: machine-executable code that comprises commands according to any of the methods described herein (e.g., the method described above) for forming at least one three-dimensional object.

In another aspect, a non-transitory computer-readable medium comprises machine-executable code that, upon execution by one or more processors, implement any of the methods (e.g., the methods described above) for processing at least one file associated with instructions for forming at least one three-dimensional object.

In another aspect, a computer-implemented method for processing at least one file associated with instructions for forming at least one three-dimensional object, comprises any of the methods (e.g., the methods described above).

In another aspect, a computer software product, comprises: a non-transitory computer-readable medium storing program instructions that comprise commands according to any of the methods described herein (e.g., the methods described above) for forming at least one three-dimensional object.

In another aspect, one or more computer-readable non-transitory storage media embodying software that comprises: commands according to any of the methods described herein (e.g., the methods described above) for forming at least one three-dimensional object.

In another aspect, a non-transitory computer-readable medium comprises machine-executable code that, upon execution by one or more processors, implement a method for forming at least one three-dimensional object, the machine-executable code comprises commands for: providing at least one assured file associated with instructions for forming the at least one three-dimensional object; computer processing the at least one assured file to yield the instructions in a computer memory; and using at least the instructions from the computer memory to form the at least one three-dimensional object.

Another aspect of the present disclosure provides a method that utilizes a system (and/or any component thereof) disclosed herein

Another aspect of the present disclosure provides a method that utilizes an apparatus (and/or any component thereof) disclosed herein.

Another aspect of the present disclosure provides a method that utilizes an apparatus comprising a controller. In some embodiments, the method effectuates one or more operations of the controller. For example, the method may include one or more operations directed by the controller. For example, the method may include controlling one or more apparatuses, systems, and/or components thereof that are controlled by the controller, e.g., in a manner directed by the controller.

Another aspect of the present disclosure provides a method that utilizes a computer system comprising one or more computer processors and at least one non-transitory computer-readable medium coupled thereto. In some embodiments, the method effectuates one or more operations by the one or more computer processors. For example, the method may include operations executed by the one or more computer processors. For example, the method may include one or more operations that are embodied as machine-executable code that is stored by the non-transitory computer-readable medium. For example, the method may include controlling operations of the computer system upon execution of the machine-executable code, e.g., by the one or more computer processors.

Another aspect of the present disclosure provides a method that utilizes at least one non-transitory computer-readable medium comprising machine-executable code. In some embodiments, the method effectuates one or more operations by one or more computer processors. For example, the method may include operations executed by the one or more computer processors. For example, the method may include controlling operations of the one or more computer processors upon execution of the machine-executable code, e.g., that is stored by the at least one non-transitory computer-readable medium.

Another aspect of the present disclosure provides a system for effectuating the methods disclosed herein.

Another aspect of the present disclosure provides an apparatus for effectuating the methods disclosed herein.

Another aspect of the present disclosure provides an apparatus comprising a controller that directs effectuating one or more operations in the method disclosed herein, wherein the controller is operatively coupled to the apparatuses, systems, and/or mechanisms that it controls to effectuate the method.

Another aspect of the present disclosure provides a computer system comprising one or more computer processors and a non-transitory computer-readable medium coupled thereto. The non-transitory computer-readable medium comprises machine-executable code that, upon execution by the one or more computer processors, implements any of the methods above or elsewhere herein.

Another aspect of the present disclosure provides an apparatus for printing one or more 3D objects comprises a controller that is programmed to direct a mechanism used in a 3D printing methodology to implement (e.g., effectuate) any of the method disclosed herein, wherein the controller is operatively coupled to the mechanism.

Another aspect of the present disclosure provides a computer software product, comprising a non-transitory computer-readable medium in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled to the mechanism.

Another aspect of the present disclosure provides a non-transitory computer-readable medium comprising machine-executable code that, upon execution by one or more computer processors, implements any of the methods disclosed herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “Fig.,” Figs.,” “FIG.” or “FIGs.” herein), of which:

FIG. 1 shows a schematic cross-sectional view of a three-dimensional (3D) printing system and its components;

FIG. 2A depicts a 3D object; and FIG. 2B depicts various 3D objects in a virtual environment;

FIG. 3 illustrates a flowchart;

FIG. 4 illustrates a flowchart;

FIG. 5 illustrates a flowchart;

FIG. 6 schematically illustrates an architecture that facilitates formation of one or more 3D objects;

FIG. 7 schematically illustrates an architecture that facilitates formation of one or more 3D objects;

FIG. 8A schematically illustrates an optical setup; FIG. 8B schematically illustrates an energy beam; and FIG. 8C schematically illustrates a control scheme;

FIG. 9 schematically illustrates a cross section in various layering planes;

FIG. 10A shows a cross sectional view of a 3D object with a support member; and

FIG. 10B schematically a horizontal view of a 3D object;

FIG. 11A schematically illustrates a cross section of a 3D object; FIG. 11B schematically illustrates an example of a 3D plane; and FIG. 11C schematically illustrates a cross section in portion of a 3D object;

FIG. 12 shows schematics of various vertical cross sectional views of different 3D objects, and a guiding circle;

FIG. 13 schematically illustrates a computer system; and

FIG. 14 schematically illustrates a computer system.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

The present disclosure provides apparatuses, systems and methods for providing security (such as, e.g., data security), certification, validation, integrity, and/or authentication in the formation of 3D objects. In some embodiments, the apparatuses, systems and methods enable implementation of data assurance to (e.g., at least a portion of) instructions data for forming at least a portion of a 3D object (e.g., a requested 3D object). Data assurance may comprise (i) security, (ii) certification, (iii) validation, (iv) integrity, or (v) authentication. Data security (e.g., a security level) may comprise encryption and/or error verification (e.g., detection). Data security may comprise cryptography. Implementation of such data assurance (e.g., measure) of the present disclosure may increase a complexity of a file (e.g., electronic file) as compared to a file devoid of such implementation of data assurance. The file may be readable by a computer media. The file may be an electronic file. The file may be related to the instructions data for forming a requested 3D object. Implementation of data assurance (e.g., measure) may increase a processing requirement (e.g., number of computing cycles) for accessing and/or modifying a file, e.g., that is related to the instructions data for forming a requested 3D object. The instructions data may be generated in a pre-formation (e.g., virtual) environment. A pre-formation environment may comprise an application (e.g., in the form of a non-transitory computer readable media). A pre-formation environment may comprise one or more stages (e.g., one or more phases, branches, or divisions). In some embodiments, at least one (e.g., any) of the stages (e.g., phases, branches, or divisions) comprises one or more modules (e.g., software modules). A module may receive, process, and/or generate data related to formation of the requested 3D object. The data assurance may be implemented by a pre-formation environment and/or a manufacturing device. The data assurance (e.g., security) may be implemented (e.g., provided) during a transfer from: at least one processor, stage, and/or module; to another. In some embodiments, at least one processor, stage, module, and/or manufacturing device, is operable to read (e.g., and decrypt) at least a portion of a secured (e.g., encrypted) file that is related to the instructions data for forming a requested 3D object.

In some embodiments, a file used in a module, a stage, and/or for forming the 3D object, may be part of a file architecture and/or network. The file may be part of a blockchain. The file may comprise a blockchain. The blockchain may include one or more (e.g., software) blocks. The blockchain may include one or more forks. At least two blocks in the blockchain may be linked. The linkage may utilize encryption at least in part. The linkage may comprise cryptography (e.g., comprising a cryptographic hash). The file and/or block may comprise a timestamp, cryptography, a transaction data, or any combination thereof. The cryptography may comprise a cryptographic hash function. The cryptography may comprise a function, a character, or a string. The cryptography may comprise a password or a username. The cryptographic string may be a hash value, message digest, digital fingerprint, and/or checksum. The function may be a one-way function. The cryptography may comprise a cyclic redundancy check, a non-cryptographic hash function, a universal hash function, a keyed cryptographic hash function, or unkeyed cryptographic hash function.

Terms such as “a,” “an,” and “the” are not intended to refer to only a singular entity, but may include the general class of which a specific example may be used for illustration. The terminology herein is used to describe specific embodiments of the invention, but their usage does not delimit the invention.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2.

The term “between” as used herein is meant to be inclusive unless otherwise specified. For example, between X and Y is understood herein to mean from X to Y.

The term “adjacent” or “adjacent to,” as used herein, includes ‘next to’, ‘adjoining’, ‘in contact with,’ and ‘in proximity to.’ In some instances, adjacent to may be ‘above’ or ‘below.’

The term “operatively coupled” or “operatively connected” refers to a first mechanism that is coupled (or connected) to a second mechanism to allow the intended operation of the second and/or first mechanism, including a first mechanism that is in signal communication with a second mechanism. The term “configured to” refers to an object or apparatus that is (e.g., structurally) configured to bring about an intended result.

Fundamental length scale (abbreviated herein as “FLS”) can refer to any suitable scale (e.g., dimension) of an object. For example, a FLS of an object may comprise a length, a width, a height, a diameter, a spherical equivalent diameter, or a diameter of a bounding sphere.

A “global vector” may be (a) a (e.g., local) gravitational field vector, (b) a vector in a direction opposite to the direction of a layerwise 3D object formation, and/or (c) a vector normal to a surface of a platform that supports the 3D object, in a direction opposite to the 3D object.

The phrase “a three-dimensional object” as used herein may refer to “one or more three-dimensional objects,” as applicable.

“Real time” as understood herein may be during at least a portion of the forming (e.g., printing) of a 3D object. Real time may be during a print operation. Real time may be during a formation (e.g., print) cycle. Real time may comprise during formation of: a 3D object, a layer of hardened material as a portion of the 3D object, a hatch line, a single-digit number of melt pools, or a melt pool.

The phrase “is/are structured,” or “is/are configured,” when modifying an article, refers to a structure of the article that is able to bring about the enumerated result.

The phrase “a target surface” may refer to (1) a surface of a build plane (e.g., an exposed surface of a material bed), (2) an exposed surface of a platform, (3) an exposed surface of a 3D object (or a portion thereof), (4) any exposed surface adjacent to an exposed surface of the material bed, platform, or 3D object, and/or (5) any targeted surface. Targeted may be by at least one energy beam.

At times, conceptualization of a 3D object (e.g., design) begins with a rendering. The rendering may comprise a drawing and/or a geometric model. The geometric model may be a corporeal (e.g., real-world) model, and/or a virtual (e.g., software) model. The model may comprise at least one geometry and/or topology of the 3D object. The 3D object may be formed by one or more manufacturing processes. The one or more manufacturing processes may be controlled (e.g., manually and/or automatically). In some embodiments, a manufacturing process comprises a plurality of forming instructions that specify (e.g., a sequence of) operations to generate a (e.g., requested) 3D object. The forming instructions may command at least one apparatus of a manufacturing device in the formation of the requested 3D object. The forming instructions may be embodied in software and/or firmware. At times, a pre-formation application (e.g., stored on a non-transitory computer-readable medium) generates forming instructions data for forming at least one requested 3D object. The forming instructions may be generated while considering the requested 3D object (e.g., geometric model). The manufacturing device, when supplied with starting materials and upon execution of the forming instructions, may generate (e.g., a physical, real world manifestation of) the requested 3D object.

Three-dimensional printing (also “3D printing”) generally refers to a process for generating a 3D object. The apparatuses, methods, controllers, and/or software described herein pertaining to generating (e.g., forming, or printing) a 3D object, pertain also to generating one or more 3D objects. For example, 3D printing may refer to sequential addition of material layers or joining of material layers (or parts of material layers) to form a 3D structure, in a controlled manner. The controlled manner may comprise manual or automated control. In the 3D printing process, the deposited material can be transformed (e.g., fused, sintered, melted, bound, or otherwise connected) to subsequently harden and/or form at least a portion of the 3D object. Fusing (e.g., sintering or melting) binding, or otherwise connecting the material is collectively referred to herein as transforming a pre-transformed material (e.g., powder material) into a transformed material. Fusing the material may include melting or sintering the material. Binding can comprise chemical bonding. Chemical bonding can comprise covalent bonding. Examples of 3D printing may include additive printing (e.g., layer by layer printing, or additive manufacturing). 3D printing may include layered manufacturing. 3D printing may include rapid prototyping. 3D printing may include solid freeform fabrication. The 3D printing may further comprise subtractive printing.

3D printing methodologies can comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition. 3D printing methodologies may comprise a binder that binds pre-transformed material (e.g., binding a powder). The binder may remain in the 3D object, or may be (e.g., substantially) absent from the 3D printing (e.g., due to heating, extracting, evaporating, and/or burning). 3D printing methodologies may differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

“Pre-transformed material,” as understood herein, is a material before it has been first transformed (e.g., once transformed) by an energy beam during the 3D printing process. The pre-transformed material may be a material that was, or was not, transformed prior to its use in the 3D printing process. The pre-transformed material may be a material that was partially transformed prior to its use in the 3D printing process. The pre-transformed material may be a starting material for the 3D printing process. The pre-transformed material may be liquid, solid, or semi-solid (e.g., gel). The pre-transformed material may be a particulate material. The particulate material may be a powder material. The powder material may comprise solid particles of material. The particulate material may comprise vesicles (e.g., containing liquid or semi-solid material). The particulate material may comprise solid or semi-solid material particles.

The FLS of the formed (e.g., printed) 3D object can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 millimeter (mm), 1.5 mm, 2 mm, 5 mm, 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 50 m, 80 m, 100 m or 1000 m. In some cases, the FLS of the printed 3D object may be between any of the afore-mentioned FLSs (e.g., from about 50 μm to about 1000 m, from about 120 μm to about 1000 m, from about 120 μm to about 10 m, from about 200 μm to about 1 m, or from about 150 μm to about 10 m).

In some instances, it is desired to control the manner in which at least a portion of a layer of hardened material is formed. The layer of hardened material may comprise a plurality of melt pools. In some instances, it may be desired to control one or more characteristics of the melt pools that form the layer of hardened material. The characteristics may comprise a depth of a melt pool, a microstructure, or the repertoire of microstructures of the melt pool. The microstructure of the melt pool may comprise the grain (e.g., crystalline and/or metallurgical) structure, or grain structure repertoire that makes up the melt pool. The grain structure may be referred to herein as microstructure.

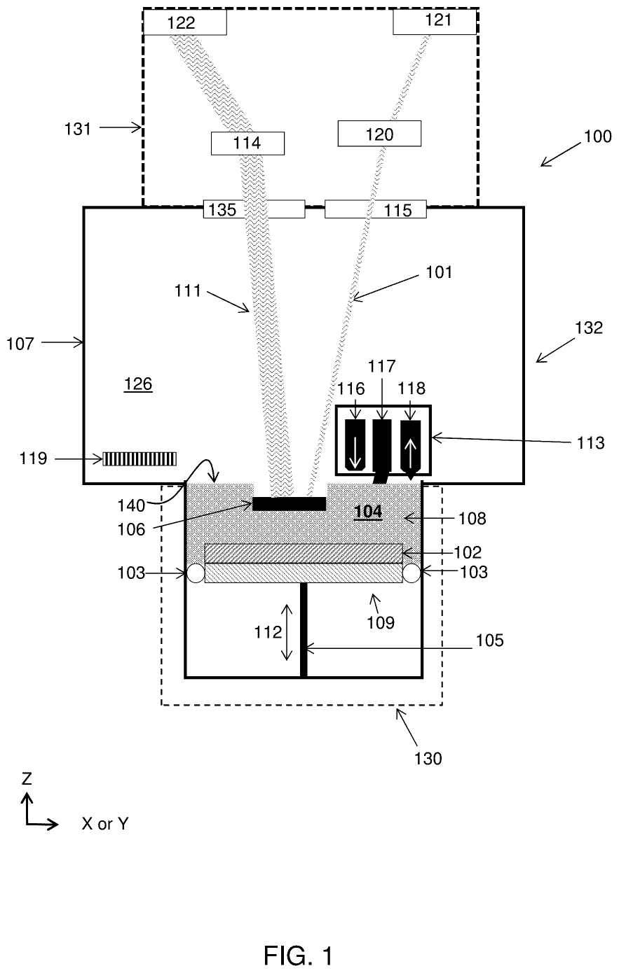

In some embodiments, transforming comprises heating at least a portion of a target surface (e.g., exposed surface of a material bed), and/or a previously formed area of hardened material using at least one energy beam. An energy source may generate the energy beam. The energy source may be a radiative energy source. The energy source may be a dispersive energy source (e.g., a fiber laser). The energy source may generate a substantially uniform (e.g., homogenous) energy stream. The energy source may comprise a cross section (e.g., or a footprint) having a (e.g., substantially) homogenous fluence. The energy beam may have a spot size (e.g., footprint or cross-section) on a target surface. The spot size may have a FLS. The energy generated for transforming a portion of material (e.g., pre-transformed or transformed) by the energy source will be referred herein as the “energy beam.” The energy beam may heat a portion of a 3D object (e.g., an exposed surface of the 3D object). The energy beam may heat a portion of the target surface (e.g., an exposed surface of the material bed, and/or a deeper portion of the material bed that is not exposed). A pre-transformed material may be directed to the target surface. The energy beam may heat a pre-transformed material on its way to the target surface. The target surface may comprise a pre-transformed material, a partially transformed material and/or a transformed material. The target surface may comprise a portion of the build platform, for example, a base (e.g., FIG. 1, 102). The target surface may comprise a (surface) portion of a 3D object. Heating by the energy beam may be substantially uniform across its footprint, e.g., on the target surface. In some embodiments, the energy beam takes the form of an energy stream emitted toward the target surface, e.g., in a step and repeat sequence (e.g., tiling sequence). In at least a portion of its trajectory with respect to the target surface, the energy beam may advance: continuously, in a pulsing sequence, or in a step-and repeat sequence. The energy source may comprise an array of energy sources, e.g., a light emitting diode (LED) array.

In some embodiments, the methods, systems, apparatuses, and/or software disclosed herein comprises controlling at least one characteristic of the layer of hardened material (or a portion thereof) that is at least a portion of the 3D object. The methods, systems, apparatuses, and/or software disclosed herein may comprise controlling the degree and/or manner of 3D object deformation. Control of 3D object deformation may comprise control of a direction and/or a magnitude of deformation. The control may be for at least a portion (e.g., all) of the 3D object. The control may be an in-situ and/or real-time control. The control may transpire during formation of the at least a portion of the 3D object. The control may comprise a closed loop or an open loop control scheme. The portion may be a surface, a melt pool, a plurality of melt pools, a layer, plurality (e.g., multiplicity) of layers, portion of a layer, and/or portion of a multiplicity of layers. The plurality of melt pools and/or layers may be of single digit or double digit. The layer of hardened material of the 3D object may comprise a plurality of melt pools. The layers' characteristics may comprise planarity, curvature, or radius of curvature of the layer (or a portion thereof). The characteristics may comprise the thickness of the layer (or a portion thereof). The characteristics may comprise the smoothness (e.g., planarity) of the layer (or a portion thereof).

In some embodiments, a 3D forming (e.g., printing, or print) cycle refers to printing one or more 3D objects in a 3D printer, e.g., using one printing instruction batch. A 3D printing cycle may include printing one or more 3D objects above a (single) platform and/or in a material bed. A 3D printing cycle may include printing all layers of one or more 3D objects in a 3D printer. On the completion of a 3D printing cycle, the one or more objects may be removed from the 3D printer (e.g., by sealing and/or removing the build module from the printer) in a removal operation (e.g., simultaneously). During a printing cycle, the one or more objects may be printed in the same material bed, above the same platform, with the same printing system, at the same time span, using the same forming (e.g., printing) instructions, or any combination thereof. A print cycle may comprise printing the one or more objects layer-wise (e.g., layer-by-layer). A layer may have a layer height. A layer height may correspond to a height of (e.g., distance between) an exposed surface of a (e.g., newly) formed layer with respect to a (e.g., top) surface of a prior-formed layer. In some embodiments, the layer height is (e.g., substantially) the same for each layer of a print cycle (e.g., within a material bed). In some embodiments, at least two layers of a print cycle within a material bed have different layer heights. A printing cycle may comprise a collection (e.g., sum) of print operations. A print operation may comprise a print increment (e.g., deposition of a layer of pre-transformed material, and transformation of a portion thereof to form at least a portion of the 3D object). A forming (e.g., printing) cycle (also referred to herein as “build cycle”) may comprise one or more forming (e.g., formation) laps. A forming lap may comprise the process of forming a formed (e.g., printed) layer in a layerwise deposition to form the 3D object. The printing-lap may be referred to herein as “build-lap” or “print-increment”. In some embodiments, a printing cycle comprises one or more printing laps. The 3D printing lap may correspond with (i) depositing a (planar) layer of pre-transformed material (e.g., as a portion of a material bed) above a platform, and (ii) transforming at least a portion of the pre-transformed material (e.g., by a transforming agent such as at least one energy beam) to form a layer of a 3D objects above the platform (e.g., in the material bed). The printing cycle may comprise a plurality of laps to layerwise form the 3D object. The 3D printing cycle may correspond with (I) depositing a pre-transformed material toward a platform, and (II) transforming at least a portion of the pre-transformed material (e.g., by a transforming agent such as at least one energy beam) at or adjacent to the platform to form one or more 3D objects above the platform at the same time-window. An additional sequential layer (or portion thereof) can be added to a previous layer of a 3D object by transforming (e.g., fusing and/or melting) a fraction of pre-transformed material that is introduced (e.g., as a pre-transformed material stream) to the prior-formed layer of transformed material. At times, the platform supports a plurality of material beds and/or a plurality of 3D objects. One or more 3D objects may be formed in a single material bed during a printing cycle (e.g., having one or more print jobs). The transformation may connect transformed material of a given layer (e.g., formed during a printing lap) to a previously formed 3D object portion (e.g., of a previous printing lap). The transforming operation may comprise utilizing a transforming agent (e.g., an energy beam or a binder) to transform the pre-transformed (or re-transform the transformed) material. In some instances, the transforming agent is utilized to transform at least a portion of the material bed (e.g., utilizing any of the methods described herein).

In some embodiments, at least one (e.g., each) energy source of the 3D forming (e.g., printing) system is able to transform (e.g., print) at a throughput of at least about 6 cubic centimeters of material per hour (cc/hr), 12 cc/hr, 35 cc/hr, 50 cc/hr, 120 cc/hr, 480 cc/hr, 600 cc/hr, 1000 cc/hr, or 2000 cc/hr. The at least one energy source may print at any rate within a range of the aforementioned values (e.g., from about 6 cc/hr to about 2000 cc/hr, from about 6 cc/hr to about 120 cc/hr, or from about 120 cc/hr to about 2000 cc/hr).

In some embodiments, the transforming agent is dispensed through a material dispenser (e.g., binding dispenser). The dispenser may be any dispenser disclosed herein. The dispenser can be controlled (e.g., manually and/or automatically). The automatic control may be using one or more controllers that are operatively coupled to at least one component of the dispenser. The control may be before, during, and/or after the forming operation (e.g., printing). The dispenser may be translated using an actuator. The translation of the dispenser can utilize a scanner (e.g., an XY-stage). In some embodiments, the at least one 3D object is printed using a plurality of dispensers. In some embodiments, at least two dispensers dispense the same type of binder (e.g., comprising a binding agent). In some embodiments, at least two dispensers each dispense a different type of binder. In some embodiments, a binding agent is a polymer or resin. The binding agent can be organic or inorganic. The binding agent can be carbon based or silicon based.

In some embodiments, the energy source is movable such that it can translate across (e.g., laterally) the top surface of the material bed, e.g., during the printing. The energy beam(s) and/or energy source(s) can be moved via at least one guidance system. The guidance system may comprise a scanner. The scanner may comprise a galvanometer scanner, a moving (e.g., rotating) polygon, a mechanical-stage (e.g., X-Y-stage), a piezoelectric device, a gimbal, or any combination of thereof. The scanner may comprise a mirror. The scanner may comprise a modulator. The scanner may comprise a polygonal mirror. The scanner can be the same scanner for two or more transforming agents or transforming agent generators (e.g., energy source or binder dispenser). At least two (e.g., each) transforming agents or transforming agent generators may have a separate scanner. At least two scanners may be operably coupled with a single transforming agents or transforming agent generators. The systems and/or apparatuses disclosed herein may comprise one or more shutters (e.g., safety shutters). The energy source(s) may project energy using a DLP modulator, a one-dimensional scanner, a two-dimensional scanner, or any combination thereof. The transforming agent generator(s) can be stationary or translatable. The transforming agent generator(s) can translate vertically, horizontally, or in an angle (e.g., planar or compound angle).

A guidance system and/or an energy source may be controlled manually and/or by at least one controller. For example, at least two guidance systems may be directed by the same controller. For example, at least one guidance system may be directed by its own (e.g., unique) controller. A plurality of controllers may be operatively coupled to each other, to the guidance system(s) (e.g., scanner(s)), and/or to the energy source(s). At least two of a plurality of energy beams may be directed towards the same position at the target surface, or to different positions at the target surface. The one or more guidance systems may be positioned at an angle (e.g., tilted) with respect to the target surface. The one or more guidance systems may be positioned parallel to the target surface. One or more sensors may be disposed adjacent to the target surface. The one or more sensors may detect (i) a position and/or (ii) an effect, of a transforming agent (e.g., at a target surface). The at least one guidance system may direct a position and/or a path of a transforming agent, considering a feedback from the one or more sensors. At least one of the one or more sensors may be disposed in an indirect view of the target surface. At least one of the one or more sensors may be disposed in a direct view of the target surface (e.g., a camera viewing the target surface). The one or more sensors may be configured to have a field of view of at least a portion of the target surface (e.g., an exposed surface of the material bed).

At times, the energy source(s) are modulated. The energy (e.g., beam) emitted by the energy source can be modulated. The modulator can comprise an amplitude modulator, a phase-modulator, or polarization modulator. The modulation may alter the intensity of the energy beam. The modulation may alter the current supplied to the energy source (e.g., direct modulation). The modulation may affect (e.g., alter) the energy beam (e.g., external modulation such as external light modulator). The modulator can comprise an aucusto-optic modulator or an electro-optic modulator. The modulator can comprise an absorptive modulator or a refractive modulator. The modulation may alter the absorption coefficient of the material that is used to modulate the energy beam. The modulator may alter the refractive index of the material that is used to modulate the energy beam.

The scanner can be included in an optical system that is configured to direct energy from the energy source to a predetermined position on the (target) surface (e.g., exposed surface of the material bed). At least one controller can be programmed to control a trajectory of the energy source(s) with the aid of the optical system. The controller can regulate a supply of energy from the energy source to the pre-transformed material (e.g., at the target surface) to form a transformed material. The optical system may be enclosed in an optical enclosure. Examples of an optical enclosure and/or system can be found in Patent Application serial number PCT/US17/64474, titled “OPTICS, DETECTORS, AND THREE-DIMENSIONAL PRINTING” that was filed Dec. 4, 2017, or in Patent Application serial number PCT/US18/12250, titled “OPTICS IN THREE-DIMENSIONAL PRINTING” that was filed Jan. 3, 2018, each of which is incorporated herein by reference in its entirety.

The energy beam (e.g., transforming energy beam) may comprise a Gaussian energy beam. The energy beam may have any cross-sectional shape comprising an ellipse (e.g., circle), or a polygon. The energy beam may have a cross section (e.g., at an intersection of the energy beam on a target surface) with a FLS of at least about 20 μm, 50 μm, 75 μm, 100 μm, 150 μm, 200 μm or 250 μm, 0.3 millimeters (mm), 0.4 mm, 0.5 mm, 0.8 mm, 1 mm, 1.5 mm, 2 mm, 2.5 mm, 3 mm, 3.5 mm, 4 mm, 4.5 mm, or 5 mm. The cross section of the energy beam may be any value of the afore-mentioned values (e.g., from about 50 μm to about 250 μm, from about 50 μm to about 150 μm, from about 150 μm to about 250 μm, from about 0.2 mm to about 5 mm, from about 0.2 mm to about 2.5 mm, or from about 2.5 mm to about 5 mm). The FLS may be measured at full width half maximum intensity of the energy beam. The FLS may be measured at 1/e² intensity of the energy beam. In some embodiments, the energy beam is a focused energy beam at the target surface. In some embodiments, the energy beam is a defocused energy beam at the target surface. The energy profile of the energy beam may be (e.g., substantially) uniform (e.g., in the energy beam's cross-sectional area that impinges on the target surface). The energy profile of the energy beam may be (e.g., substantially) uniform during an exposure time (e.g., also referred to herein as a dwell time). The exposure time (e.g., at the target surface) of the energy beam may be at least about 0.1 milliseconds (ms), 0.5 ms, 1 ms, 10 ms, 50 ms, 100 ms, 200 ms, 500 ms, 1000 ms, 2500 ms, or 5000 ms. The exposure time may be between any of the above-mentioned exposure times (e.g., from about 0.1 ms to about 5000 ms, from about 0.1 ms to about 1000 ms, or from about 1000 ms to about 5000 ms). In some embodiments, the energy beam is configured to be continuous or non-continuous (e.g., pulsing). In some embodiments, at least one energy source can provide an energy beam having an energy density of at least about 50 joules/cm² (J/cm²), 100 J/cm², 200 J/cm², 300 J/cm², 400 J/cm², 500 J/cm², 600 J/cm², 700 J/cm², 800 J/cm², 1000 J/cm², 1500 J/cm², 2000 J/cm², 2500 J/cm², 3000 J/cm², 3500 J/cm², 4000 J/cm², 4500 J/cm², or 5000 J/cm². The at least one energy source can provide an energy beam having an energy density of at most about 50 J/cm², 100 J/cm², 200 J/cm², 300 J/cm², 400 J/cm², 500 J/cm², 600 J/cm², 700 J/cm², 800 J/cm², 1000 J/cm², 500 J/cm², 1000 J/cm², 1500 J/cm², 2000 J/cm², 2500 J/cm², 3000 J/cm², 3500 J/cm², 4000 J/cm², 4500 J/cm², or 5000 J/cm². The at least one energy source can provide an energy beam having an energy density of a value between the afore-mentioned values (e.g., from about 50 J/cm² to about 5000 J/cm², from about 50 J/cm² to about 2500 J/cm², or from about 2500 J/cm² to about 5000 J/cm²). In some embodiments, the power density (e.g., power per unit area) of the energy beam is at least about 100 Watts per millimeter square (W/mm²), 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², 7000 W/mm², 8000 W/mm², 9000 W/mm², 10000 W/mm², 20000 W/mm², 30000 W/mm², 50000 W/mm², 60000 W/mm², 70000 W/mm², 80000 W/mm², 90000 W/mm², or 100000 W/mm². The power density of the energy beam may be any value between the aforementioned values (e.g., from about 100 W/mm² to about 100000W/mm², about 100 W/mm² to about 1000 W/mm², or about 1000 W/mm² to about 10000 W/mm², from about 10000 W/mm² to about 100000 W/mm², from about 10000 W/mm² to about 50000 W/mm², or from about 50000 W/mm² to about 100000 W/mm²). The energy beam may emit energy stream towards the target surface in a step and repeat sequence. The target surface may comprise an exposed surface of an energy beam, a previously formed 3D object portion, or a platform.

At times, an energy source provides power at a peak wavelength. For example, an energy source can provide electromagnetic energy at a peak wavelength of at least about 100 nanometer (nm), 400 nm, 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. An energy beam can provide energy at a peak wavelength between any value of the afore-mentioned peak wavelength values (e.g., from about 100 nm to about 2000 nm, from about 100 nm to about 1000 nm, or from about 1000 nm to about 2000 nm). The energy source (e.g., laser) may have a power of at least about 0.5 Watt (W), 1 W, 5 W, 10 W, 50 W, 100 W, 250 W, 500 W, 1000 W, 2000 W, 3000 W, or 4000 W. The energy source may have a power between any value of the afore-mentioned laser power values (e.g., from about 0.5 W to about 4000 W, from about 0.5 W to about 1000 W, or from about 1000 W to about 4000 W).

At times, an energy beam is translated relative to a surface (e.g., target surface) at a given rate (e.g., a scanning speed), e.g., in a trajectory. The scanning speed of the energy beam may be at least about 50 millimeters per second (mm/sec), 100 mm/sec, 500 mm/sec, 1000 mm/sec, 2000 mm/sec, 3000 mm/sec, 4000 mm/sec, or 50000 mm/sec. The scanning speed of the energy beam may be any value between the aforementioned values (e.g., from about 50 mm/sec to about 50000 mm/sec, from about 50 mm/sec to about 3000 mm/sec, or from about 3000 mm/sec to about 50000 mm/sec). The energy beam may be continuous or non-continuous (e.g., pulsing). The energy profile of the energy beam may be (e.g., substantially) uniform during the exposure time (e.g., also referred to herein as dwell time). The exposure time (e.g., at the target surface) of the energy beam may be at least about 0.1 milliseconds (ms), 0.5 ms, 1 ms, 10 ms, 50 ms, 100 ms, 500 ms, 1000 ms, 2500 ms, or 5000 ms. The exposure time may be any value between the above-mentioned exposure times (e.g., from about 0.1 ms to about 5000 ms, from about 0.1 ms to about 1000 ms, or from about 1000 ms to about 5000 ms). The exposure time (e.g., irradiation time) may be the dwell time. The dwell time may be at least 1 minute, or 1 hour.

In some embodiments, the at least one 3D object is formed (e.g., printed) using a plurality of energy beams and/or energy sources. At times, at least two transforming agents (e.g., energy sources (e.g., producing at least two energy beams)) may have at least one characteristic value in common with each other. At times, the at least two energy sources may have at least one characteristic value that is different from each other. Characteristics of the transforming agent may comprise transformation density (or transformation strength), trajectory, FLS of footprint on the target surface, hatch spacing, scan speed, or scanning scheme. The transformation density may refer to the volume or weight of material transformed in a given time by the transforming agent. The FLS of footprint on the target surface may refer to the FLS of the energy beam on the target surface, of a binder stream dispensed on the target surface. Characteristics of the energy beam may comprise wavelength, power density, amplitude, trajectory, FLS of footprint on the target surface, intensity, energy, energy density, fluence, Andrew Number, hatch spacing, scan speed, scanning scheme, or charge. The scanning scheme may comprise continuous, pulsed or tiled scanning scheme. The charge can be electrical and/or magnetic charge. Andrew number is proportional to the power of the irradiating energy over the multiplication product of its velocity (e.g., scan speed) by a hatch spacing. The Andrew number is at times referred to as the area filling power of the irradiating energy. In some embodiments, at least two of the energy source(s) and/or beam(s) can be translated at different rates (e.g., velocities).

FIG. 1 shows an example of a 3D forming (e.g., 3D printing) system 100 and apparatuses, including a (e.g., first) energy source 121 that emits a (e.g., first) energy beam 101 and a (e.g., second) energy source 122 that emits a (e.g., second overlapping) energy beam 111. The 3D printing system may also be referred to herein as “3D printer.” In the example of FIG. 1 the energy from energy source 121 travels through an (e.g., first) optical system 120 (e.g., comprising a scanner) and an optical window 115 to be incident upon a target surface 140 within an enclosure 126 (e.g., comprising an atmosphere). The enclosure can comprise one or more walls that enclose the atmosphere. The target surface may comprise at least one layer of pre-transformed material (e.g., FIG. 1, 108) that is disposed adjacent to a platform (e.g., FIG. 1, 109). Adjacent can be above. In some embodiments, an elevator shaft (e.g., FIG. 1, 105) is configured to move the platform (e.g., vertically; FIG. 1, 112). The enclosure (e.g., 132) may including sub-enclosures comprising an optical chamber (e.g., 131), a processing chamber (e.g., 107), and a build module (e.g., 130). The platform may be separated from one or more walls (e.g., side walls) of the build module by a seal (e.g., FIG. 1, 103). The guidance system of the energy beam may comprise an optical system. FIG. 1 shows the energy from the energy source 122 travels through an optical system 114 (e.g., comprising a scanner) and an optical window 135 to impinge (e.g., be incident) upon the target surface 140. The energy from the (e.g., plurality of) energy source(s) may be directed through the same optical system and/or the same optical window. At times, energy (e.g., beam) from the same energy source is directed to form a plurality of energy beams by one or more optical systems. The target surface may comprise a (e.g., portion of) hardened material (e.g., FIG. 1, 106) formed via transformation of material within a material bed (e.g., FIG. 1, 104). In the example of FIG. 1, a layer forming device 113 includes a (e.g., powder) dispenser 116, a leveler 117, and material removal mechanism 118. During printing, the 3D object (e.g., and the material bed) may be supported by a (e.g., movable) platform, which platform may comprise a base (e.g., FIG. 1, 102). The base may be detachable (e.g., after the printing). A hardened material may be anchored to the base (e.g., via supports and/or directly), or non-anchored to the base (e.g., floating anchorlessly in the material bed, e.g., suspended in the material bed). An optional thermal control unit (e.g., FIG. 1, 119) can be configured to maintain a local temperature (e.g., of the material bed and/or atmosphere). In some cases, the thermal control unit comprises a (e.g., passive or active) heating member. In some cases, the thermal control unit comprises a (e.g., passive or active) cooling member. The thermal control unit may comprise or be operatively coupled to a thermostat. The thermal control unit can be provided inside of a region where the 3D object is formed or adjacent to (e.g., above) a region (e.g., within the processing chamber atmosphere) where the 3D object is formed. The thermal control unit can be provided outside of a region (e.g., within the processing chamber atmosphere) where the 3D object is formed (e.g., at a predetermined distance).

In some embodiments, the target surface is detected by a detection system. The detection system may comprise at least one sensor. The detection system may comprise a light source operable to illuminate a portion of the 3D forming (e.g., printing) system enclosure (e.g., the target surface). The light source may be configured to illuminate onto a target surface. The illumination may be such that objects in the field of view of the detector are illuminated with (e.g., substantial) uniformity. For example, sufficient uniformity may be uniformity such that at most a threshold level (e.g., 25 levels) of variation in grayscale intensity exists (for objects), across the build plane. The illumination may comprise illuminating a map of varied light intensity (e.g., a picture made of varied light intensities). Examples of illumination apparatuses include a lamp (e.g., a flash lamp), a LED, a halogen light, an incandescent light, a laser, or a fluorescent light. The detection system may comprise a camera system, CCD, CMOS, detector array, a photodiode, or line-scan CCD (or CMOS). Examples of a control system, detection system and/or illumination can be found in U.S. patent application Ser. No. 15/435,090, titled “ACCURATE THREE-DIMENSIONAL PRINTING” that was filed Feb. 16, 2017, which is incorporated herein by reference in its entirety.

The 3D printer may include an enclosure (e.g., FIG. 1, 132). The enclosure can include sub-enclosures. For example, the enclosure can include a processing chamber (e.g., FIG. 1, 107) and a build module (e.g., FIG. 1, 130). The sub-enclosures may be configured to be coupled and decoupled from one another. In some embodiments, the build module and the processing chamber are separate and/or inseparable. In some embodiments, the optical chamber and the processing chamber are separate and/or inseparable. The build module and processing chamber may (e.g., controllably) engage and disengage. The separate build module, optical chamber, and processing chamber may each comprise a separate atmosphere. Any of these atmospheres may be different than the ambient atmosphere outside of the build module, optical chamber, and/or processing chamber. For example, any of these atmospheres may be inert (e.g., comprise argon, or nitrogen). Any of these atmospheres may comprise a species that is reactive with the transformed and/or pre-transformed material during the printing, in an amount below a (e.g., reactive) threshold. The species may comprise water or oxygen. The build module, optical chamber, and/or processing chamber may engage to form a gas tight seal (e.g., hermetic seal). The separate build module, optical chamber, and/or processing chamber may (e.g., controllably) merge. For example, the atmospheres of the build module and processing chamber may merge. In the example of FIG. 1, the 3D printing system comprises a processing chamber which comprises the energy beam and the target surface (e.g., comprising the atmosphere in the interior volume of the processing chamber, e.g., 126). At times, at least one build module may be disposed in the enclosure that comprises the processing chamber (having an interior volume 126 comprising an atmosphere). At times, at least one build module may engage with the processing chamber (e.g., FIG. 1) (e.g., 107). At times, a plurality of build modules may be coupled to the enclosure. The build module and/or optical chamber may reversibly engage with (e.g., couple to) the processing chamber. The engagement of the build module and/or optical chamber may be before or after the 3D printing. The engagement of the build module and/or optical chamber with the processing chamber may be controlled (e.g., by a controller, such as a microcontroller). Examples of a controller and any of its components can be found in: patent application serial number PCT/US17/18191, titled “ACCURATE THREE-DIMENSIONAL PRINTING” that was filed on Feb. 16, 2017; U.S. patent application Ser. No. 15/435,065, titled “ACCURATE THREE-DIMENSIONAL PRINTING” that was filed on Feb. 16 2017; and/or patent application serial number EP17156707, titled “ACCURATE THREE-DIMENSIONAL PRINTING” that was filed on Feb. 17, 2017; each of which is incorporated herein by reference in its entirety. The controller may direct the engagement and/or dis-engagement of the build module and/or of the optical chamber. The control may comprise automatic and/or manual control. The engagement of the build module with the processing chamber may be reversible. In some embodiments, the engagement of the build module with the processing chamber may be non-reversible (e.g., stable, or static). The FLS (e.g., width, depth, and/or height) of the processing chamber can be at least about 50 millimeters (mm), 60 mm, 70 mm, 80 mm, 90 mm, 100 mm, 200 mm, 250 mm, 280 mm, 400 mm, 500 mm, 800 mm, 900 mm, 1 meter (m), 2 m, or 5 m. The FLS of the processing chamber can be at most about 50 millimeters (mm), 60 mm, 70 mm, 80 mm, 90 mm, 100 mm, 200 mm, 250 mm, 400 mm, 500 mm, 800 mm, 900 mm, 1 meter (m), 2 m, or 5 m. The FLS of the processing chamber can be between any of the afore-mentioned values (e.g., 50 mm to about 5 m, from about 250 mm to about 500 mm, or from about 500 mm to about 5 m). The build module, optical chamber, and/or processing chamber may comprise any (e.g., be formed of a) material comprising an organic (e.g., polymer or resin) or inorganic material (e.g., a salt, mineral, acid, base, or silicon-based compound). The build module and/or processing chamber may comprise any material disclosed herein (e.g., elemental metal, metal alloy, an allotrope of elemental carbon, ceramic, or glass).

At times, a pre-formation application (e.g., stored on a non-transitory computer-readable medium) generates instructions data for forming at least one requested 3D object (e.g., by a suitable manufacturing device). The instructions data may comprise instructions for control of at least one characteristic of a transforming agent. Control of at least one characteristic of a transforming agent may be for effecting at least one (e.g., specified) process parameter. Characteristics of the transforming agent may comprise: (I) a transforming agent flux (e.g., energy beam fluence), (II) transforming agent motion (e.g., energy beam position, velocity and/or acceleration), (III) a transforming agent intensity (e.g., energy beam power density), (IV) transforming agent persistence (e.g., dwell) time, (V) transforming agent area of effect (e.g., energy beam footprint) (e.g., on an exposed surface of a material bed), (VI) transforming agent focus, or (VII) a fundamental length scale of a transforming agent footprint (e.g., on a target surface, e.g., an exposed surface of a material bed). The instructions data may comprise instructions for control of a movement of a transforming agent across a target surface (e.g., on an exposed surface of a material bed). The movement of the transforming agent may comprise with a specified transforming agent intensity considering (e.g., as a function of) its position on the target surface. The instructions data may comprise (i) forming instructions data, or (ii) layout instructions data. The forming instructions may comprise commands for a given manufacturing device to form a requested 3D object. The commands may be for control of at least one apparatus of the manufacturing device. The forming instructions may cause a given manufacturing device to control and/or to select an effect with respect to at least a portion of a generated (e.g., requested) 3D object. For example, a selected effect for a requested 3D object may comprise (i) a material type, (ii) a microstructure (iii) a density, (iv) a surface roughness, (v) a material porosity, (vi) an auxiliary support structure (or absence thereof), (vii) a dimensional requirement and/or tolerance, or (viii) a rate of formation, with which (e.g., a portion of) the requested 3D object is formed. The auxiliary support structure may comprise a distance between any immediately adjacent auxiliary support, or location of any auxiliary supports with respect to the requested 3D object. The layout instructions may comprise commands for a given manufacturing device to form at least one requested 3D object (i) according to a requested arrangement, (ii) according to a specified sequence with which one or more transforming agents (e.g., and/or generators thereof) are operated, and/or (iii) to have a requested marking (e.g., label). The requested arrangement may comprise a location of the at least one requested 3D object within a build volume of the manufacturing device. The requested arrangement may be an optimized arrangement. The requested arrangement may be suggested by a software module, operator, and/or client. The pre-formation application may comprise at least two formation stages for preparing the instructions data for generating the 3D object. A (e.g., first) stage may include generation of the forming instructions for generating the requested 3D object. The (e.g., first) stage may comprise at least one application for interaction with a virtual model of a (e.g., discrete) requested 3D object (e.g., an “Object Environment” application). A (e.g., second) stage may include generation of the layout instructions for a given formation cycle. The instruction data may be of the requested 3D object(s) within the build volume. The second (e.g., formation environment) stage may comprise at least one application for interaction with at least one requested 3D object within a build volume of the manufacturing device (e.g., a “Formation Environment” application), e.g., above a platform.

In some embodiments, at least one (e.g., any) of the stages comprises one or more modules (e.g., software modules). A module may enable and/or enact a specific functionality within a given stage. For example, a module may receive, process, and/or generate data related to formation of the requested 3D object. Data related to a requested 3D object may be processed (e.g., in an object stage) to generate forming instructions for the requested 3D object. The processing may include generation, alteration, and/or supplementation to at least one file relating to the forming instructions. A file relating to the forming instructions may be referred to herein as a “forming instruction related file”. The processing of the data in the object stage may include (in any order) one or more of the following modules: (i) requested object model; (ii) region of interest designation (abbreviated herein as “ROI”); (iii) an estimation of a likelihood of formation failure; (iv) object simulation; and/or (v) processing instructions for a forming apparatus.

In some embodiments, a module for processing a requested 3D object model generates a virtual model of a (e.g., requested) 3D object. In some embodiments, an object stage enables an opening and/or importing of a virtual model of a requested 3D object that is in a native (e.g., boundary representation) computer-aided design (abbreviated herein as “CAD”) file format. In some embodiments, the module for processing the requested 3D object model may be compatible with (e.g., import and/or open) file formats comprising IGES, JT, Parasolid, PRC, STEP, STL, 3mf, or LTCX. In some embodiments, the module for processing the requested 3D object model comprises a file conversion functionality. For example, a file conversion may comprise converting a received file of the requested 3D object from a first format (e.g., STL) to a second format (STEP). In some embodiments, the requested 3D object may comprise a 3D object that (a) is generatively designed, (b) is topologically optimized, or (c) comprises a networked (e.g., lightweight, sponge, and/or lattice) structure. In some embodiments, the object stage provides a one or more interactions with one or more modes of a requested 3D object (e.g., a virtual model of the requested 3D object). The interactions with the virtual model of the requested 3D object may comprise (I) selection of one or more similar portions thereof, (II) generation of any ROI, (III) manipulation and/or modifications to any (e.g., predefined) ROI, or (IV) specification of at least one formation variable category option (e.g., forming process or forming feature) for any selected portions. In some embodiments, the forming process comprises hatching, tiling, forming (e.g., substantially) globular melt pools, forming high aspect ratio melt pools, re-transforming, annealing, machining, or pre-heating. In some embodiments, selecting the forming process considers a forming parameter that comprises (a) an angle, (b) a surface roughness, (c) a rate of formation, (d) a material composition, or (e) a dimensional fidelity, of the at least one (e.g., surface) portion of the 3D object. The angle may be with respect to a global vector, gravity, a direction of layerwise object formation, and/or a platform that supports the 3D object. The dimensional fidelity may be of a formed three-dimensional object with respect to the geometric model. In some embodiments, the forming feature comprises generation of: (a) one or more auxiliary supports or (b) a label.

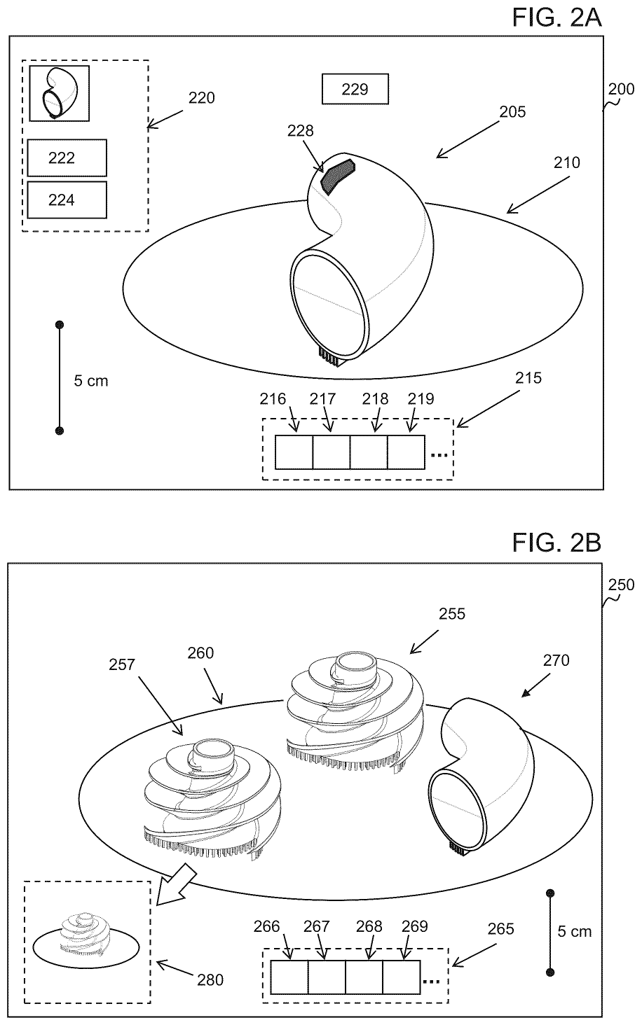

In some embodiments, a module for processing a requested 3D object model aids in generation, modification, analysis, and/or optimization, of a (e.g., design of) a requested 3D object. The requested 3D object may comprise a CAD model or a mechanical design automation (abbreviated herein as “MDA”) model. In some embodiments, a module for processing a requested 3D object model comprises a meshing scheme that is used to generate (e.g., at least a portion of) a geometric model (e.g., FIG. 2, 205). A mesh may comprise a discrete representation of a (e.g., 3D) object. In some embodiments, a meshing scheme comprises isotropic or anisotropic meshing. In some embodiments, a mesh (e.g., scheme) may comprise a surface mesh or a volumetric mesh. In some embodiments, a surface mesh may be used: (a) to generate a display of the geometric model, (b) for (e.g., interactive) placement of one or more (e.g., auxiliary) support structures on the geometric model, and/or (c) to slice a volume of the geometric model. In some embodiments, a volumetric mesh may be used for simulating at least one behavior of the 3D object (e.g., according to a numerical simulation), which behavior may be during and/or after the formation of the 3D object. The behavior may refer to thermal and/or mechanical behavior of at least a portion of the 3D object during printing of the 3D object and/or subsequent to the printing of the 3D object (e.g., as it relaxes to its final, e.g., equilibrium state). In some embodiments, a relationship may exist between a surface mesh and a volumetric mesh (e.g., for a given geometric model). For example, a volumetric mesh may be formed considering a (e.g., surface) boundary described by a surface mesh. In some embodiments, formation of a volumetric mesh does not consider a surface mesh (e.g., boundary).

At times, a fidelity of a surface (or volume) mesh with respect to a (e.g., requested) 3D object may be related to a coarseness (e.g., of data points) of the mesh. For example, a relatively coarse mesh may have a lower fidelity to a surface (or volume) of a 3D object, as compared to a fine(r) mesh. In some embodiments, a relatively coarse mesh may have a reduced number of data points (e.g., and/or a lower computational cost) as compared to a fine(r) mesh. In some embodiments, geometric characteristics of the geometric model are associated with (e.g., data points) of a mesh. In some embodiments, geometric characteristic data are stored at nodes and/or edges of fundamental components (e.g., cells) of a mesh. A cell of a mesh may be a geometric structure such as a polygon (e.g., 2D or 3D polygon). The polygon may be a space filling polygon. The geometric structure may be a tessellation. In some embodiments, the cell comprises a symmetric polygon. In some embodiments, the cell comprises an equilateral polygon. In some embodiments, the cell comprises a triangle, a tetragon, or a hexagon. In some embodiments, the tetragon comprises a concave or a convex polygon (e.g., tetragon).

In some embodiments, an object stage comprises an application providing control of an interaction with a virtual model of a requested 3D object. For example, an object stage may comprise an Object Environment application. For example, control of an interaction may comprise control of a view and/or a selection tool for interacting with (e.g., modifying) at least a portion of a virtual model of a requested 3D object. The requested 3D object may comprise template data. Template data may comprise default settings (e.g., presets) for at least a portion of the requested 3D object. The default settings may comprise (I) a selected effect, (II) a (e.g., predefined) ROI, (III) a forming process, (IV) a forming feature, for at least a portion of the requested 3D object, (V) an orientation at which the requested 3D object is formed (e.g., relative to a platform), (VI) a manufacturing speed, and/or (VII) at least one setting of a manufacturing device (e.g., forming device). An orientation of an object may be with respect to a manufacturing device environment (e.g., with respect to a platform above which the 3D object is formed in the manufacturing device), with respect to a global vector, or with respect to a coordinate system (e.g., Cartesian, spherical, cylindrical, polar, or homogenous). In some embodiments, a setting of a manufacturing device may comprise (A) an atmospheric composition within which the requested 3D object is formed, (B) a throughput of formation of the requested 3D object, (C) a layer height, (D) gas flow, (E) manufacturing device (e.g., type and/or unit number), (F) pre-transformed material size and/or type, or (G) transforming agent type. A transforming agent type may comprise an energy beam characteristic, or binder characteristic such as flow rate, polymerization rate, or hardening rate. A modification (e.g., from an object template) may comprise a change to, an addition, or a removal of, at least one preset of the template. For example, modifications from a template may include modification to at least one formation variable category option. In some embodiments, a catalog stores data associated with an object template (e.g., and any modification thereto) of a (e.g., plurality of) virtual model(s). In some embodiments, an Object Environment application enables a modification to a virtual model of a requested 3D object. For example, a modification to a virtual model may comprise a simplification of the model. An alteration (e.g., simplification) of a virtual model may result in a greater ease of manufacturing, increased manufacturing speed, an increased performance of a manufacturing device for forming, increased dimensional fidelity (with respect to the requested 3D object), and/or a reduction in weight of, a requested 3D object. The alteration may be an alteration as compared to the original, non-altered, 3D object. An object stage application may be any pre-formation application as described in U.S. patent application Ser. No. 16/125,644, titled “MANIPULATING ONE OR MORE FORMATION VARIABLES TO FORM THREE-DIMENSIONAL OBJECTS”, that was filed Sep. 7, 2018, which is incorporated by reference herein in its entirety.

FIG. 2A depicts an example of an Object Environment application 200. In the example of FIG. 2A, an Object Environment application includes a virtual model 205 of a requested 3D object, displayed atop a reference plane 210. The reference plane may imitate a platform above which the 3D object is disposed during manufacturing. In some embodiments, a virtual model of a requested 3D object may be displayed floating freely in space (e.g., devoid of any reference plane). In the example of FIG. 2A, a toolbar 215 includes icons corresponding to various manner of controlling a view of the virtual model of the 3D object, and/or various selection tools. For example, control of a view of the virtual model may comprise control of a (e.g., camera) view of the virtual model (e.g., 216), a view modality (e.g., 217), or a section view (e.g., 219). In some embodiments, control of a selection tool (e.g., 218) includes user-guided selection. A user-guided selection may comprise a lasso selection, a (e.g., closed) shape selection (e.g., rectangle), or a circular selection. A selection may comprise a geometry-based selection based on the geometry of the virtual model of the 3D object (e.g., a surface patch and/or edge), and/or selection of the entire virtual model of the 3D object. FIG. 2A depicts an example of a (e.g., patch) surface selection 228, and an interaction window 229 that provides an interface for specifying any modifications to the selected portion of the model. In the example of FIG. 2A, a window 220 includes template information 222 associated with the displayed model, and any specified modification(s) 224 applied (e.g., from the template) to the current model.

In some embodiments, a module enables specification and/or designation of a region of interest (ROI) for at least a portion of a requested 3D object (a “ROI module”). A ROI module may enable specification of (i) at least one formation variable category option, and/or (ii) a selected effect, to at least a portion of a requested 3D object. The at least the portion may comprise at least one (a) surface portion, or (b) volumetric portion. In some embodiments, an ROI module may enable assigning a requested forming process, surface finish, any auxiliary support, formation rate (e.g., object generation speed) preferences. At times, it is requested to select (e.g., to designate and/or to define) a region of interest for at least a portion of a 3D object. An ROI designation may enable a modification to (e.g., override) a forming procedure (e.g., a default forming procedure). A forming procedure may comprise a forming feature (e.g., an auxiliary support) or a forming process (e.g., of a plurality of forming processes). In some embodiments, an ROI module comprises at least one sub-module for designation and/or modification to a forming procedure (e.g., to a file thereof). For example, a (e.g., first) sub-module for specification of a forming feature, and a (e.g., second) sub-module for specification of a forming process. At times, a (e.g., forming procedure) category is associated with an ROI designation. For example, a category may comprise (I) a forming feature and/or (II) a given forming (e.g., printing) process of a plurality of forming processes. A forming feature may comprise an auxiliary support or a label. In some embodiments, a label is associated with a portion of the 3D object (e.g., the ROI portion), and/or the (e.g., entire) 3D object. A label may comprise a (e.g., named) reference to a given ROI of the 3D object. A label may comprise a detectable marking within and/or on a surface of the 3D object. A label may be generated manually and/or automatically. In some embodiments, a data store (e.g., a database) comprises data relating a given serial number to a given (e.g., instance of) a formed 3D object (e.g., in a table). For example, an automatically generated label may comprise operations of (a) querying a database to determine (e.g., fetch) a current value of a sequence (e.g., a serial number), (b) generating a label ROI according to the sequence, and (c) incrementing the sequence (e.g., a serial number).

In some embodiments, an object stage module provides an analysis (e.g., estimation, calculation and/or assessment) of a likelihood of failure in the forming of a (e.g., requested) 3D object. The requested 3D object may comprise a topology having overhangs (e.g., ledges) and/or cavities. The analysis may be performed before, during, and/or after generating forming instructions by which a forming device forms the 3D object. A failure can comprise a defect in at least a portion of the 3D object and/or a malfunction in a device operating to form the 3D object. A defect may comprise a rupture, a collapse, a failure of the 3D object to meet at least one (e.g., design) requirement, or a failure of the 3D object to operate (e.g., perform) for its intended purpose. For example, an analysis may comprise (i) any estimated failure mode(s) of the 3D object formation, or (ii) a response to the (e.g., any) estimated failure mode(s). In some embodiments, an estimated failure mode comprises a failure of: (i) object support; (ii) residual stress; (iii) material property; (iv) excessive material addition; (v) adjustive deformation; or (vi) destructive deformation; of the (e.g., forming) 3D object. Excessive material addition may manifest as material balling. Adjustive deformation may comprise bending, curling, warping, twisting, rolling, plastically yielding, or balling. Destructive deformation may comprise cracking or tearing. At times, an analysis may consider a geometry and/or orientation of the 3D object. At times, an analysis may consider historical data. Historical data may be of a same (e.g., requested) prior-formed 3D object, and/or of a similar 3D object. Historical data may comprise previously formed (e.g., printed) layers of a requested 3D object. At times, the analysis may consider a (e.g., physics model) simulation of a process of forming at least a portion of the 3D object and/or the reaction of the 3D object to its formation. The simulation may be a full simulation, e.g., of an entire requested 3D object. The simulation may be a partial simulation, e.g., of a portion of a requested 3D object. The simulation may be of a currently formed layer of the 3D object. The simulation may take into account one or more previously formed portions (e.g., layers) of the 3D object. The plurality of previously formed layers may be within the last 10, 100, 1000, 10000, or 100000 formed layers. The reaction of the 3D object may comprise a post formation relaxation process within the formed 3D object. At times, the analysis may be a simplification of: various aspects of a geometric model and/or simulation of forming the requested 3D object. In some embodiments, a malfunction may comprise damage to the device that is operating to form the 3D object. In some embodiments, a response to an estimated failure mode may comprise: (i) an object formation modification; (ii) a notification; or (iii) a refinement of a failure estimate.

In some embodiments, an object simulation module comprises an analysis (e.g., simulation) of an outcome of manufacturing instructions to result in an analyzed virtual example of manufacturing 3D object. A simulation may consider the forming process of the 3D object, its physical behavior during and/or after the printing, and any structural correction. Structural correction (“object pre-print correction”) may comprise corrective deformation of a 3D model of the requested 3D object. In a corrective deformation procedure, a virtual model (e.g., representation) of the requested 3D object is modified to account for any foreseen deformation during and/or after (e.g., upon relaxation) its formation, such that when the modified virtual model is utilized for generation of the printing instructions, the 3D object will be formed according to its originally requested dimensionality (e.g., within an acceptable tolerance). The corrective deformation may be referred to herein as “object pre-print correction” (abbreviated as “OPC”) or “pre-print correction.” The corrective deformation may take into account features comprising (i) stress within a forming object (e.g., structure) such as accumulating stress or latent stress, (ii) deformation of transformed material as it hardens to form at least a portion of the requested 3D object, (iii) the manner of temperature depletion during the printing process, (iv) the manner of deformation of the transformed material as a function of the density of the pre-transformed material within the material bed (e.g., powder material within a powder bed) in which the 3D object was formed (when applicable), or (v) stress relaxation during and/or after formation of the 3D object. The corrective deformation may introduce a deformation to at least a portion of the model of the 3D object. The generation of forming instructions for a given requested 3D object may consider (e.g., be based at least in part on) the corrective deformation. The introduced deformation may be such that, upon transformation and hardening, the at least the portion of the 3D object assumes a requested (e.g., intended) shape (e.g., geometry). The simulation may comprise a computational model. The computational model may comprise the use of mathematics, statistics, physics and/or computer science. The computational model may consider historical data. The computational model may utilize machine learning. Examples of machine learning can be found in patent application serial number PCT/US17/54043, titled “THREE-DIMENSIONAL OBJECTS AND THEIR FORMATION” that was filed on Sep. 28, 2017, that is incorporated herein by reference in its entirety. The computational model may consider a physics model. The structural correction may comprise any pre-print correction to the model of the requested 3D object that may result in reduced deformation of the formed 3D object and adherence to the requested dimensionality constraints of the 3D object that is formed. The structural correction may comprise a geometric correction to the geometric model of the requested 3D object. Examples of structural correction can be found in patent application serial number PCT/US16/34857, titled “THREE-DIMENSIONAL PRINTING AND THREE-DIMENSIONAL OBJECTS FORMED USING THE SAME” that was filed on May 27, 2016; patent application serial number PCT/US17/18191, titled “ACCURATE THREE-DIMENSIONAL PRINTING” that was filed on Feb. 16, 2017; U.S. patent application Ser. No. 15/435,065, titled “ACCURATE THREE-DIMENSIONAL PRINTING” that was filed on Feb. 16 2017; patent application serial number EP17156707, titled “ACCURATE THREE-DIMENSIONAL PRINTING” that was filed on Feb. 17, 2017; and/or patent application serial number PCT/US17/54043, titled “THREE-DIMENSIONAL OBJECTS AND THEIR FORMATION” that was filed on Sep. 28, 2017; each of which is incorporated herein by reference in its entirety. The physical simulation may comprise thermal and/or mechanical simulation of the 3D object during its formation. Examples of physical simulation can be found in patent application serial number PCT/US16/59781, titled “ADEPT THREE-DIMENSIONAL PRINTING” that was filed on Oct. 31, 2016; patent application serial number PCT/US17/18191; U.S. patent application Ser. No. 15/435,065; patent application serial number EP17156707; and/or patent application serial number PCT/US17/54043; each of which is incorporated herein by reference in its entirety. The simulation may comprise a physics model regarding the forming process. The physics model may comprise a thermo mechanical (e.g., thermo plastic) model of the forming process to form the 3D object.

In some embodiments, an expected thermo-plastic (e.g., thermal component of a thermo-mechanical model) is calculated by computing a thermal balance in the material using the following Equation 1:

$$ρ {c}_{ρ} \frac{\partial T}{\partial t} + {∇}_{x} \cdot q = ρ r ;$$

Where t is time, T=T(t, x) is the temperature field, x is a deformation point; cₚ=cₚ(T) is the heat capacity of the material as a function of temperature; ρ=ρ(t,x) is the density; r=r (t, x) is the energy source field per unit mass; q=−∇ₓT; and ∇ₓT is the temperature gradient. The heat capacity can include a latent heat of melting for the material and the material properties can be assumed to be temperature dependent. An expected mechanical deformation (e.g., mechanical component of a thermo-mechanical model) can be calculated by finding the function x=Φ(t, X) using the following Equation 2, such that:

∇ₓ·P(t,X)=0;

Where P=P(t,X) is a stress tensor. The stress tensor can be the first Piola-Kirchhoff stress tensor. Equivalent forms of the above equation can comprise a different stress tensor. The different stress tensor may be a Cauchy, Nominal, Piola, second Piola-Kirchhoff, or Biot stress tensor. Equation 2 can assume inertial terms are negligible (e.g., quasistatic approximation of the momentum equation). The constitutive model for the material can be calculated and using the following Equation 3:

S=C:εₑₗ;

where S=F−1 P is the same or another stress tensor, e.g., the second Piola-Kirchhoff stress tensor; C is the elastic 4-tensor of the material, and εₑₗ is the elastic strain tensor.

In some embodiments, a physics model comprises calculations that consider a type of material (e.g., type of alloy) and an expected thermo-mechanical reaction of that material to the forming process, e.g., that causes deformation. In some embodiments, the physics model relies on one or more assumptions. In one example, the physics model relies on the following assumptions: (i) an optimal transforming agent process (e.g., is applied to maintain a constant peak temperature over a dwell time); and (ii) a closed loop control is employed to adjust process parameters in real time. In some embodiments, a reduced set physics model (e.g., also) assumes: (iii) strain/stress related effects. The strain/stress related effects may be applied to a layer. The stress/strain related effects may be independent of or dependent on a stress field of any underlying structure. In some embodiments, the physics model can be used to calculate a predicted deformation substantially in real time (e.g., before, during and/or following formation of at least a portion of the 3D object). The real time calculations can be used in a feed forward and/or feedback (closed loop) control system(s) that controls the forming process.

In some embodiments, an object stage comprises a module for generating processing instructions for a forming apparatus. At times, 3D forming (e.g., printing) comprises one or more forming (e.g., printing) instructions (e.g., embodied in a computer-readable medium). The forming instructions, when executed, may cause a (e.g., suitable) manufacturing (e.g., 3D printing) device to perform a series of operations. The series of operations may cause (e.g., additive) formation of the 3D object. For example, the forming instructions may divide the formation of a physical 3D object into a series of physical layers (e.g., layers of transformed material). In some embodiments, a model of a 3D object is arranged (e.g., divided) into a number of constituent portions (e.g., virtual slices). A slice of a 3D model may correspond to a (e.g., planar) section of the 3D model (e.g., a layer). In some embodiments, a series of physical layers correspond to a series of virtual slices of a geometric model. The (e.g., planar) slice may be defined by a top surface, a bottom surface, and a thickness. Top and bottom may be with respect to a global vector and/or platform above which the 3D object is formed. A thickness of a slice may correspond with a layer height (e.g., thickness) of the formed 3D object. The 3D model may be organized into a plurality of (e.g., neighboring) slices. For example, a plurality of slices may be arranged such that a top surface of a first slice is adjacent to (e.g., juxtaposed with) a bottom surface of a neighboring slice that is above the first slice (e.g., above with respect to a global vector). The first slice may be directly adjacent to the second slice. For example, the first slice may contact the second slice. In some embodiments, a (e.g., corresponding) virtual slice exists for each layer of the physically formed 3D object, e.g., that is formed additively in a layer-wise manner.

In some embodiments, a module for generating processing instructions specifies for a (e.g., each) slice of a geometric model an associated (e.g., set of) forming (e.g., printing) instruction of a printing lap. The forming process may comprise layerwise printing, extruding (e.g., layerwise extruding), molding, or any other forming process disclosed herein for forming a 3D object. In some embodiments, the printing operations comprise (i) depositing a first (e.g., planar) layer of pre-transformed material as a portion of a material bed, and (ii) directing a transforming agent (e.g., an energy beam or a binding agent) towards a first portion of the first layer of pre-transformed material to form a first transformed material. For example, the printing operations can comprise (i) depositing a first (e.g., planar) layer of pre-transformed material as a portion of a material bed, and (ii) directing an energy beam towards a first portion of the first layer of pre-transformed material to form a first transformed material. The transformed material may be a portion of the 3D object. The transformed material may be hardened into a hardened (e.g., solid) material as a portion of the 3D object. The transformed material may comprise pre-transformed material that are connected. Connected may be by using a binding agent, through chemical bonding such as utilizing covalent bonds, and/or by sintering. The transformed material may be embedded in a matrix. The matrix may be formed by a binding agent such as polymer, resin, and/or other glue. Optionally, this process may be repeated layer by layer deposition, or layerwise deposition. Another layer may be formed, for example, by adding a second (e.g., planar) layer of pre-transformed material, directing a transforming agent (e.g., an energy beam, a chemically reactive species, or a binding agent) toward a second portion of the second layer of pre-transformed material to form a second transformed material according to forming instructions of a second slice in the (e.g., geometric) computer model of the 3D object.

In some embodiments, a formation environment stage comprises processing data related to formation of at least one requested 3D object in a given formation cycle of a manufacturing device. The formation environment stage may receive data from a (e.g., prior) stage. For example, the formation environment stage may receive forming instructions data from an object stage. Forming instructions data may be received for (e.g., each of) a plurality of requested 3D objects to be formed in the given formation cycle. The processing of the (e.g., forming instructions) data in the formation environment stage may result in a data output. The data output may comprise layout instructions data. The formation environment stage may comprise one or more modules operable for receiving, processing, and/or generating data related to formation of at least one 3D object within a manufacturing device. The formation environment stage may relate to the at least one 3D object (e.g., a plurality of 3D objects) arranged on a platform and/or in a build volume. The processing may involve and/or utilize the forming instruction related files generated in the first stage (e.g., first phase, first branch, or first division). The processing of the data in the formation environment stage may include (in any order) one or more of the following modules: (i) an arrangement of a build volume; (ii) a sequencer (e.g., of at least two manufacturing device apparatuses); (iii) object labelling; and/or (iv) a build volume simulation.

In some embodiments, a module for arranging a build volume enables placement of at least one requested 3D object within a build volume and/or above a platform, of a manufacturing device. The manufacturing device may comprise a platform. The platform may be configured to support at least one forming 3D object (e.g., directly and/or indirectly) during formation. The module may comprise a (e.g., virtual) model of (a) at least one requested 3D object, or (b) a manufacturing device (e.g., build volume). The module may enable a placement of a (e.g., at least one) requested 3D object above (e.g., resting upon) a platform of the manufacturing device. The placement may be made with respect to a (e.g., Cartesian, polar, and/or spherical) coordinate system.

In some embodiments, a module for arranging a build volume comprises an application configured for interaction with one or more virtual models of 3D objects (e.g., of a corresponding one or more requested 3D objects). For example, the module may comprise a Formation Environment application. In some embodiments, a Formation Environment application may comprise interaction with (i) a single virtual model of the 3D object, (ii) a plurality of virtual models (e.g., corresponding to a same or to similar requested 3D object), or (iii) at least two different virtual models (e.g., corresponding to at least two different requested 3D objects). In some embodiments, a Formation Environment application may interact with (e.g., load) at least one virtual model of a requested 3D object that was prepared in an object stage (e.g., by an Object Environment application). In some embodiments, a Formation Environment application may load at least one virtual model of a requested 3D object that was prepared in an application other than an Object Environment application. A Formation Environment application may be configured to organize a distribution (e.g., a layout) of one or more virtual models corresponding to one or more requested 3D objects that are formed in a forming cycle. The organization may be relative to a platform above which the 3D objects are to be manufactured. The organization of the 3D object(s) may be in a horizontal direction and/or vertical direction. The organization may comprise a rotation of (e.g., at least one) 3D object. The rotation may be with respect to the build volume, platform, and/or at least one transforming agent (e.g., generator), of the manufacturing device. The rotation may be with respect to the global vector. A Formation Environment application may correspond to at least one manufacturing device environment. For example, a Formation Environment application may comprise a virtual environment that corresponds to a physical environment of at least one manufacturing device (e.g., from a plurality of manufacturing devices). A physical environment of a manufacturing device may comprise at least one manufacturing device parameter. For example, a manufacturing device parameter may comprise a processing volume within which at least one 3D object may be formed (e.g., during a forming cycle). A processing volume may comprise an area (e.g., of a platform) that is addressable by at least one transforming agent. A processing volume may comprise a height over which at least one 3D object may be formed. A processing volume may comprise a height over which a platform that supports a forming object may translate, e.g., in layerwise deposition. A processing volume may comprise a width and depth corresponding to the platform. A processing volume may comprise a horizontal cross-section corresponding to the platform. In some embodiments, a Formation Environment application comprises a configuration of a virtual environment. A configuration of a given virtual environment may correspond to at least one parameter of a physical environment of a corresponding manufacturing device.

FIG. 2B depicts an example of a Formation Environment application 250. In the example of FIG. 2B, a forming area (e.g., a platform) 260 is disposed below an arrangement of a plurality of 3D object models (e.g., 255, 257, and 270) that correspond to a plurality of requested 3D objects. An arrangement of virtual models may comprise a layout. In the example shown in FIG. 2B, a toolbar 265 includes icons corresponding to control of a view of the model(s) (e.g., of a layout), and a selection tool. For example, control of a view of the virtual model(s) may comprise control of a camera view (e.g., angle, zoom, pan, focus and/or perspective) of the model(s) (e.g., 266), a view modality (e.g., shaded, wireframe, shaded with edges, semi-transparent, and/or angle filter) (e.g., 267), or a section view (e.g., 269). In some embodiments, control of a selection tool (e.g., 268) comprises user-guided selection (e.g., lasso selection, or a shape selection), geometry-based selection, or selection of an entire virtual model (e.g., within a layout). In some embodiments, a Formation Environment application provides a capability to modify (e.g., a selected portion of) a virtual model of a requested 3D object. The modification may comprise adjusting one 3D object with respect to another 3D object above the forming area and/or in the forming volume. The adjustment may be with respect to one or more directly adjacent 3D object models. In some embodiments, a modification to at least one 3D object may be made (e.g., directly) from within a Formation Environment application. The optimization may be regarding formation speed, space utilization, fidelity of the object(s) (e.g., considering heat dissipation), or any combination thereof. The adjustment may comprise placement optimization. In some embodiments, a modification may comprise an adjustment to forming instructions data. In some embodiments, a modification (e.g., to forming instructions data) may be made (e.g., indirectly) by opening an Object Environment application (e.g., 280).

In some embodiments, a manufacturing device comprises at least two apparatuses that are operable for forming at least a portion of at least one requested 3D object. For example, at least two transforming agent generators may be disposed to transform at least one requested 3D object. In some embodiments, at least two requested 3D objects are arranged (e.g., in a layout) for transformation by at least one transforming agent (e.g., generator). In some embodiments, a sequencer module (e.g., in a formation environment stage) comprises a capability of specifying a sequence of operation(s) for at least two manufacturing device apparatuses. The sequence of operations may consider an arrangement of at least one requested 3D object (e.g., within a build volume). The sequence of operations may consider a (e.g., spatial) relationship between at least one requested 3D object and at least one manufacturing device apparatus. The sequence of operations may comprise a pattern (e.g., of activation and/or deactivation). The sequence of operations may comprise a cadence (e.g., a timing of operations).

In some embodiments, a requested 3D object comprises a marking (e.g., a label). In some embodiments, a formation environment stage comprises an object labelling module. The object labelling module may generate one or more markings for at least one requested 3D object. The object labelling module may generate markings considering at least one forming instructions-related file. For example, a forming instructions-related file may comprise data (e.g., generated by an ROI module) indicating a portion of a requested 3D object designated for a marking (e.g., a label). In some embodiments, an object labelling module comprises a coupling with a (e.g., at least one) product lifecycle management (“PLM”) application. A coupling may comprise an application programming interface (API) connection. A PLM application may comprise (e.g. maintain) data corresponding to a (e.g., current) value of a marking for a requested 3D object. For example, a current value may correspond to a (e.g., given) serial number of a requested 3D object (e.g., in a manufacturing line).

In some embodiments, a formation environment stage comprises a simulation of a manufacturing device environment. The simulation may be performed within (e.g., by) a module that enables a build volume simulation. The simulation may comprise any simulation method as described herein. A build volume simulation may enable an optimization of at least one aspect of forming a requested 3D object in the manufacturing device. For example, a build volume simulation may optimize at least an aspect of the formation process while considering the arrangement of at least one 3D object in the build volume and/or above the platform. An optimization may comprise consideration of (i) the platform, (ii) build starting material (e.g., pre-transformed material), and/or (iii) (e.g., any) adjacent 3D object(s) that are formed within the build volume and/or above the platform. In some embodiments, optimization may comprise: (i) a formation rate (e.g., manufacturing speed) of one or more requested 3D objects; (ii) a fidelity of a geometry of one or more formed 3D objects with respect to that of one or more requested 3D objects; (iii) fill scheduling for one or more formed 3D objects, or (iv) a requested 3D object arrangement. The optimization of fill scheduling may comprise optimization of forming instructions for the one or more formed 3D objects. For example, optimization of the forming instructions may comprise determining an order of transformation for a plurality of (e.g., fill) portions that form a given layer of a requested 3D object. The optimization of the fill scheduling may comprise ordering a sequence of forming processes (e.g., melt pool formation sequence). The forming process sequence may include tiling, and/or hatching operations. The optimization of the fill scheduling may comprise determining an ordering of formation for a plurality of (e.g., interior and/or perimeter) portions of a requested 3D object during a given formation lap. The (e.g., totality of the) plurality of portions may correspond to a (e.g., complete) slice of the requested 3D object. An interior portion may be interior with respect to a (e.g., slice) perimeter of the requested 3D object (e.g., at a given layer). A requested 3D object arrangement may be with respect to (a) a platform, (b) one or more transforming agent generators, and/or (c) a plurality of (e.g., all) requested 3D objects. Optimization may comprise a determination of a placement of at least one requested 3D object on (e.g., or above) the platform. Optimization may comprise a determination of an angle of impingement and/or distance of at least one requested 3D object with respect to one or more transforming agent generators. Optimization may comprise determination of a placement of and/or distance between a plurality of requested 3D objects, e.g., in a build volume. Optimization may comprise simulation of (I) one or more requested 3D objects, or (II) at least a portion of a manufacturing device. A simulation may comprise a thermo-mechanical model. For example, optimization may comprise a simulation of the one or more objects above a supportive platform, e.g., within a given build volume. The simulation may consider (e.g., determine) a deformation of the platform during formation of at least a portion of a requested 3D object. A corrective deformation may be generated, e.g., considering an estimated deformation of the platform. The corrective deformation may be for at least a portion of one or more requested 3D objects, and/or to a forming feature (e.g., auxiliary support(s)).

In some embodiments, a 3D object includes one or more auxiliary features. The auxiliary feature(s) can be supported by the material (e.g., powder) bed. The term “auxiliary feature” or “support structure” as used herein, generally refers to a feature that is part of a printed 3D object, but is not part of the requested, intended, designed, ordered, modeled, or final 3D object. Auxiliary feature(s) (e.g., auxiliary support(s)) may provide structural support during and/or subsequent to the formation of the 3D object. The 3D object may have any number of supports. The supports may have any shape and size. In some examples, the supports comprise a rod, plate, wing, tube, shaft, pillar, or any combination thereof. In some cases, the auxiliary supports support certain portions of the 3D object and do not support other portions of the 3D object. In some cases, the supports are (e.g., directly) coupled to a bottom surface the 3D object (e.g., relative to the platform). In some embodiments, the supports are anchored to the platform during formation of the 3D object. In some examples, the supports are used to support portions of the 3D object having a certain (e.g., complex or simple) geometry. The 3D object can have auxiliary feature(s) that can be supported by the material bed (e.g., powder bed) and not contact and/or anchor to the platform, container accommodating the material bed, or the bottom of the enclosure. The 3D part (3D object) in a complete or partially formed state can be completely supported by the material bed (e.g., without contacting the platform, container accommodating the powder bed, or enclosure). The 3D object in a complete or partially formed state can be completely supported by the powder bed (e.g., without touching anything except the powder bed). The 3D object in a complete or partially formed state can be suspended anchorlessly in the powder bed, without resting on and/or being anchored to any additional support structures. In some cases, the 3D object in a complete or partially formed (e.g., nascent) state can freely float (e.g., anchorlessly) in the material bed. Auxiliary feature(s) may enable the removal of energy from the 3D object that is being formed. In some instances, the auxiliary support is a scaffold that encloses the 3D object or part thereof. The scaffold may comprise lightly sintered or lightly fused powder material. In some examples, the 3D object may not be anchored (e.g., connected) to the platform and/or walls that define the material bed (e.g., during formation). At times, the 3D object may not touch (e.g., contact) to the platform and/or walls of the container that define and/or encloses the material bed (e.g., during formation). The 3D object be suspended (e.g., float) in the material bed. The scaffold may comprise a continuously sintered (e.g., lightly sintered) structure that is at most 1 millimeter (mm), 2 mm, 5 mm or 10 mm. The scaffold may comprise a continuously sintered structure having dimensions between any of the aforementioned dimensions (e.g., from about 1 mm to about 10 mm, from about 5 mm to about 10 mm, or from about 1 mm to about 5 mm). In some examples, the 3D object may be printed without a supporting scaffold. The supporting scaffold may engulf the 3D object. The supporting scaffold may float in the material bed. The printed 3D object may be printed without the use of auxiliary features, may be printed using a reduced number of auxiliary features, or printed using spaced apart auxiliary features. Examples of an auxiliary support structure can be found in Patent Application Serial No. PCT/US15/36802 filed on Jun. 19, 2015, titled “APPARATUSES, SYSTEMS AND METHODS FOR THREE-DIMENSIONAL PRINTING,” which is entirely incorporated herein by reference in its entirety. The printed 3D object may comprise a single auxiliary support mark reminiscent of a single auxiliary support feature. The single auxiliary feature (e.g., auxiliary support or auxiliary structure) may be a platform (e.g., a building platform such as a base or substrate), or a mold. The auxiliary support may be adhered to the platform or mold. In some embodiments, the 3D object comprises a layered structure indicative of 3D forming procedure that is devoid of one or more auxiliary support features or one or more auxiliary support feature marks that are indicative of a presence or removal of the one or more auxiliary support features. Examples of auxiliary features comprise heat fins, wires, anchors, handles, supports, pillars, columns, frame, footing, scaffold, flange, projection, protrusion, mold (a.k.a. mould), or other stabilization features.

In some embodiments, the instructions (e.g., the forming instructions and/or the layout instructions) data may be generated by processing data through (e.g., at least one of) the above-mentioned stages. One or more of the modules (e.g., within a stage) may be separate from another. Data may transition (e.g., be transferred) between at least two separate modules. At least two of the modules may be executed by different processors. At least two of the modules may be executed by the same processor. At least two of the modules may be in a software (e.g., application). At least two of the modules may be in different software (e.g., applications).

In some embodiments, instructions data for generating a requested 3D object may be received by at least one manufacturing device. The instructions data may comprise specification of at least one process parameter. The instructions data may comprise specification of at least one characteristic of a transforming agent. The at least one manufacturing device may comprise at least one processor operable to read the instructions (e.g., data). For example, the at least one manufacturing device may comprise at least one controller. The at least one controller may control one or more process parameters (e.g., of the at least one manufacturing device). For example, the at least one controller may control at least one apparatus of the manufacturing device.

In some embodiments, the methods, systems, apparatuses, and/or software disclosed herein comprise providing a security (e.g., level) to (e.g., at least a portion of) the instruction data for forming the 3D object. The security may promote an (i) integrity, (ii) authentication, and/or (iii) confidentiality, of data used to form at least a portion of at least one three-dimensional (3D) object. The security may promote (e.g., confirm) that a closed system is formed (e.g., maintained). The closed system may comprise a pre-formation environment and a manufacturing device that are for forming a 3D object (e.g., a requested 3D object). The security may be implemented for (e.g., during) generation of instructions data. The security may be implemented for (e.g., during) the process (e.g., virtual and/or physical) formation of the 3D object. The security may deter (e.g., restrain and/or prevent) unauthorized access to at least a portion of the instructions data. The security may comprise encryption of at least one forming instructions related file. The security may be implemented (e.g., provided) during a transfer from at least one stage and/or module to another. The encryption may comprise at least one level of encryption. A (e.g., given) level of encryption may be implemented within (e.g., by) a module and/or a stage. For example, a given module may implement an encryption level by encryption to any (i) received, (ii) generated, and/or (iii) transmitted, data. Received and/or transmitted data may be between at least two stages, and/or between at least two modules. The encryption may be implemented by a module dedicated to encryption implementation. The encryption may comprise a symmetric encryption scheme, an asymmetric encryption scheme, or a combination thereof. The encryption may comprise a (I) Data Encryption Standard (DES) (e.g., Triple DES), (II) Rivest-Shamir-Adleman (RSA), (III) Advanced Encryption Standard (AES), (IV) Blowfish, or (V) Twofish, encryption scheme. The encryption may comprise one or more encryption keys. The encryption may comprise an encryption key and a decryption key. In some embodiments, an encryption key and a decryption key are the same (e.g., the same key). In some embodiments, an encryption key and a decryption key are different (e.g., different keys). In some embodiments, an encryption scheme may comprise a public encryption key, or a private encryption key. Security may comprise generation of at least two encryption levels. Implementation of at least two encryption levels may comprise an encryption level (e.g., a second encryption level) that is added to a previous encryption level (e.g., a first encryption level). The first encryption level and the second encryption level may comprise different encryptions, such as, e.g., different types of encryption. The encryption of the first encryption level and the second encryption level may be the same (e.g., the same type). The encryption may comprise a first encryption level to a first section of a file (e.g., related to the forming instructions), and a second encryption level to a second section of the file. For example, the first section may be a body (e.g., payload) of the file, and the second section may be metadata of the file. For example, the first section and the second section may be different sections of the body (e.g., payload) of the file. For example, the first section and the second section may be different sections of the metadata of the file. Encryption may be added to a file to form an encrypted file. Such encrypted file may not be accessible by a user that does not have an encryption and/or decryption key, for example. The encrypted file may have a higher level of complexity as compared to the non-encrypted file. For example, the encrypted file has a greater level of complexity than a non-encrypted (or unencrypted) file. The encryption may increase the size and/or processing time of the encrypted file as compared to a non-encrypted file. For example, as compared to an unencrypted file comprising forming instructions: (i) an encrypted file comprising forming instructions may have a larger size; (ii) it may take a longer time to transmit such encrypted file to a forming device; and (iii) it may take a longer time for a computer of the forming device to decrypt such encrypted file to yield forming instructions for forming a 3D object. The first encryption level may be generated in a prior module and/or stage. The second encryption level may be generated in a subsequent module and/or stage. A plurality of encryption levels (e.g., at least two encryption levels) may be implemented by a plurality of stages and/or modules (e.g., at least two stages and/or modules). A plurality of encryption levels may be implemented by the same stage and/or module (e.g., the same stage and/or module may implement at least two encryption levels). An encryption level may be used to validate completion of a module and/or stage.

In some embodiments, security (e.g., encryption) is provided for at least a portion of the instructions data during its generation and/or transmission. In some embodiments, security is provided for at least a portion of the instructions data following its generation (e.g., prior to a transmission). The security may be implemented for at least a portion of a file related to the forming instructions. A transmission may be a movement of data between (i) at least two stages, (ii) at least two modules, (iii) at least two processors, and/or (iv) a pre-formation application and a manufacturing device. A transmission may comprise movement of data within (a) a bus (e.g., of a motherboard), or (b) a network. The transmission may be wireless.

In some embodiments, authentication is provided in an instructions date related file. The authentication may be used to validate completion of a module and/or stage. The authentication may be regarding a source used to generate instructions data for forming a requested 3D object. The authentication may comprise a characteristic of at least a portion of a file related to the forming instructions. The characteristic may include a file format, and/or an encryption mechanism. The characteristic may form a section of the at least the portion of the file (e.g., related to the forming instructions). For example, the characteristic may be stored within a body (e.g., payload), and/or as metadata, of a file. The authentication may be implemented by providing error detection of at least a portion of file related to the forming instructions. In some embodiments, the error detection comprises a checksum or a hash.

In some embodiments, a security protocol is implemented to constrain (e.g., prevent) (i) a data breach, (ii) tampering, and/or (iii) property loss (e.g., and/or harm). In some embodiments, a security protocol (e.g., encryption) is implemented for at least a portion of a (e.g., forming instructions) file that comprises manufacturing device (e.g., apparatus) settings, and/or (e.g. requested 3D object) design data. In some embodiments, a plurality of process parameters are specified by forming instructions data for a given requested 3D object. The plurality of process parameters may correspond to one or more manufacturing device settings. For example, one or more settings may be specified for at least one apparatus of a manufacturing device. The one or more settings may comprise (a) a voltage setpoint, (b) a current setpoint, (c) a (e.g., activation) timing (e.g., duty cycle), or (d) a power (e.g., output), of an apparatus of the manufacturing device. The specification of the plurality of process parameters may comprise (i) an attribute (e.g., a temperature) at one or more positions at a target surface (e.g., of a build region), (ii) a target surface height (e.g., exposed surface of a material bed) at a position, (iii) a (e.g., average or mean) target surface planarity, (iv) a gas flow (e.g., within a build region), (v) a pressure (e.g., within a build volume), (vi) a power of a transforming agent generator (e.g., an energy source) that generates a transforming agent (e.g., an energy beam), (vii) an intensity of a transforming agent (e.g., power density of an energy beam), (viii) a transforming agent flux (e.g., energy beam fluence), (ix) a position of a transforming agent (e.g., on the target surface), (x) speed of the transforming agent, (xi) an area of effect (e.g., fundamental length scale) of a transforming agent on the target surface (e.g., energy beam footprint), (xii) a focus (e.g., and/or de-focus) of a transforming agent, (xiii) a dwell time of the transforming agent, or (xiv) an intermission time of a transforming agent. A given process parameter (e.g., setpoint) may be achieved by control of a (e.g., at least one) manufacturing device apparatus. In some embodiments, specification of the plurality of process parameters is automatic, manual, or any combination thereof. Automatic may comprise specification of at least one process parameter value using at least one controller. Manual may comprise default, user-specified, and/or automatically (e.g., preset) values. The plurality of process parameter (e.g., values) may be constant (e.g., fixed) and/or varying. Varying may comprise time-varied. Specification of the plurality of process parameters, e.g., during generation of the forming instructions, may be according to selected forming process(es). The selected forming process(es) may consider one or more forming parameters of the requested 3D object, as described herein.

In some embodiments, a data breach constitutes disclosure of at least a portion of a file, e.g., that is related to forming instructions. The disclosure may be sufficient to cause damage to at least one party. For example, a data breach may reveal at least a portion of process parameter data. The revealed process parameter data may comprise at least one setpoint of a manufacturing device (e.g., apparatus), e.g., during formation of a requested 3D object. For example, a data breach may reveal a confidential design, e.g., of a requested 3D object. The confidential design may be a design of an owner of a manufacturing device that is suitable for forming the requested 3D object, and/or a design of a third party. In some embodiments, a data breach may constitute a violation of a contractual obligation. For example, a contractual obligation may exist between a (e.g., forming) company that owns a manufacturing device that is suitable for forming a requested 3D object, and a third party that has requested (e.g., contracted with) the forming company to form the requested 3D object. In some embodiments, a data breach may violate a jurisdictional law or regulation. For example, a data breach may violate a rule, regulation, and/or law regarding (i) privacy, and/or (ii) data protection. For example, a requested 3D object may be intended for implantation into a (e.g., human and/or animal) body (e.g., an implant).

In some embodiments, tampering comprises an alteration to at least a portion of a file, e.g., that is related to forming instructions. The alteration may comprise a change that causes a formed 3D object to deviate from a requested 3D object. The deviation may comprise a deviation in a (a) geometry, or (b) at least one material property, of the formed 3D object. The deviation may comprise a deviation that is outside of a threshold value (e.g., tolerance). The alteration may comprise a disruption to at least one component of (I) a pre-formation environment (e.g., stage and/or module), and/or (II) a manufacturing device. Tampering may promote at least partial loss of (e.g., owner) control for the at least one component. For example, tampering may introduce a virus, spyware, worm, trojan, botnet, or ransomware, into the at least one component. The alteration may comprise a change that places (i) a manufacturing device (e.g., apparatus), (ii) (e.g., operating) personnel, (iii) an environment, and/or (iv) a facility, in an unsafe operating condition. An unsafe operating condition may promote (e.g., cause) an (e.g., increased) risk of property loss and/or harm. Increased may be with respect to an operating condition that is devoid of tampering (e.g., alteration).

In some embodiments, insufficient security (e.g., a lack thereof) for at least a portion of a file, e.g., that is related to forming instructions, promotes (e.g., enables and/or results in) damage to property and/or to person. The damage may comprise property loss and/or (e.g., personal) harm. The damage may result from (e.g., be caused by) tampering with the file. The damage may be by accessing the information of the file and/or exposing at least part of the information in the file. For example, damage may be to (i) a forming equipment, (ii) materials, (iii) a forming facility, (iv) a person (e.g., facility personnel), or (v) intellectual property. The encryption described herein may prevent, deter and/or hinder such insufficient security. The forming equipment may be a manufacturing device (e.g., or a component thereof) that is suitable for forming a requested 3D object. Damage (e.g., to material, equipment, or personnel) may comprise (a) wasted formation (e.g., starting) material, (b) wear and tear to one or more components of a manufacturing device, or (c) wasted labor (e.g., personnel work-hours). Damage to a forming facility may comprise damage to a forming environment. Damage to a forming environment may comprise damage to one or more objects and/or property that is within or adjacent to the forming environment. For example, damage to a forming environment may be caused by a compromised manufacturing device and/or material, e.g., that has been subjected to tampering. Damage (e.g., or harm) to a person may comprise harming (I) forming facility personnel, or (II) a recipient of a formed 3D object. A forming facility personnel may comprise a person involved with the forming of a (e.g., requested) 3D object, and/or that is disposed in a location of forming the 3D object. A recipient of a formed 3D object may comprise a customer, e.g., of a company that forms the requested 3D object. A recipient of a formed 3D object may comprise a patient e.g., where the formed 3D object is an implant and/or augmentation. Damage to intellectual property may comprise theft and/or copying of a (e.g., object) design, or of secret information (e.g., a trade secret). The secret information may be embedded in the file. For example, damage to intellectual property may comprise improper access to one or more process parameters that are specified to form at least a portion of a requested 3D object, and/or to the design of the 3D object.

In some embodiments, data from at least a portion of a file, e.g., that is related to forming instructions, is passed (e.g., transmitted) between at least two communicatively coupled components. The at least two communicatively coupled components may be operable to read, process, and/or manipulate the data. The communicatively coupled components may be (e.g., embedded in) a processor. The communicatively coupled components may be (e.g., embedded in) a non-transitory computer readable media. The communicatively coupled components may be (e.g., embedded in) a program (e.g., software). A component may comprise (a) a stage, (b) a module, (c) a processor, or (d) any combination thereof. The at least two components may be embodied in a pre-formation environment, a manufacturing device, and/or a combination thereof. In some embodiments, at least two components that transmit data (e.g., therebetween) comprise a (e.g., data) pipeline. In some embodiments, a security (e.g., level) is implemented (i) during entry, (ii) during processing (e.g., manipulation), and/or (iii) prior to transmission, of the data by a component. In some embodiments, a security (e.g., level) is implemented (i) during access, (ii) during (e.g., data) processing, and/or (iii) prior to transmission, of the data by a processor.

In some embodiments, (e.g., at least) a second component considers data provided by (e.g., at least) a first component (e.g., in the pipeline). In some embodiments, the data comprises encrypted data of at least a portion of a file, e.g., that is related to forming instructions of the 3D object(s). The second component may decrypt at least a portion (e.g., all) of the data to form encrypted data. In some embodiments, at least two (e.g., the first and second) components operate in parallel. In some embodiments, at least two components operate sequentially. For example, at least two stages may operate in parallel and/or sequentially. For example, at least two modules may operate in parallel and/or sequentially. For example, at least two processors may operate in parallel and/or sequentially. In some embodiments, at least one stage comprises at least two modules. In some embodiments, at least two modules are embodied on separate (e.g., computing) systems. For example, separate computing systems may comprise a distributed system (e.g., network).

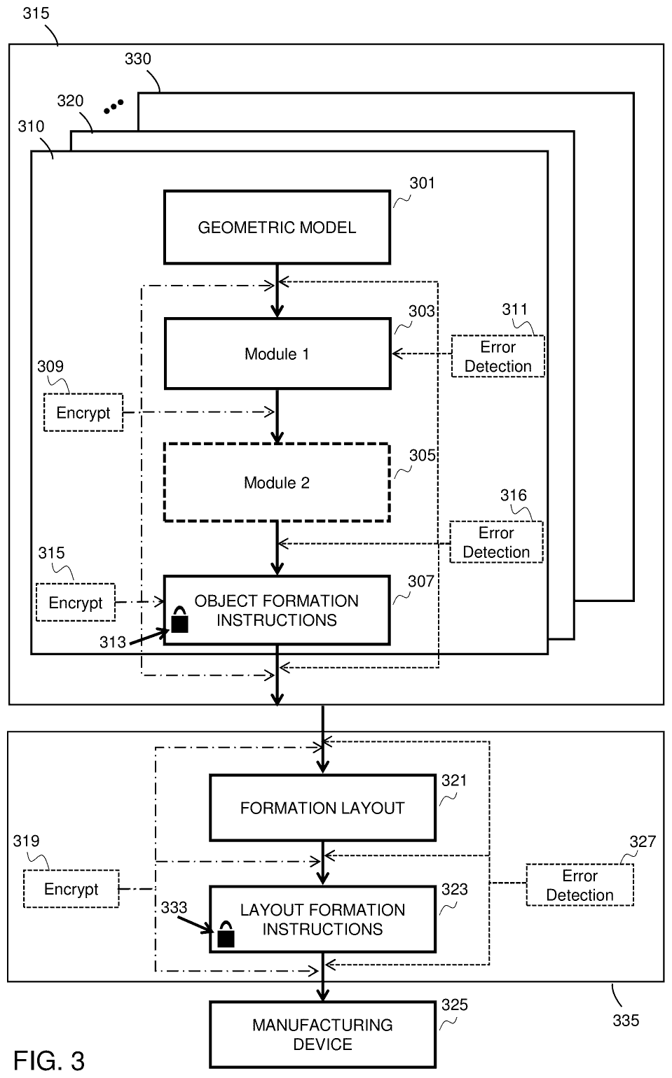

FIG. 3 depicts an example of an implementation of data assurance for instructions data for forming at least a portion of a requested 3D object. The instructions data may be generated and/or transmitted in a (e.g., data) pipeline. In the example of FIG. 3, in a (e.g., first) stage 315 data corresponding to a geometric model 301 of a (e.g., requested) 3D object is considered in the generation of object formation instructions, e.g., by a module 307. One or more modules (e.g., of a data pipeline) may be involved in the generation of object formation instructions for a requested 3D object, e.g., modules as described herein. The one or more modules may receive, process, manipulate, and/or transmit at least a portion of a file, e.g., that is related to forming instructions data. In the example of FIG. 3, data corresponding to the geometric model is provided to a (e.g., first) module 303, on to a (e.g., second) optional module 305, and then on to the module 307. While the example FIG. 3 depicts three (3) modules in an object stage, in some embodiments a greater or fewer number of modules are utilized in the object stage. In some embodiments, a data assurance (e.g., measure) is implemented for at least a portion of a file in an object stage. For example, a security (e.g., level) may be implemented for at least a portion of a file in an object stage. For example, the data assurance may comprise encryption (e.g., 313) and/or authentication (e.g., error detection). The example depicted in FIG. 3 shows encryption and error detection as data assurance options that may be implemented, however, any other data assurance option(s) can be implemented in their stead. Other data assurance option(s) may comprise (i) a certification, (ii) a validation, (iii) a verification of integrity, or (iv) an authentication. In some embodiments, the data assurance is implemented within a module, e.g., of the object stage. In some embodiments, the data assurance is implemented prior to or following a data transmission, e.g., from a first module to a second module. In some embodiments, security (e.g., encryption) is implemented within a module (e.g., encryption 315). In some embodiments, security (e.g., encryption) is implemented prior to or following a data transmission, e.g., between at least two modules (e.g., encryption 309). In some embodiments, authentication (e.g., error detection) is implemented within a module (e.g., error detection 311). In some embodiments, authentication (e.g., error checking) is implemented prior to or following a data transmission, e.g., between at least two modules (e.g., error detection 316).

In some embodiments, data is provided from a first (e.g., object) stage to a second (e.g., formation environment) stage. In some embodiments, a plurality of objects may be prepared, e.g., in a first (e.g., object) stage. In the example of FIG. 3, object formation instructions corresponding to a plurality of requested objects (e.g., FIG. 3, 310, 320, and 330) is provided to a (e.g., second) stage 335. A second stage may comprise a formation environment stage. The stage may be referred to herein as phase, branch, or division. The formation environment stage may comprise one or more modules. In the example of FIG. 3, a module 321 is for forming an arrangement (e.g., of requested 3D objects) of a build volume (e.g., a formation layout); and a module 323 generates layout instructions considering the formation layout. The instructions data for forming the requested 3D object(s), e.g., comprising forming instructions and/or layout instructions, may be provided to a manufacturing device (e.g., FIG. 3, 325). In some embodiments, a data assurance (e.g., measure) is implemented for at least a portion of a file in a formation environment stage. For example, a security (e.g., level) may be implemented for at least a portion of a file in a formation environment stage. For example, encryption (e.g., FIG. 3, 333) may be implemented. In some embodiments, the data assurance comprises (i) a certification, (ii) a validation, (iii) a verification of integrity, (iv) an authentication, (v) encryption, or (vi) error detection. In some embodiments, the data assurance is implemented within a module, e.g., of the formation environment stage. In some embodiments, the data assurance is implemented prior to or following a data transmission, e.g., from a first module to a second module. In some embodiments, security (e.g., encryption) is implemented within a module, e.g., of the formation environment stage. In some embodiments, security (e.g., encryption) is implemented prior to or following a data transmission, e.g., between at least two modules (e.g., encryption 319). In some embodiments, authentication (e.g., error detection) is implemented within a module, e.g., of the formation environment stage. In some embodiments, authentication (e.g., error checking) is implemented prior to or following a data transmission, e.g., between at least two modules (e.g., error detection 327). While the example FIG. 3 depicts two (2) modules in a formation environment stage, in some embodiments a greater or fewer number of modules are utilized in the formation environment stage.

In a forming process (e.g., 3D printing), a requested 3D object can be formed (e.g., printed) according to forming (e.g., printing) instructions. The forming instructions may at least in part consider a (e.g., geometric) model of a requested 3D object. The geometric model may be a virtual model (e.g., a computer-generated model of the 3D object). For example, the geometric model may comprise a CAD model. The geometric model may be a virtual representation of the geometry and/or the topology of the 3D object (e.g., in the form of 3D imagery). The geometric model may correspond to an image (e.g., scan) of an object (e.g., a real object such as a test object). The image may be a scan image.

A dispenser may deposit the binder and/or the reactive species, e.g., through an opening in the dispenser. An energy source may generate the energy beam. A dispenser may deposit the pre-transformed material, e.g., to form a material bed. In some embodiments, the 3D object is formed in a material bed. The material bed (e.g., powder bed) may comprise flowable material (e.g., powder), e.g., that remains flowable during the forming process (e.g., powder that is not compressed or pressurized). During formation of the one or more 3D objects, the material bed may exclude a pressure gradient. In some examples, the 3D object (or a portion thereof) may be formed in the material bed with diminished number of auxiliary supports and/or spaced apart auxiliary supports (e.g., spaced by at least about 2, 3, 5, 10, 40, or 60 millimeters). In some examples, the 3D object (or a portion thereof) may be formed in the material bed without being anchored (e.g., to the platform). For example, the 3D object may be formed without auxiliary supports.

In some examples the 3D object may be formed above a platform, e.g., without usage of a material bed. The 3D printing cycle may correspond with (I) depositing a pre-transformed material toward the platform, and (II) transforming at least a portion of the pre-transformed material (e.g., by at least one energy beam) at or adjacent to the platform (e.g., during deposition of the pre-transformed material towards the platform) to form one or more 3D objects disposed above the platform. An additional sequential layer (or part thereof) can be added to the previous layer of a 3D object by transforming (e.g., fusing and/or melting) a fraction of pre-transformed material that is introduced (e.g., as a pre-transformed material stream) to the prior-formed layer. The depositing in (i) and the transforming in (ii) may comprise a forming increment. A dispenser may deposit the pre-transformed material, e.g., through an opening of the dispenser.

In some embodiments, forming instructions for forming (e.g., a given layer of) the 3D object(s) may comprise the utilization (e.g., selection) of one or more 3D forming (e.g., printing) procedures. A forming procedure may comprise a forming feature (e.g., an auxiliary support) or a forming process (e.g., of a plurality of forming processes). The particular forming procedure(s) (e.g., of a plurality of forming procedures) that is used to generate a given portion of the (e.g., layer of) the 3D object may consider the geometry of the 3D object. For example, the forming procedure that is used may consider: (i) a position of the given portion (e.g., with respect to a geometry of the 3D object(t); (ii) an angle of the given portion (e.g., of a normal vector at a surface of the 3D object, and/or with respect to a global vector); (iii) an intended use of the given portion (e.g., according to an intended use of the requested 3D object); (iv) a requested (e.g., surface) characteristic of the given portion (e.g., a surface roughness or a dimensional accuracy); and/or (v) a requested material property of the given portion. The given portion of the (e.g., layer of) requested 3D object may comprise a (e.g., slice) feature. In some embodiments, a slice feature may be designated (e.g., specified) considering: (i) a position (e.g., of a given portion) with respect to a geometry of the 3D object; and/or (ii) an angle of the given portion, e.g., of a normal vector at a point on surface of the 3D object, and/or with respect to a global vector. Examples of a geometry of a 3D object, e.g., a cavity, a ledge, or an overhang, can be found in patent application serial number PCT/US17/54043, which is incorporated herein by reference in its entirety. In some embodiments, a (e.g., each) slice of a requested 3D object comprises a plurality of slice features. The particular forming procedure(s) that is/are used to generate a given portion (e.g., slice feature) of the 3D object may be selected manually and/or automatically (e.g., using a controller). The selection may be before and/or during the printing of the 3D object. For example, the selection may be altered during the printing of the 3D object. The alteration may be manual (e.g., by a user) and/or automatic (e.g., using a selection tree, simulation, and/or other procedure). The alteration may consider data from one or more sensors.

In some embodiments, a forming instructions module (e.g., engine and/or program) comprises code for generation of forming instructions for at least one (e.g., each) virtual slice of a virtual geometric model. The forming instructions module may receive data from one or more prior modules and/or stages, e.g., in a data pipeline. In some embodiments, the forming instructions engine considers (e.g., manual and/or automatic) selection of at least one forming process (e.g. of a plurality of forming processes) for a (e.g., each) virtual slice or slice portion. The virtual slice of a model of the 3D object may correspond to a formed layer of the 3D object. The slice portion may comprise a slice edge, or slice interior. The plurality of forming processes may comprise hatching, tiling, forming globular melt pools, forming high aspect ratio melt pools, re-transforming, annealing, or pre-heating. Examples of forming processes can be found in Patent Application serial number PCT/US18/20406, titled “THREE-DIMENSIONAL PRINTING OF THREE-DIMENSIONAL OBJECTS” that was filed Mar. 1, 2018, and in U.S. Patent Application Ser. No. 62/654,190, titled “THREE-DIMENSIONAL PRINTING OF THREE-DIMENSIONAL OBJECTS” that was filed Apr. 6, 2018, each of which is incorporated herein by reference in its entirety.

In some embodiments, the forming instructions that are generated in a pre-formation software environment are sent to one or more forming tools (e.g., printer, extruder and/or welder). The generation of the forming instructions may comprise a data pipeline. The data pipeline may comprise one or more stages and/or modules. The data pipeline may comprise security (e.g., an implementation thereof). The data pipeline may comprise generation of and/or modification to one or more files. The one or more files may be organized in a structure, e.g., in a directory comprising folders and optionally sub-folders. Organization of the one or more files may comprise data compression, e.g., into a zip and/or archive file.

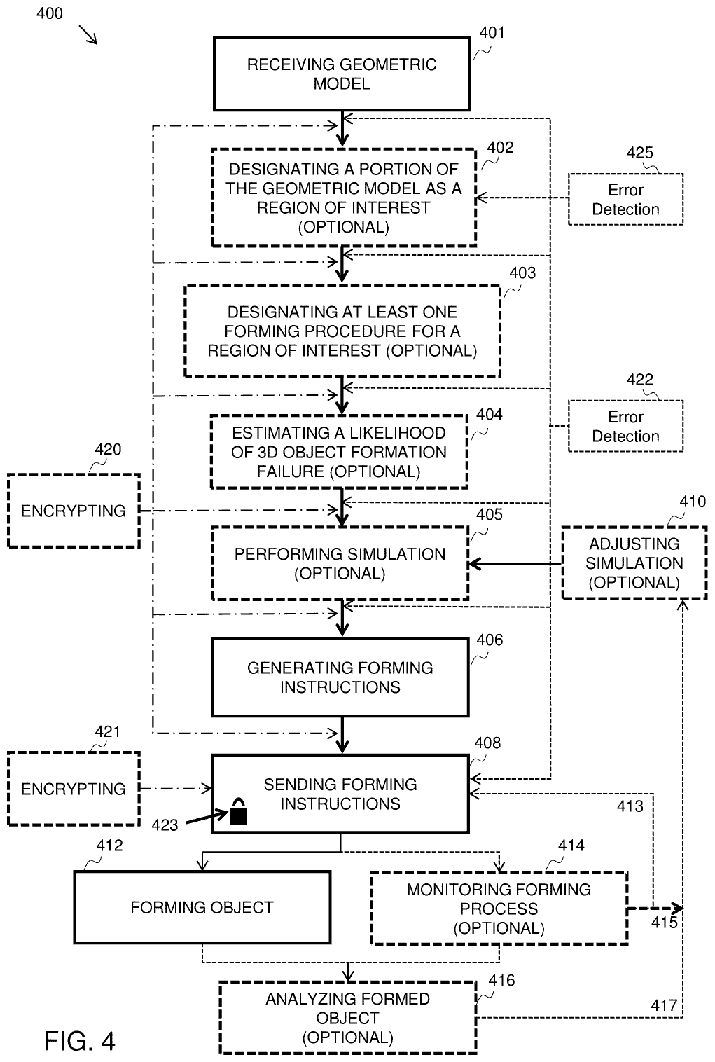

FIG. 4 depicts an example flowchart 400 comprising: receiving a geometric model (e.g., 401); an optional operation 402 for designating a portion of the geometric model as an ROI; an optional operation 403 for designating at least one forming (e.g., printing) procedure for an ROI; an optional operation 404 for estimating a likelihood of 3D object formation failure; an optional operation 405 for performing a simulation (e.g., of the forming and/or the formed 3D object); and generating forming instructions (e.g., 406). In some embodiments, at least two operations (e.g., 402-406) are performed (e.g., implemented) by a first module and a second module. In some embodiments, the first module and the second module are the same. In some embodiments, the first module and the second module are different. In some embodiments, a separate module performs an (e.g., each) individual operation. In some embodiments, a data assurance (e.g., measure) is implemented (e.g., within a data pipeline) for at least a portion of a file that is related to the forming instructions, e.g., in the pipeline that includes the forming instructions. For example, a security (e.g., level) may be implemented (e.g., within a data pipeline) for at least a portion of a file that is related to the forming instructions. For example, security may be implemented by an encrypting operation and/or error detection (e.g., authentication) operation. An encrypting operation may encrypt at least a portion of the file (e.g., 423), e.g., that is related to the forming instructions. In some embodiments, security (e.g., encryption) is implemented within a module (e.g., 421). In some embodiments, security (e.g., encryption) is implemented prior to or following a data transmission (e.g., 420), e.g., between at least two operations (e.g., modules). In some embodiments, error detection (e.g., authentication) is implemented within a module (e.g., 425). In some embodiments, error detection (e.g., authentication) is implemented prior to or following a data transmission, e.g., between at least two modules (e.g., 422). The example depicted in FIG. 4 shows encryption and error detection as data assurance options that may be implemented, however, any other data assurance option(s) can be implemented in their stead. Other data assurance option(s) may comprise (i) a security, (ii) a certification, (Hi) a validation, (iv) a verification of integrity, or (v) an authentication, for at least a portion of a file that is related to the forming instructions.

In some embodiments, forming instructions generated in an object stage are provided to a second (e.g., formation environment) stage. The second stage may modify the forming instructions that were generated in the object stage. In some embodiments, a modification of the forming instructions (e.g., data) comprises a modification regarding: (i) an arrangement (e.g., of a plurality of objects) of a build volume; (ii) a sequence (e.g., of at least two manufacturing device apparatuses); (iii) object labelling; (iv) any corrective deformation to a virtual model of the 3D objects arranged in the build volume (e.g., based at least in part in a build volume simulation) and/or (v) assignment of forming (e.g., print) processes based on a requested structure and/or material property of the objects arranged in the build volume. For example, the second stage may generate layout instructions.

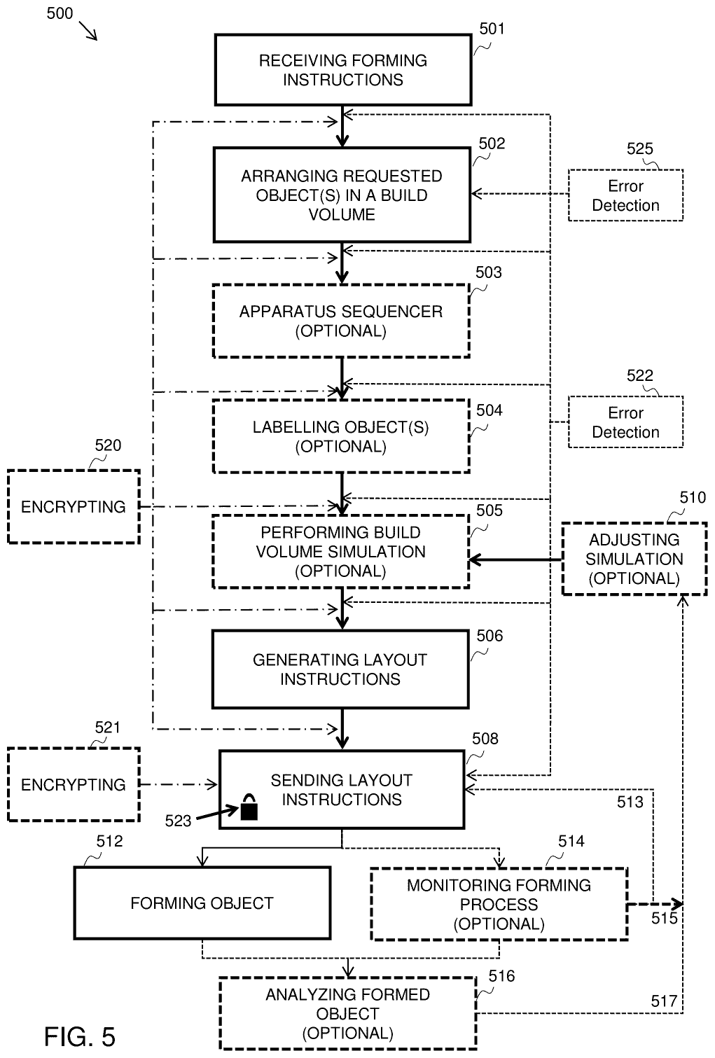

In some embodiments, the layout instructions are generated in a pre-formation software environment. The layout instructions may be sent to one or more forming tools (e.g., printer, extruder and/or welder). The generation of the layout instructions may comprise a data pipeline. The data pipeline may comprise one or more stages and/or modules. The data pipeline may comprise security (e.g., an implementation thereof). FIG. 5 depicts an example flowchart 500 comprising: receiving forming instructions (e.g., 501); an operation of arranging one or more requested 3D objects in a build volume (e.g., 502); an optional operation 503 for designating a sequence for at least two apparatuses of a manufacturing device; an optional operation 504 for labelling at least a portion of a requested 3D object; an optional operation 505 for performing a (e.g., build volume) simulation, e.g., of the forming and/or the formed 3D object(s); and generating layout instructions (e.g., 506). In some embodiments, at least two operations (e.g., 502-506) are performed (e.g., implemented) by a first module and a second module. In some embodiments, the first module and the second module are the same. In some embodiments, the first module and the second module are different. In some embodiments, a separate module performs an (e.g., each) individual operation. In some embodiments, a data assurance (e.g., measure) is implemented (e.g., within a data pipeline) for at least a portion of a file that is related to the layout instructions. For example, a security (e.g., level) may be implemented (e.g., within a data pipeline) for at least a portion of a file that is related to the layout instructions. For example, security may be implemented by an encrypting operation and/or error detection (e.g., authentication) operation. An encrypting operation may encrypt at least a portion of the file (e.g., 523), e.g., that is related to the layout instructions. In some embodiments, security (e.g., encryption) is implemented within a module (e.g., 521). In some embodiments, security (e.g., encryption) is implemented prior to or following a data transmission (e.g., 520), e.g., between at least two operations (e.g., modules). In some embodiments, error detection (e.g., authentication) is implemented within a module (e.g., 525). In some embodiments, error detection (e.g., authentication) is implemented prior to or following a data transmission, e.g., between at least two modules (e.g., 522). The example depicted in FIG. 5 shows encryption and error detection as data assurance options that may be implemented, however, any other data assurance option(s) can be implemented in their stead. Other data assurance option(s) may comprise implementation of (i) a security, (ii) a certification, (lii) a validation, (iv) a verification of integrity, or (v) an authentication, for at least a portion of a file that is related to the forming instructions.

In some cases, performing the simulation (e.g., FIG. 4, 405; FIG. 5, 505), generating forming instructions (e.g., FIG. 4, 406), generating layout instructions (e.g., FIG. 5, 506), sending the forming (e.g., print) instructions (e.g., FIG. 4, 408), and/or sending the layout instruction (e.g., FIG. 5, 508) is/are performed during at least a portion of the forming. In some cases, performing the simulation (e.g., FIG. 4, 405), generating forming instructions (e.g., FIG. 4, 406), and/or sending the forming instructions (e.g., FIG. 4, 408) is/are performed before and/or during the forming. Each of operations 402-406 and/or 502-506 can constitute a module. The operations 401-408 and/or 501-508 can constitute a (e.g., object) stage. In some embodiments, forming instructions generated in an object stage are provided (e.g., directly) to a manufacturing device, e.g., for forming a requested 3D object. In some embodiments, forming instructions generated in an object stage are provided (e.g., for further processing) to a second (e.g., formation environment) stage.

One or more objects can be formed (e.g., printed) (e.g., FIG. 4, 412; FIG. 5, 512) using one or more manufacturing devices (e.g., forming tools such as printers). In some embodiments, formation of the 3D object is optionally monitored (e.g., FIG. 4, 414; FIG. 5, 514). Monitoring can comprise using one or more detectors that detect one or more outputs (e.g., thermal, optical, chemical and/or tactile signals). The detector can comprise a sensor. In some cases, monitoring is performed in real-time during formation of the one or more 3D objects. In some cases, monitoring is done before, during and/or after printing. The monitoring may use historical measurements (e.g., as an analytical tool and/or to set a threshold value). Monitoring of one or more aspects of formation can optionally be used to (e.g., directly) modify the forming instructions (e.g., FIG. 4, 413) and/or adjust the one or more simulations (e.g., FIG. 4, 415). Monitoring of one or more aspects of formation can optionally be used to (e.g., directly) modify the layout instructions (e.g., FIG. 5, 513) and/or adjust the one or more simulations (e.g., FIG. 5, 515). For example, one or more thermal detectors may gather (e.g., real time) thermal signals (e.g., real time thermal signature curve) at and/or in a location in proximity to (e.g., vicinity of) an irradiation spot on the target surface during printing of a 3D object. The location in proximity to the irradiation spot may include an area of at least about 1, 1.5, 2, 2.5, 3, 3.5, 4, 4.5, 5, 5.5, 6, 6.5, 7, 7.5, 8, 8.5, 9, 9.5, or 10 FLS (e.g., diameter) of a melt pool. The location in proximity to the irradiation spot may include an area between any of the afore-mentioned values (e.g., from about 1 FLS to about 10 FLS, from about 1 FLS to about 5 FLS, from about 5 FLS to about 10 FLS, or from about 1 FLS to about 6 FLS) of irradiation spots. The thermal signals can be compared to a target thermal signal (e.g., target thermal signature curve) during the formation process. One or more characteristics of a transforming agent may be altered during formation of the 3D object to adjust the (e.g., real time) thermal signal to (e.g., substantially) match the target temperature. The alteration to the transforming may comprise an alteration to (i) a transformation density (or transformation strength), (ii) a trajectory, (iii) a FLS of a footprint of the transforming agent on the target surface, (iv) a hatch spacing, (v) a scan speed, (vi) a scanning scheme (v) a dwell time of the transforming agent, as it progresses along a path along the target surface, or (vi) an intermission time of the transforming agent as it progresses along a path along the target surface. For example, the alteration may comprise an alteration to an energy beam (a) power density at the target surface, (b) wavelength, (c) cross section, (d) path, (e) irradiation spot size, (f) scan speed, (g) dwell time, (h) intermission time, or (i) power of the energy source generating the energy beam. Matching the target temperature may be to within a (e.g., pre-determined) tolerance.

In some embodiments, a target thermal signal is obtained from one or more simulations (e.g., FIG. 4, 405; FIG. 5, 505), e.g., any simulation described herein. The target signal may be a value, a set of values, or a function (e.g., a time dependent function). The one or more 3D objects may optionally be analyzed (e.g., FIG. 4, 416; FIG. 5, 516). In some embodiments, a target (e.g., thermal) signal is obtained from historical data of 3D objects (or portions thereof) that have been analyzed. In some embodiments, the object(s) or portion(s) thereof is analyzed using an inspection tool (e.g., optical camera, x-ray instrument, sensor, and/or a microscope). The microscope may comprise an optical, or an electron microscope. The microscope may comprise a scanning tunneling, scanning electron, or a transmission electron microscope. The measurement may be conducted using a method comprising X-ray tomography, tensile tester, fatigue tester, eStress system, or X-ray diffraction (XRD). The measurements may be conducted at ambient temperature. The surface roughness of the 3D object can be measured with a surface profilometer. In some cases, the analysis provides data concerning geometry of the object(s). In some cases, the analysis provides data concerning one or more material properties (e.g., porosity, surface roughness, grain structure, internal strain and/or chemical composition) of the object(s). In some embodiments, the analysis data is compared to requested data. For example, a geometry of the printed object(s) may be compared with the geometry of the requested object(s). In some embodiments, the analysis data is used (e.g., FIG. 4, 417; FIG. 5, 517) to adjust the simulation (e.g., FIG. 4, 410; FIG. 5, 510). The adjusted simulation may be used, for example, in formation of subsequent object(s).

In some embodiments, error detection is implemented (e.g., provided) for at least a portion of a file, e.g., that is related to instructions data for forming a requested 3D object. The instructions data may comprise (i) forming instructions data, or (ii) layout instructions data. An error detection (e.g., value) may be used to validate a completeness and/or integrity of the instructions data. An error detection (e.g., value) may be used to validate completion of a module and/or stage. An error detection (e.g., value) may be used to authenticate (e.g., a source of) data, e.g., that is related to instructions for forming a requested 3D object. An error detection (e.g., value) may be used to validate and/or authenticate a version (e.g., revision) of a software and/or firmware. For example, error detection may be used for certification of a software and/or firmware version. Certification may be used (e.g., required) for generation of 3D objects that have an intended use in a regulated environment, e.g., aerospace and/or medical applications. Certification may indicate adherence to a jurisdictional and/or industrial standard and/or regulation. The error detection may comprise verification of a generated error detection value. In some embodiments, an error detection value is generated in a pre-formation software environment, and verified by one or more manufacturing devices. In some embodiments, an error detection value is generated in a first module and/or stage, and verified in a second module and/or stage.

In some embodiments, a verification attempt generates an unexpected error detection value. A verification attempt that generates an unexpected error detection value may result in a response (e.g., output), e.g., a verification error. A response may comprise (i) a notification, or (ii) a modification to a work flow for forming a requested 3D object. A notification may include generation of an alert of (a) any (e.g., portion(s) of a) file, (b) a module, and/or (c) a stage, that is associated with an unexpected error detection value. The alert may be a visual, tactile, audio, and/or olfactory alert. The alert may be embedded in an output file. A modification to a work flow may comprise halting (e.g., preventing) (I) transmission of (e.g., instructions) data, or (II) formation of a requested 3D object, e.g., by a manufacturing device. Halting transmission may be for transmission between at least two (A) stages, (B) modules, (C) manufacturing device(s), (D) processors, (E) a processor and a manufacturing device, or (F) any combination thereof.

In some embodiments, error detection comprises (a) a checksum, (b) a cyclic redundancy check (CRC), or (c) a check (e.g., parity) bit, e.g., of at least a portion of the file. A checksum may comprise a data manipulation scheme (e.g., algorithm, and/or function). For example, the checksum may comprise a (e.g., cryptographic) hash function. The hash function may receive an input (e.g., file, or portion thereof). The hash function may produce a (e.g., characteristic) output. For example, the hash function may produce a string, e.g., a sequence of numbers and/or letters. The string may have a characteristic (e.g., fixed) length. In some embodiments, a function that generates a checksum comprises (A) a message digest algorithm (e.g., MD5), or (B) a secure hash algorithm (SHA), e.g., SHA1 or SHA256. In some embodiments, error detection is implemented within (e.g., by) a module and/or a stage. For example, a given module may implement error detection by generating a checksum for any data including (i) received, (ii) generated, and/or (iii) transmitted data (e.g., file). Received and/or transmitted data may within a (e.g., single) stage, and/or within a (e.g., single) module. Received and/or transmitted data may be between at least two stages, and/or between at least two modules. The error detection may comprise a first error detection value for a first (e.g., section of a) file, e.g., that is related to instructions data for forming a requested 3D object. The error detection may comprise a second error detection value for a second file. For example, the first section may be a body (e.g., payload), and the second section may be a metadata, of the file. For example, the first file may be generated in a first module and/or stage, and the second file may be generated in a second module and/or stage. The first error detection value may be generated in a prior module and/or stage. The second error detection value may be generated in a subsequent module and/or stage. A plurality of (e.g., at least two) error detection values may be implemented by at least two stages and/or modules. A plurality of (e.g., at least two) error detection values may be implemented by the same stage and/or module.

In some embodiments, a manufacturing device (e.g., 3D printer) comprises and/or communicates with (e.g., at least one component of) a pre-formation (e.g., software) environment. The pre-formation environment may comprise one or more components, e.g., modules, stages, and/or processors. The pre-formation environment may generate instructions data related to the formation of a requested 3D object. The pre-formation environment and/or the manufacturing device may implement a data assurance (e.g., measure) for at least a portion of a file, e.g., that is related to the instructions data. The data assurance measure may comprise security (e.g., encryption) and/or verification (e.g., error detection). In some embodiments, authorization for accessing (e.g., reading and/or executing) a secured file is granted (e.g., bestowed). Grant of the authorization for access may be granted considering an identity of an accessing party. The identity may be embedded in the file, e.g., the file comprising the instructions data related to the formation of the 3D object. In some embodiments, accessing (e.g., reading and/or executing) a secured file is hindered (e.g., prevented, or blocked) for a (e.g., any) would-be accessing party that lacks authorization. In some embodiments, accessing a secured file is limited to a (e.g., single) authorized accessing party. An accessing party may be an entity that (i) manufactures, (ii) owns, (iii) controls, and/or (iv) operates a manufacturing device. An accessing party may be an entity that (i) develops, (ii) owns, (iii) controls, and/or (iv) operates a pre-formation environment (e.g., application), e.g., that generates a file related to instructions data for forming a requested 3D object. An identity of an accessing party may comprise data relating to a forming apparatus (i) manufacturing party, (ii) owning party, (iii) controlling party, and/or (iv) operating party. An identity of an accessing party may comprise (e.g., compatibility with): a system type, a system version, e.g., a manufacturing device model (e.g., number) and/or a pre-formation environment application revision. Authorization for accessing a secured file may be granted upon a verification (e.g., authentication) of the identity of an accessing party. For example, the authentication may be granted for a (e.g., any) manufacturing device that is of a same type, model, and/or that is manufactured by a same manufacturing entity. The authentication may be granted for a (e.g., any) manufacturing device, that is owned and/or operated by a same (e.g., legal) entity. The authentication may be embedded in the file during any of the stages or modules disclosed herein. The authentication may be granted for a (e.g., any) pre-formation environment application that is of a same type, version, and/or that is developed by a same (e.g., developing) entity. The authentication may be granted for a (e.g., any) pre-formation environment application, that is controlled, owned and/or operated by a same (e.g., legal) entity. In some embodiments, at least one component and/or manufacturing device is operable to read at least a portion of an assured data such as an encrypted data (e.g., file). For example, at least one component and/or manufacturing device may be configured to read and/or execute at least a portion of encrypted data, e.g., prior to accessing and/or modifying the data. For example, at least one component and/or manufacturing device may decrypt at least a portion of encrypted data, e.g., prior to accessing and/or modifying the data. For example, an (e.g., authorized) at least one component may decrypt at least a portion of encrypted data prior to modifying instructions data, e.g., by a stage and/or module. For example, an (e.g., authorized) manufacturing device may decrypt at least a portion of encrypted data prior to executing the instructions data, e.g., for forming at least a portion of a requested 3D object. Decryption may be via use of a decryption key (e.g., password). In some embodiments, a decryption key is provided by a pre-formation environment (e.g., component) and/or a manufacturing device.

In some embodiments, the manufacturing device provides an output in the form of a (e.g., data) file. The manufacturing device may provide assurance to the output file, e.g., any assurance described herein. For example, the manufacturing device may include encryption. For example, the manufacturing device may embed identification information such as a serial number, type, location, ownership, control, and/or manufacturing entity, of the manufacturing device.

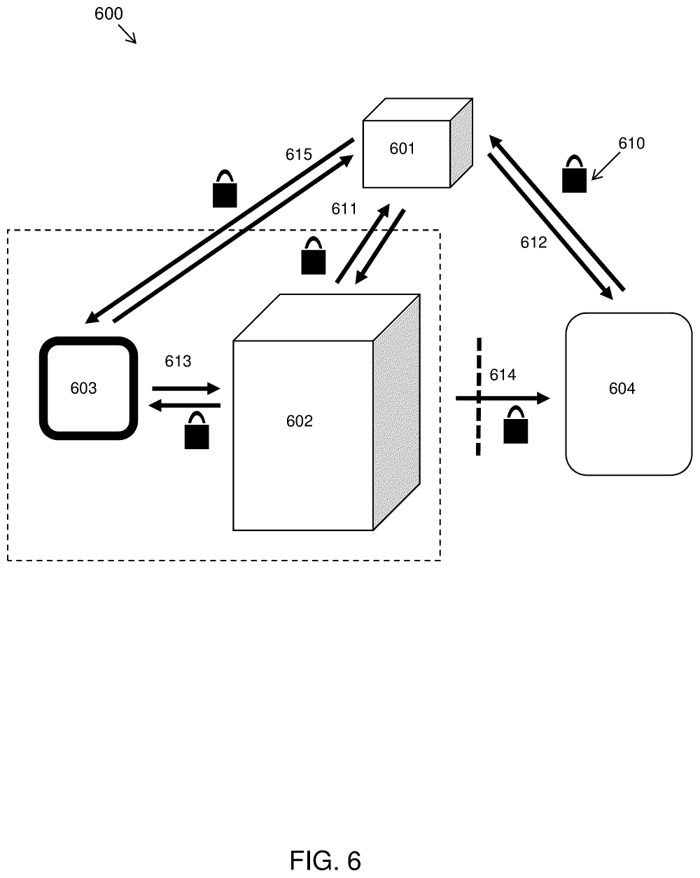

The pre-formation environment and the manufacturing device may communicate locally and/or remotely. Remote may comprise communication that is wireless and/or over a network architecture. The network may comprise a peer-to-peer network. The network architecture may comprise a protocol. FIG. 6 depicts an example 600 of an implementation of data assurance, wherein a manufacturing device (e.g., 3D printer) 602 is in communication with a local component (e.g., processor) 601, a remote component 604, and an interface 603. A communication between at least two components may comprise assured data (e.g., FIG. 6, 610). For example, a communication between at least two components may comprise secured data. Secured data may comprise encryption and/or error detection. In some embodiments, local, remote and/or protected (e.g., through a firewall) communication comprises transmission of secured (e.g., encrypted) data (e.g., FIG. 6, 611-615). The communication may be unidirectional (e.g., one-way, e.g., 614) or bidirectional (e.g., two-way, e.g., 611). In some embodiments, local, remote and/or protected (e.g., through a firewall) communication comprises transmission of unsecured data. The example arrows 611 and 613 designate local communications. The example arrow 614 designates a manufacturing device transmitting (e.g., encrypted) data through a firewall (shown as a discontinuous line). The example arrows 612 and 615 designate a local component communicating with a remote component (e.g., 604) and an interface (e.g., 603), respectively. In some embodiments, a decryption key is provided by a pre-formation environment and/or a manufacturing device. The interface may comprise one or more input and/or display devices. The interface may comprise an input/output (I/O) interface. The I/O interface(s) may comprise one or more wired or wireless connections. The device(s) can include one or more user interfaces (UI). The UI may enable an interaction with a pre-formation environment and/or a manufacturing device. The UI may include one or more keyboards, one or more pointer devices (e.g., mouse, trackpad, touchpad, or joystick), one or more displays (e.g., computer monitor or touch screen), one or more sensors, and/or one or more switches (e.g., electronic switch). In some cases, the UI may be a web-based user interface. The communication of the manufacturing device with a remote component and/or a (e.g., machine) interface may be through a server. The server may be integrated within the manufacturing device. The machine interface may be integrated with, or situated adjacent to, the manufacturing device.

In some embodiments, data security is implemented for a plurality of manufacturing devices that are in communication with a server. The server may be in communication with (e.g., serve data from) one or more pre-formation environments, and/or one or more components of a pre-formation environment, e.g., modules, stages, and/or processors. The server may receive and/or transmit encrypted data. In some embodiments, the server may implement a security (e.g., level). In some embodiments, the server may implement error detection.

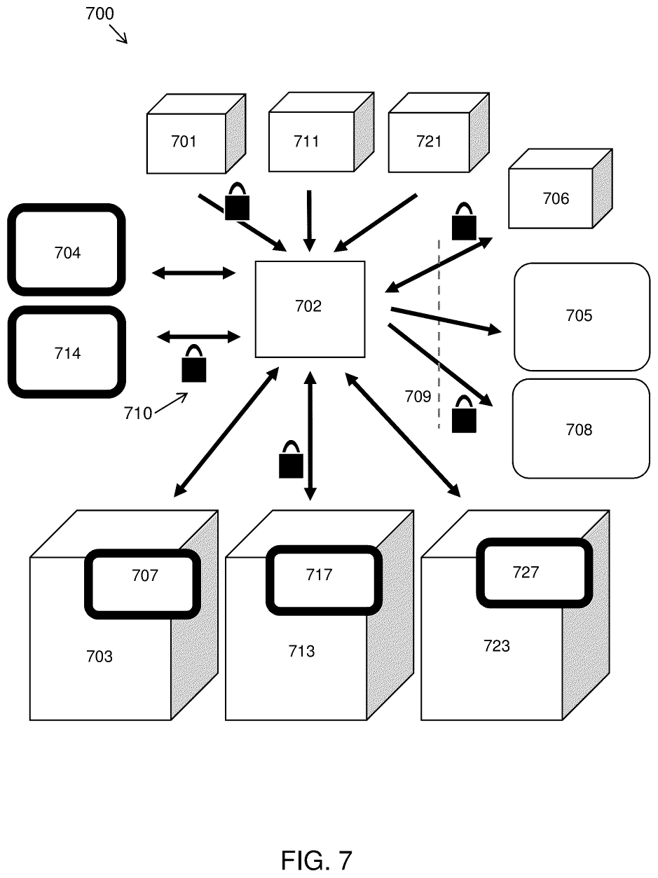

FIG. 7 shows an example of a data assurance implementation 700 for a plurality of manufacturing devices 703, 713, and 723 that are in communication with a server 702. The server may be external to the plurality of manufacturing devices. The manufacturing device(s) may be in communication with one or more interfaces. An interface (e.g., 707, 717, and 727) may be adjacent to (e.g., integrated in) a (e.g., respective) manufacturing device (e.g., 703, 713, and 723). An interface (e.g., 704 and 714) may be distant from the plurality of manufacturing devices. An interface may communicate directly or indirectly with a one or more processors. The one or more processors may be remote and/or local to (e.g., comprised by), a manufacturing device. In some embodiments, the manufacturing device comprises at least one processor. The manufacturing device may comprise a plurality of processors. At least two of the plurality of processors may interact with each other (e.g., directly or indirectly). At times, at least two of the plurality of processors may not interact with each other. Any of the interfaces may be optionally included in a manufacturing device. A communication between at least two components may be unidirectional or bidirectional. A communication between at least two components may comprise assured data (e.g., FIG. 7, 710). For example, a communication between at least two components may comprise secured data. Secured data may comprise encryption and/or error detection.

In some embodiments, a bidirectional communication comprises secured (e.g., encrypted and/or verified) data. In some embodiments, a unidirectional communication comprises secured (e.g., encrypted and/or verified) data. The arrows in FIG. 7 illustration the directionality of the communication (e.g., flow of information direction) between components. A bidirectional communication may comprise a double-headed arrow, and a unidirectional communication may comprise a single-headed arrow. A manufacturing device may be connected directly or indirectly to one or more components. A manufacturing device may be connected directly or indirectly (e.g., through a server) to one or more components that generate and/or direct instructions data (e.g., 701, 711, 721 and/or 706), e.g., related to forming a requested 3D object. The connection may be local (e.g., in 701) or remote (e.g., in 706). The manufacturing device may communicate (e.g., transmit data) with at least one monitoring device (e.g., 705 or 708). Communication may be through a security level, e.g., a firewall (e.g., 709). A component may be owned by an entity supplying the forming instructions to a manufacturing device (e.g., 708), or by a client (e.g., 705). The client may be an entity or person that requests at least one formed 3D object. At least one local processor may be in communication with at least one remote processor. At least one processor may be in communication with a forming device (e.g., 3D printer). The communication may be direct or indirect, e.g., through a server. The communication may be unidirectional or bidirectional.

In some embodiments, the forming agent comprises an energy beam. At times, an energy beam is directed onto a specified area of at least a portion of the target surface for a specified time period. The material in or on the target surface (e.g., powder material such as in a top surface of a powder bed) can absorb the energy from the energy beam and, and as a result, a localized region of the material can increase in temperature. In some instances, one, two, or more 3D objects are generated in a material bed (e.g., a single material bed; the same material bed). The plurality of 3D objects may be generated in the material bed simultaneously or sequentially. At least two 3D objects may be generated side by side. At least two 3D objects may be generated one on top of the other. At least two 3D objects generated in the material bed may have a gap between them (e.g., gap filled with pre-transformed material). At least two 3D objects generated in the material bed may contact (e.g., not connect to) each other. In some embodiments, the 3D objects may be independently built one above the other. The generation of a multiplicity of 3D objects in the material bed may allow continuous creation of 3D objects.

A pre-transformed material may be a powder material. A pre-transformed material layer (or a portion thereof) can have a thickness (e.g., layer height) of at least about 0.1 micrometer (μm), 0.5 μm, 1.0 μm, 10 μm, 50 μm, 100 μm, 150 μm, 200 μm, 300 μm, 400 μm, 500 μm, 600 μm, 700 μm, 800 μm, 900 μm, or 1000 μm. A pre-transformed material layer (or a portion thereof) may have any value of the afore-mentioned layer thickness values (e.g., from about 0.1 μm to about 1000 μm, from about 1 μm to about 800 μm, from about 20 μm to about 600 μm, from about 30 μm to about 300 μm, or from about 10 μm to about 1000 μm).

At times, the pre-transformed material comprises a powder material. The pre-transformed material may comprise a solid material. The pre-transformed material may comprise one or more particles or clusters. The term “powder,” as used herein, generally refers to a solid having fine particles. The powder may also be referred to as “particulate material.” Powders may be granular materials. The powder particles may comprise micro particles. The powder particles may comprise nanoparticles. In some examples, a powder comprises particles having an average FLS of at least about 5 nanometers (nm), 10 nm, 20 nm, 30 nm, 40 nm, 50 nm, 100 nm, 200 nm, 300 nm, 400 nm, 500 nm, 1 μm, 5 μm, 10 μm, 15 μm, 20 μm, 25 μm, 30 μm, 35 μm, 45 μm, 50 μm, 55 μm, 60 μm, 65 μm, 70 μm, 75 μm, 80 μm, or 100 μm. In some embodiments, the powder may have an average fundamental length scale of any of the values of the average particle fundamental length scale listed above (e.g., from about 5 nm to about 100 μm, from about 1 μm to about 100 μm, from about 15 μm to about 45 μm, from about 5 μm to about 80 μm, from about 20 μm to about 80 μm, or from about 500 nm to about 50 μm). The powder in a material bed may be flowable (e.g., retain its flowability) during the printing.

At times, the powder is composed of individual particles. The individual particles can be spherical, oval, prismatic, cubic, or irregularly shaped. The particles can have a FLS. The powder can be composed of a homogenously shaped particle mixture such that all of the particles have substantially the same shape and fundamental length scale magnitude within at most about 1%, 5%, 8%, 10%, 15%, 20%, 25%, 30%, 35%, 40%, 50%, 60%, or 70%, distribution of FLS. In some embodiments, the powder may have a distribution of FLS of any of the values of the average particle FLS listed above (e.g., from at most about 1% to about 70%, about 1% to about 35%, or about 35% to about 70%). In some embodiments, the powder can be a heterogeneous mixture such that the particles have variable shape and/or fundamental length scale magnitude.

At times, at least parts of the layer are transformed to a transformed material that subsequently forms at least a fraction (also used herein “a portion,” or “a part”) of a hardened (e.g., solidified) 3D object. At times a layer of transformed or hardened material may comprise a cross section of a 3D object (e.g., a horizontal cross section). At times a layer of transformed or hardened material may comprise a deviation from a cross section of a 3D object. The deviation may comprise vertical or horizontal deviation.

At times, the pre-transformed material is requested and/or pre-determined for the 3D object. The pre-transformed material can be chosen such that the material is the requested and/or otherwise predetermined material for the 3D object. A layer of the 3D object may comprise a single type of material. For example, a layer of the 3D object may comprise a single metal alloy type. In some examples, a layer within the 3D object may comprise several types of material (e.g., an elemental metal and an alloy, several alloy types, several alloy-phases, or any combination thereof). In certain embodiments, each type of material comprises only a single member of that type. For example, a single member of metal alloy (e.g., Aluminum Copper alloy). In some cases, a layer of the 3D object comprises more than one type of material. In some cases, a layer of the 3D object comprises more than one member of a material type.

In some instances, the elemental metal comprises an alkali metal, an alkaline earth metal, a transition metal, a rare-earth element metal, or another metal. The alkali metal can be Lithium, Sodium, Potassium, Rubidium, Cesium, or Francium. The alkali earth metal can be Beryllium, Magnesium, Calcium, Strontium, Barium, or Radium. The transition metal can be Scandium, Titanium, Vanadium, Chromium, Manganese, Iron, Cobalt, Nickel, Copper, Zinc, Yttrium, Zirconium, Platinum, Gold, Rutherfordium, Dubnium, Seaborgium, Bohrium, Hassium, Meitnerium, Ununbium, Niobium, Iridium, Molybdenum, Technetium, Ruthenium, Rhodium, Palladium, Silver, Cadmium, Hafnium, Tantalum, Tungsten, Rhenium, or Osmium. The transition metal can be mercury. The rare-earth metal can be a lanthanide, or an actinide. The lanthanide metal can be Lanthanum, Cerium, Praseodymium, Neodymium, Promethium, Samarium, Europium, Gadolinium, Terbium, Dysprosium, Holmium, Erbium, Thulium, Ytterbium, or Lutetium. The actinide metal can be Actinium, Thorium, Protactinium, Uranium, Neptunium, Plutonium, Americium, Curium, Berkelium, Californium, Einsteinium, Fermium, Mendelevium, Nobelium, or Lawrencium. The other metal can be Aluminum, Gallium, Indium, Tin, Thallium, Lead, or Bismuth.

In some instances, the metal alloy comprises an iron based alloy, nickel based alloy, cobalt based allow, chrome based alloy, cobalt chrome based alloy, titanium based alloy, magnesium based alloy, copper based alloy, or any combination thereof. The alloy may comprise an oxidation or corrosion resistant alloy. The alloy may comprise a super alloy (e.g., Inconel). The super alloy may comprise Inconel 600, 617, 625, 690, 718, or X-750. The metal (e.g., alloy or elemental) may comprise an alloy used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The metal (e.g., alloy or elemental) may comprise an alloy used for products comprising a device, medical device (human & veterinary), machinery, cell phone, semiconductor equipment, generators, turbine, stator, motor, rotor, impeller, engine, piston, electronics (e.g., circuits), electronic equipment, agriculture equipment, gear, transmission, communication equipment, computing equipment (e.g., laptop, cell phone, i-pad), air conditioning, generators, furniture, musical equipment, art, jewelry, cooking equipment, or sport gear. The impeller may be a shrouded (e.g., covered) impeller that is produced as one piece (e.g., comprising blades and cover) during one 3D printing procedure. The 3D object may comprise a blade. The impeller may be used for pumps (e.g., turbo pumps). Examples of an impeller and/or blade can be found in U.S. patent application Ser. No. 15/435,128, filed on Feb. 16, 2017; PCT patent application number PCT/US17/18191, filed on Feb. 16, 2017; or European patent application number. EP17156707.6, filed on Feb. 17, 2017, all titled “ACCURATE THREE-DIMENSIONAL PRINTING,” each of which is incorporated herein by reference in its entirety where non-contradictory. The metal (e.g., alloy or elemental) may comprise an alloy used for products for human and/or veterinary applications comprising implants, or prosthetics. The metal alloy may comprise an alloy used for applications in the fields comprising human and/or veterinary surgery, implants (e.g., dental), or prosthetics.

In some instances, the alloy includes a superalloy. The alloy may include a high-performance alloy. The alloy may include an alloy exhibiting at least one of: excellent mechanical strength, resistance to thermal creep deformation, good surface stability, resistance to corrosion, and resistance to oxidation. The alloy may include a face-centered cubic austenitic crystal structure. The alloy may comprise Hastelloy, Inconel, Waspaloy, Rene alloy (e.g., Rene-80, Rene-77, Rene-220, or Rene-41), Haynes alloy, Incoloy, MP98T, TMS alloy, MTEK (e.g., MTEK grade MAR-M-247, MAR-M-509, MAR-M-R41, or MAR-M-X-45), or CMSX (e.g., CMSX-3, or CMSX-4). The alloy can be a single crystal alloy.

In some instances, the iron alloy comprises Elinvar, Fernico, Ferroalloys, Invar, Iron hydride, Kovar, Spiegeleisen, Staballoy (stainless steel), or Steel. In some instances, the metal alloy is steel. The Ferroalloy may comprise Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, or Ferrovanadium. The iron alloy may comprise cast iron, or pig iron. The steel may comprise Bulat steel, Chromoly, Crucible steel, Damascus steel, Hadfield steel, High speed steel, HSLA steel, Maraging steel, Maraging steel (M300), Reynolds 531, Silicon steel, Spring steel, Stainless steel, Tool steel, Weathering steel, or Wootz steel. The high-speed steel may comprise Mushet steel. The stainless steel may comprise AL-6XN, Alloy 20, celestrium, marine grade stainless, Martensitic stainless steel, surgical stainless steel, or Zeron 100. The tool steel may comprise Silver steel. The steel may comprise stainless steel, Nickel steel, Nickel-chromium steel, Molybdenum steel, Chromium steel, Chromium-vanadium steel, Tungsten steel, Nickel-chromium-molybdenum steel, or Silicon-manganese steel. The steel may be comprised of any Society of Automotive Engineers (SAE) grade steel such as 440F, 410, 312, 430, 440A, 440B, 440C, 304, 305, 304L, 304L, 301, 304LN, 301LN, 2304, 316, 316L, 316LN, 316, 316LN, 316L, 316L, 316, 317L, 2205, 409, 904L, 321, 254SMO, 316Ti, 321 H, or 304H. The steel may comprise stainless steel of at least one crystalline structure selected from the group consisting of austenitic, superaustenitic, ferritic, martensitic, duplex, and precipitation-hardening martensitic. Duplex stainless steel may be lean duplex, standard duplex, super duplex, or hyper duplex. The stainless steel may comprise surgical grade stainless steel (e.g., austenitic 316, martensitic 420, or martensitic 440). The austenitic 316 stainless steel may comprise 316L, or 316LVM. The steel may comprise 17-4 Precipitation Hardening steel (e.g., type 630, a chromium-copper precipitation hardening stainless steel, 17-4PH steel).

In some instances, the titanium-based alloy comprises alpha alloy, near alpha alloy, alpha and beta alloy, or beta alloy. The titanium alloy may comprise grade 1, 2, 2H, 3, 4, 5, 6, 7, 7H, 8, 9, 10, 11, 12, 13, 14, 15, 16, 16H, 17, 18, 19, 20, 21, 2, 23, 24, 25, 26, 26H, 27, 28, 29, 30, 31, 32, 33, 34, 35, 36, 37, 38, or higher. In some instances, the titanium base alloy comprises Ti-6Al-4V or Ti-6Al-7Nb.

In some instances, the Nickel alloy comprises Alnico, Alumel, Chromel, Cupronickel, Ferronickel, German silver, Hastelloy, Inconel, Monel metal, Nichrome, Nickel-carbon, Nicrosil, Nisil, Nitinol, or Magnetically “soft” alloys. The magnetically “soft” alloys may comprise Mu-metal, Permalloy, Supermalloy, or Brass. The brass may comprise Nickel hydride, Stainless or Coin silver. The cobalt alloy may comprise Megallium, Stellite (e. g. Talonite), Ultimet, or Vitallium. The chromium alloy may comprise chromium hydroxide, or Nichrome.

In some instances, the aluminum alloy comprises AA-8000, Al—Li (aluminum-lithium), Alnico, Duralumin, Hiduminium, Kryron Magnalium, Nambe, Scandium-aluminum, or Y alloy. The magnesium alloy may comprise Elektron, Magnox, or T-Mg—Al—Zn (Bergman-phase) alloy.

In some instances, the copper alloy comprises Arsenical copper, Beryllium copper, Billon, Brass, Bronze, Constantan, Copper hydride, Copper-tungsten, Corinthian bronze, Cunife, Cupronickel, Cymbal alloys, Devarda's alloy, Electrum, Hepatizon, Heusler alloy, Manganin, Molybdochalkos, Nickel silver, Nordic gold, Shakudo, or Tumbaga. The Brass may comprise Calamine brass, Chinese silver, Dutch metal, Gilding metal, Muntz metal, Pinchbeck, Prince's metal, or Tombac. The Bronze may comprise Aluminum bronze, Arsenical bronze, Bell metal, Florentine bronze, Guanin, Gunmetal, Glucydur, Phosphor bronze, Ormolu, or Speculum metal. The copper alloy may be a high-temperature copper alloy (e.g., GRCop-84).

In some instances, the metal alloys are Refractory Alloys. The refractory metals and alloys may be used for heat coils, heat exchangers, furnace components, or welding electrodes. The Refractory Alloys may comprise a high melting points, low coefficient of expansion, mechanically strong, low vapor pressure at elevated temperatures, high thermal conductivity, or high electrical conductivity.

In some examples, the material (e.g., pre-transformed material) comprises a material wherein its constituents (e.g., atoms or molecules) readily lose their outer shell electrons, resulting in a free-flowing cloud of electrons within their otherwise solid arrangement. In some examples the material is characterized in having high electrical conductivity, low electrical resistivity, high thermal conductivity, or high density (e.g., as measured at ambient temperature (e.g., R.T., or 20° C.)). The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times,” or “multiplied by.” The high electrical conductivity can be any value between the afore-mentioned electrical conductivity values (e.g., from about 1*10⁵ S/m to about 1*10⁸ S/m). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸, or 1*10⁻⁸ Ω*m. The low electrical resistivity can be any value between the afore-mentioned electrical resistivity values (e.g., from about 1*10⁻⁵ Ω*m to about 1*10⁻⁸ Ω*m). The high thermal conductivity may be at least about 20 Watts per meters times Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be any value between the afore-mentioned thermal conductivity values (e.g., from about 20 W/mK to about 1000 W/mK). The high density may be at least about 1.5 grams per cubic centimeter (g/cm³), 2 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the afore-mentioned density values (e.g., from about 1 g/cm³ to about 25 g/cm³, from about 1 g/cm³ to about 10 g/cm³, or from about 10 g/cm³ to about 25 g/cm³).

At times, a metallic material (e.g., elemental metal or metal alloy) comprises small amounts of non-metallic materials, such as, for example, oxygen, sulfur, or nitrogen. In some cases, the metallic material can comprise the non-metallic material in a trace amount. A trace amount can be at most about 100000 parts per million (ppm), 10000 ppm, 1000 ppm, 500 ppm, 400 ppm, 200 ppm, 100 ppm, 50 ppm, 10 ppm, 5 ppm, or 1 ppm (based on weight, w/w) of non-metallic material. A trace amount can comprise at least about 10 ppt, 100 ppt, 1 ppb, 5 ppb, 10 ppb, 50 ppb, 100 ppb, 200 ppb, 400 ppb, 500 ppb, 1000 ppb, 1 ppm, 10 ppm, 100 ppm, 500 ppm, 1000 ppm, or 10000 ppm (based on weight, w/w) of non-metallic material. A trace amount can be any value between the afore-mentioned trace amounts (e.g., from about 10 parts per trillion (ppt) to about 100000 ppm, from about 1 ppb to about 100000 ppm, from about 1 ppm to about 10000 ppm, or from about 1 ppb to about 1000 ppm).

In some embodiments, a pre-transformed material within the enclosure is in the form of a powder, wires, sheets, or droplets. The material (e.g., pre-transformed, transformed, and/or hardened) may comprise elemental metal, metal alloy, ceramics, an allotrope of elemental carbon, polymer, and/or resin. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball, or a carbon nanotube. The ceramic material may comprise cement. The ceramic material may comprise alumina, zirconia, or carbide (e.g., silicon carbide, or tungsten carbide). The ceramic material may comprise high performance material (HPM). The ceramic material may comprise a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon-based polymer or a resin. The material may comprise an organosilicon-based material. The material may comprise silicon and hydrogen atoms. The material may comprise silicon and carbon atoms. In some embodiments, the material may exclude a silicon-based material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) and/or wires. The bound material can comprise chemical bonding. Transforming can comprise chemical bonding. Chemical bonding can comprise covalent bonding. The pre-transformed material may be pulverous. The printed 3D object can be made of a single material (e.g., single material type) or multiple materials (e.g., multiple material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or comprising (e.g., with) metal alloy. The material may comprise a stainless steel. The material may comprise a titanium alloy, aluminum alloy, and/or nickel alloy.

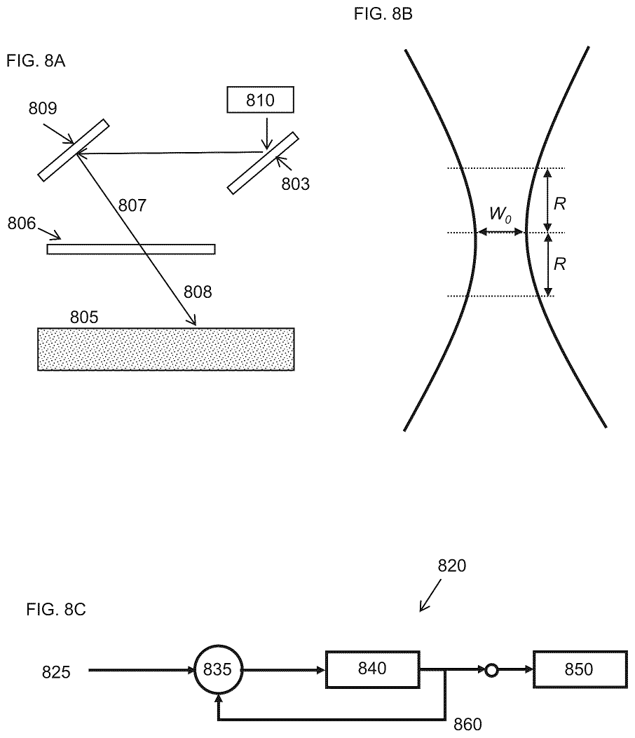

In some embodiments, the manufacturing device includes an optical system. The optical system may be used to control the one or more transforming agents (e.g., energy beams). The energy beams may comprise a single mode beam (e.g., Gaussian beam) or a multi-mode beam. The optical system may be coupled with or separate from an enclosure. The optical system may be enclosed in an optical enclosure (e.g., FIG. 1, 131). FIG. 8A shows an example of an optical system in which an energy beam is projected from the energy source 810, is deflected by two mirrors 803 and 809, and travels through an optical element 806 prior to reaching target 805 (e.g., an exposed surface of a material bed comprising a pre-transformed material and/or hardened or partially hardened material such as from a previous transformation operation). The optical system may comprise more than one optical element. In some cases, the optical element comprises an optical window (e.g., for transmitting the energy beam into the enclosure). In some embodiments, the optical element comprises a focus altering device, e.g., for altering (e.g., focusing or defocusing) an incoming energy beam (e.g., FIG. 8A, 807) to an outgoing energy beam (e.g., FIG. 8A, 808). The focus altering device may comprise a lens. In some embodiments, aspects of the optical system are controlled by one or more controllers of the printer. For example, one or more controllers may control one or more mirrors (e.g., of galvanometer scanners) that directs movement of the one or more energy beams in real time. Examples of various aspects of optical systems and their components can be found in U.S. patent application Ser. No. 15/435,128, filed on Feb. 16, 2017, titled “ACCURATE THREE-DIMENSIONAL PRINTING;” international patent application number PCT/US17/18191, filed on Feb. 16, 2017, titled “ACCURATE THREE-DIMENSIONAL PRINTING;” European patent application number EP17156707.6, filed on Feb. 17, 2017, titled “ACCURATE THREE-DIMENSIONAL PRINTING;” international patent application number PCT/US17/64474, filed Dec. 4, 2017, titled “OPTICS, DETECTORS, AND THREE-DIMENSIONAL PRINTING;” and international patent application number PCT/US18/12250, filed Jan. 3, 2018, titled “OPTICS IN THREE-DIMENSIONAL PRINTING,” each of which is entirely incorporated herein by reference.

In some cases, the optical system modifies a focus of the one or more energy beams at the target surface (or adjacent thereto, e.g., above or below the target surface to form a defocused beam spot at the target surface). In some embodiments, the energy beam is (e.g., substantially) focused at the target surface. In some embodiments, the energy beam is defocused at the target surface. An energy beam that is focused at the target surface may have a (e.g., substantially) minimum spot size at the target surface. An energy beam that is defocused at the target surface may have a spot size at the target surface that is (e.g., substantially) greater than the minimum spot size, for example, by a pre-determined amount. For example, a Gaussian energy beam that is defocused at the target surface can have spot size that is outside of a Rayleigh distance from the energy beams focus (also referred to herein as the beam waist). FIG. 8B shows an example profile of a Gaussian beam as a function of distance. The target surface of a focused energy beam may be within a Rayleigh distance (e.g., FIG. 8B, R) from the beam waist (e.g., FIG. 8B, W₀).

In some cases, one or more controllers control the operation of one or more components of a manufacturing device. For example, one or more controllers may control one or more aspects (e.g., movement and/or speed) of a layer forming apparatus. One or more controllers may control one or more aspects of an energy source (e.g., energy beam power, scan speed and/or scan path). One or more controllers may control one or more aspects of an energy beam optical system (e.g., energy beam scan path and/or energy beam focus). One or more controllers may control one or more operations of a gas flow system (e.g., gas flow speed and/or direction). In some embodiments, one or more controllers control aspects of multiple components or systems. For example, a first controller can control aspects of the energy source(s), a second controller can control aspects of a layer forming apparatus(es), and a third controller can control aspects of a gas flow system. In some embodiments, one or more controller controls aspect of one component or system. For example, multiple controllers may control aspects of an optical system. For instance, a first controller can control the path of the one or more energy beams, a second controller may control scan speed of the one or more energy beams, and a third controller may control a focus of the one or more energy beams. As another example, multiple controllers may control aspects of an energy source. For instance, a first controller can control the power of one or more energy beams, a second controller may control pulsing (e.g., pulse versus continuous, or pulse rate) of the one or more energy beams, and a third controller may control a power profile over time (e.g., ramp up and down) one or more energy beams. At times, the first controller, second controller, and the third controller are the same controller. At times, at least two of the first controller, second controller, and the third controller are different controllers. Any combination of one or more controllers may control aspects of one or more components or systems of a printer. The one or more controllers may control the operations before, during, and/or after the printing, or a portion of the printing (irradiation operation). The controller may comprise an electrical circuitry, one or more electrical wiring, a signal receiver, and/or a signal emitter. The controller may be operatively coupled to one or more components of the forming apparatus via a connecter and/or signal communication. The connection may be wired and/or wireless. The controller may communicate via signal receipt and/or transmission. The signal may comprise electrical, optical or audio signal.

In some instances, the controller(s) can include (e.g., electrical) circuitry that is configured to generate output (e.g., voltage signals) for directing one or more aspects of the apparatuses (or any parts thereof) described herein. FIG. 8C shows a schematic example of a (e.g., automatic) controller (e.g., a control system, or a controller) 820 that is programmed or otherwise configured to facilitate formation of one or more 3D objects. The controller may comprise an electrical circuitry. The controller may comprise a connection to an electrical power. The controller (e.g., FIG. 8C, 820) can comprise a subordinate-controller 840 for controlling formation of at least one 3D object (e.g., FIG. 8C, 850). The controller may comprise one or more loop schemes (e.g., open loop, feed-forward loop and/or feedback loop). In the example of FIG. 8C, the controller optionally includes feedback control loop 860. The subordinate-controller may be an internal-controller. The controller (e.g., or subordinate controller) may comprise a proportion-integral-derivative (PID) loop. The subordinate-controller can be a second-controller as part of the first controller. The subordinate-controller can be a linear controller. The controller may be configured to control one or more components of the forming tool. The controller may be configured to control a transforming agent generator (e.g., an energy source, a dispenser of the binding agent and/or reactive agent), a guidance mechanism (e.g., scanner and/or actuator), at least one component of a layer dispenser, a dispenser (e.g., of a pre-transformed material and/or a transforming agent), at least one component of a gas flow system, at least one component of a chamber in which the 3D object is formed (e.g., a door, an elevator, a valve, a pump, and/or a sensor). The controller may control at least one component of the forming apparatus such as the forming agent (e.g., transforming agent). For example, the controller (e.g., FIG. 8C, 820) may be configured to control (e.g., in real time, during at least a portion of the 3D printing) a controllable property comprising: (i) an energy beam power (e.g., delivered to the material bed), (ii) temperature at a position in the material bed (e.g., on the forming 3D object), (iii) energy beam speed, (iv) energy beam power density, (v) energy beam dwell time, (vi) energy beam irradiation spot (e.g., on the exposed surface of the material bed), (vii) energy beam focus (e.g., focus or defocus), or (viii) energy beam cross-section (e.g., beam waist). The controller (e.g., FIG. 8C, 820) may be configured to control (e.g., in real time, during at least a portion of the 3D printing) a controllable (e.g., binding and/or reactive agent) property comprising: (i) strength (e.g., reaction rate), (ii) volume (e.g., delivered to the material bed), (iii) density (e.g., on a location of the material bed), or (iv) dwell time (e.g., on the material bed). The controllable property may be a control variable. The control may be to maintain a target parameter (e.g., temperature) of one or more 3D objects being formed. The target parameter may vary in time (e.g., in real time) and/or in location. The location may comprise a location at the exposed surface of the material bed. The location may comprise a location at the top surface of the (e.g., forming) 3D object. The target parameter may correlate to the controllable property. The (e.g., input) target parameter may vary in time and/or location in the material bed (e.g., on the forming 3D object). The subordinate-controller may receive a pre-determined power per unit area (of the energy beam), temperature, and/or metrological (e.g., height) target value. For example, the subordinate-controller may receive a target parameter (e.g., FIG. 8C, 825) (e.g. temperature) to maintain at least one characteristic of the forming 3D object (e.g., dimension in a direction, and/or temperature). The controller can receive multiple (e.g., three) types of target inputs: (i) characteristic of the transforming agent (e.g., energy beam power), (ii) temperature, and (iii) geometry. Any of the target input may be user defined. The geometry may comprise geometrical object pre-print correction. The geometric information may derive from the 3D object (or a correctively deviated (e.g., altered) model thereof). The geometry may comprise geometric information of a previously printed portion of the 3D object (e.g., comprising a local thickness below a given layer, local build angle, local build curvature, proximity to an edge on a given layer, or proximity to layer boundaries). The geometry may be an input to the controller (e.g., via an open loop control scheme). Some of the target values may be used to form 3D forming instructions for generating the 3D object (e.g., FIG. 8C, 850). The forming instructions may be dynamically adjusted in real time. The controller may monitor (e.g., continuously) one or more signals from one or more sensors for providing feedback (e.g., FIG. 8C, 860). For example, the controller may monitor the energy beam power, temperature of a position in the material bed, and/or metrology (e.g., height) of a position on the target surface (e.g., exposed surface of a material bed). The position on the target surface may be of the forming 3D object. The monitor may be continuous or discontinuous. The monitor may be in real-time during the 3D printing. The monitor may be using the one or more sensors. The forming instructions may be dynamically adjusted in real time (e.g., using the signals from the one or more sensors). A variation between the target parameter and the sensed parameter may be used to estimate an error in the value of that parameter (e.g., FIG. 8C, 835). The variation (e.g., error) may be used by the subordinate-controller (e.g., FIG. 8C, 840) to adjust the forming instructions. The controller may control (e.g., continuously) one or more parameters (e.g., in real time). The controller may use historical data (e.g., for the parameters). The historical data may be of previously printed 3D objects, or of previously printed layers of the 3D object. Configured may comprise built, constructed, designed, patterned, or arranged. The hardware of the controller may comprise the control-model. The control-model may be linear or non-linear. For example, the control-model may be non-linear. The control-model may comprise linear or non-linear modes. The control-model may comprise free parameters which may be estimated using a characterization process. The characterization process may be before, during and/or after the 3D printing. The control-model may be wired to the controller. The control model can be configured into the controller (e.g., before and/or during the 3D printing). Examples of a controller, subordinate controller, and/or control-model can be found in patent application serial number PCT/US16/59781; patent application serial number PCT/US17/18191; U.S. patent application Ser. No. 15/435,065; patent application serial number EP17156707; and/or patent application serial number PCT/US17/54043; each of which is incorporated herein by reference in its entirety.

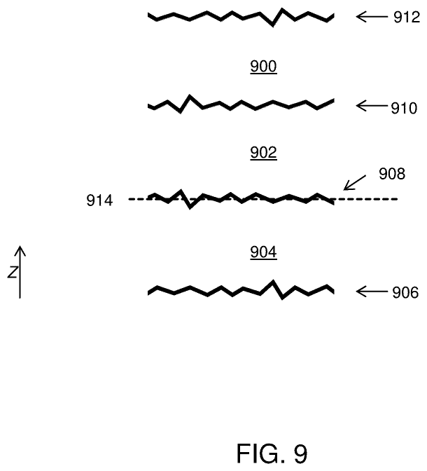

In some embodiments, a (e.g., geometric) model comprises at least two layers. Layers of the geometric model may correspond to (e.g., successive) layers of the formed 3D object (e.g., that formed in a layer-wise manner) and/or (e.g., virtual) slices of the geometric model. In some cases, a layer comprises a layering plane that corresponds to an average layering plane. FIG. 9 shows an example schematic vertical cross section of a portion of a 3D object having layers of hardened material 900, 902, and 904 that are sequentially formed during a 3D forming procedure. Boundaries (e.g., FIG. 9, 906, 908, 910 and 912) between the layers may be visible (e.g., by human eye or using microscopy). The microscopy method may comprise optical microscopy, scanning electron microscopy, or transmission electron microscopy. The boundaries between the layers may be evident by a microstructure of the 3D object. The boundaries between the layers may be (e.g., substantially) planar. The boundaries between the layers may have some irregularity (e.g., roughness) due to the transformation (e.g., melting and or sintering) process (e.g., and formation of any microstructure such as melt pools). An average layering plane (e.g., FIG. 9, 914) may correspond to a (e.g., imaginary) plane that is an estimated or calculated average. A calculated average may correspond to an arithmetic mean of (e.g., a number of) point locations on a boundary between layers. A calculated average may be calculated using, for example, a linear regression analysis. In some cases, the average layering plane consider deviations from a nominal planar shape.

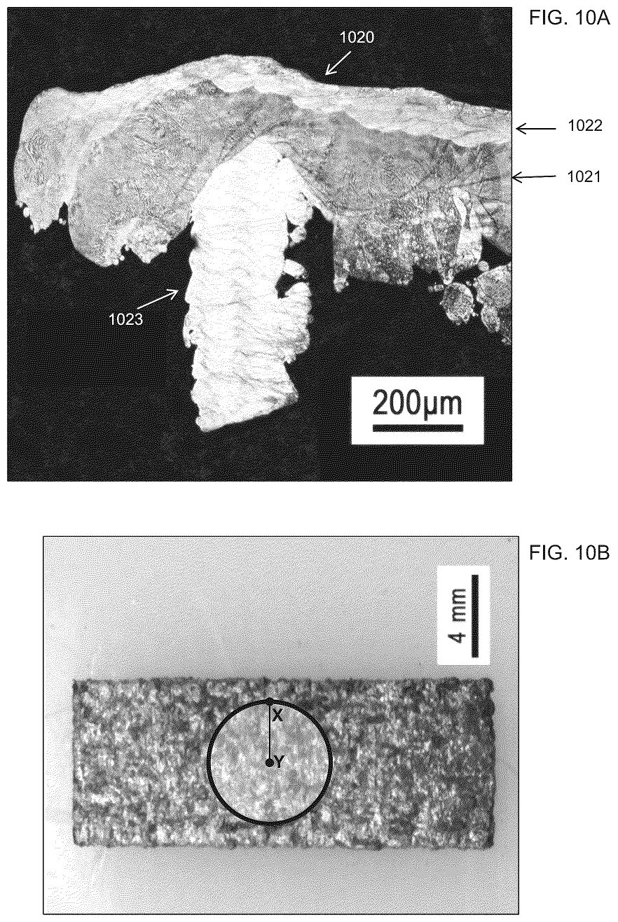

In some cases, (e.g., a portion of) auxiliary features (e.g., supports) are removed from the 3D object after printing. Removal can comprise machining (e.g., cutting, sawing and/or milling), polishing (e.g., sanding) and/or etching. Removal can comprise beam (e.g., laser) etching or chemical etching. In some cases, the supports (or a portion thereof) remain in and/or on the 3D object after printing. In some cases, the one or more supports leave respective one or more support marks on the 3D object that are indicative of a presence or removal of the one or more supports. FIG. 10A shows an example of a vertical cross section of a 3D object that includes a main portion 1020 coupled with a support 1023. In some cases, the main portion comprises multiple layers (e.g., 1021 and 1022) that were sequentially added (e.g., after formation of the support) during a printing operation. In some cases, the support causes one or more layers of the portion of the 3D object to deform during printing. Sometimes, the deformed layers form a detectable (e.g., visible) mark. The mark may be a region of discontinuity in the layer, such as a microstructure discontinuity and/or an abrupt microstructural variation (e.g., FIG. 10A). The discontinuity in the microstructure may be explained by an inclusion of a foreign object (e.g., the support). The microstructural variation may include (e.g., abruptly) altered melt pools and/or grain structure (e.g., crystals, e.g., dendrites) at or near the attachment point of the support. The microstructure variation may be due to differential thermal gradients due to the presence of the support. The microstructure variation may be due to a forced melt pool and/or layer geometry due to the presence of the support. The discontinuity may be at an external surface of the 3D object. The discontinuity may arise from inclusion of the support to the surface of the 3D object (e.g. and may be visible as a breakage of the support when removed from the 3D object (e.g., after printing). In some instances, the 3D object includes two or more support and/or support marks. If more than one support is used, the supports may be spaced apart by a (e.g., pre-determined) distance. FIG. 10B shows an example 3D object having points X and Y on a surface of the 3D object. In some embodiments, X is spaced apart from Y by a support spacing distance. For example, a sphere of radius XY that is centered at X may lack one or more supports (or one or more support marks).

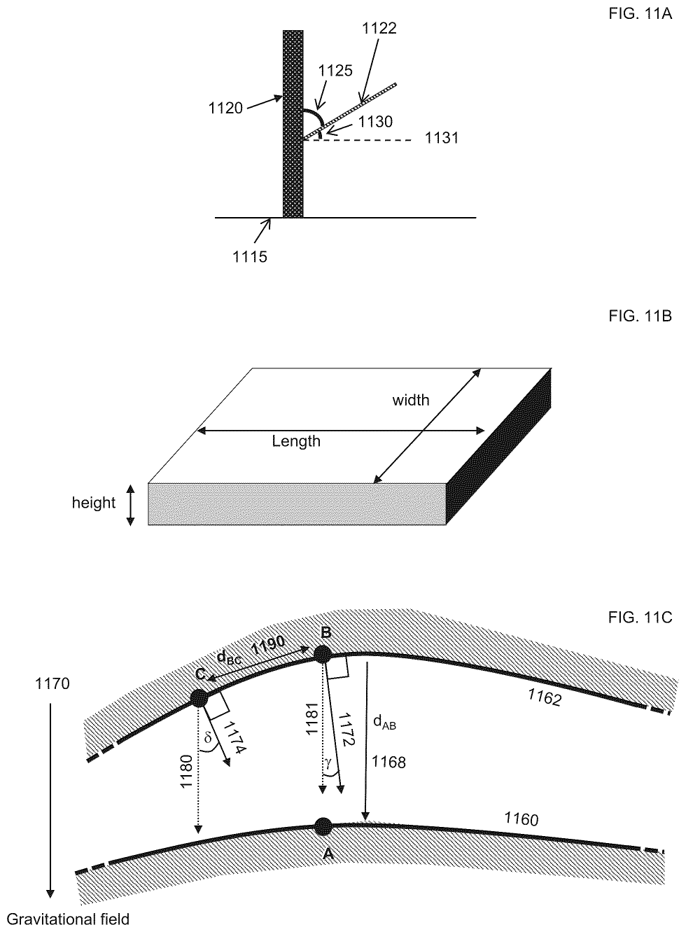

In some embodiments, an overhang is formed on a previously-transformed portion (also referred to herein as rigid portion) of the object. FIG. 11A shows an example schematic depiction of an overhang 1122 connected to a rigid portion 1120. The rigid portion may be connected (e.g., anchored) to a platform (e.g., FIG. 11A, 1115) (e.g., base of the platform). The overhang may be printed without auxiliary supports other than the connection to the one or more rigid portions (e.g., that are part of the 3D object). The overhang may be formed at an angle (e.g., FIG. 11A, 1130) with respect to the build plane and/or platform (e.g., FIG. 11A, 1115). The overhang and/or the rigid portion may be formed from the same or different pre-transformed material (e.g., powder). The overhang can form a first angle (e.g., FIG. 11A, 1125) with respect to the rigid portion (e.g., FIG. 11A, 1120). The overhang can form a second angle (e.g., FIG. 11A, 1130) with respect to a plane (e.g., FIG. 11A, 1131) that is (e.g., substantially) parallel with the support surface of the platform, to the layering plane, and/or normal to global vector (e.g., were the layer refer to the layerwise deposition of the transformed material to form the 3D object). In some embodiments, a plane (e.g., FIG. 11A, 1131) that is (e.g., substantially) parallel with the support surface of the platform corresponds to a layering plane.

In some embodiments, 3D printing methodologies are employed for forming (e.g., printing) at least one 3D object that is substantially two-dimensional, such as a wire or a planar object. The 3D object may comprise a plane-like structure (referred to herein as “planar object,” “three-dimensional plane,” or “3D plane”). The 3D plane may have a relatively small thickness as compared to a relatively large surface area. The 3D plane may have a relatively small height relative to its width and length. For example, the 3D plane may have a small height relative to a large horizontal plane. FIG. 11B shows an example of a 3D plane that is substantially planar (e.g., flat). The 3D plane may be planar, curved, or assume an amorphous 3D shape. The 3D plane may be a strip, a blade, or a ledge. The 3D plane may comprise a curvature. The 3D plane may be curved. The 3D plane may be planar (e.g., flat). The 3D plane may have a shape of a curving scarf. The term “3D plane” is understood herein to be a generic (e.g., curved) 3D surface. For example, the 3D plane may be a curved 3D surface. The one or more layers within the 3D object may be substantially planar (e.g., flat). The planarity of a surface or a boundary the layer may be (e.g., substantially) uniform. Substantially uniform may be relative to the intended purpose of the 3D object. The height of the layer at a position may be compared to an average layering plane. The layering plane can refer to a plane at which a layer of the 3D object is (e.g., substantially) oriented during printing. A boundary between two adjacent (printed) layers of hardened material of the 3D object may define a layering plane. The boundary may be apparent by, for example, one or more melt pool terminuses (e.g., bottom or top). A 3D object may include a plurality of layering planes (e.g., with each layering plane corresponding to each layer). In some embodiments, the layering planes are (e.g., substantially) parallel to one another. An average layering plane may be defined by a linear regression analysis (e.g., least squares planar fit of the top-most part of the surface of the layer of hardened material). An average layering plane may be a plane calculated by averaging the material height at each selected point on the top surface of the layer of hardened material. The selected points may be within a specified region of the 3D object. The deviation from any point at the surface of the planar layer of hardened material may be at most 20% 15%, 10%, 5%, 3%, 1%, or 0.5% of the height (e.g., thickness) of the layer of hardened material.

FIG. 11C shows an example of a first (e.g., top) surface 1160 and a second (e.g., bottom) surface 1162 of a 3D object. At least a portion of the first and second surface may be separated by a gap. At least a portion of the first surface may be separated from at least a portion of the second surface (e.g., to constitute a gap). The gap may be filled with pre-transformed or transformed (e.g., and subsequently hardened) material, e.g., during the formation of the 3D object. The second surface may be a bottom skin layer. FIG. 11C shows an example of a vertical gap distance 1140 that separates the first surface 1160 from the second surface 1162. Point A (e.g., in FIG. 11C) may reside on the top surface of the first portion. Point B may reside on the bottom surface of the second portion. The second portion may be a cavity ceiling or hanging structure as part of the 3D object. Point B (e.g., in FIG. 11C) may reside above point A. Above (e.g., top) may be with respect to a global vector 1100. For example, for two positions in a 3D printing system, a (e.g., second) position (e.g., FIG. 11C, B) that has a lower global vector value than a (e.g., first) position (e.g., FIG. 11, A) is above the (e.g., second) position. The gap may be the (e.g., shortest) distance (e.g., vertical distance) between points A and B. FIG. 11C shows an example of the gap 1168 that constitutes the shortest distance dAB between points A and B. There may be a first normal to the bottom surface of the second portion at point B. FIG. 11C shows an example of a first normal 1172 to the surface 1162 at point B. The angle between the first normal 1172 and a direction of global vector 1170 may be any angle γ. A global vector may be (a) directed to a gravitational center, (b) directed opposite to the direction of a layer-wise deposition to print a three-dimensional object, and/or (c) normal to a platform configured to support the three-dimensional object during its printing, and directed opposite to a surface of the platform that supports the three-dimensional object. Point C may reside on the bottom surface of the second portion. There may be a second normal to the bottom surface of the second portion at point C. FIG. 11C shows an example of the second normal 1174 to the surface 1162 at point C. The angle between the second normal 1174 and the global vector 1170 may be any angle δ. Vectors 1180, and 1181 are parallel to the global vector 1170. The angles γ and δ may be the same or different. The angle between the first normal 1172 and/or the second normal 1174 to the global vector 1100 may be any angle alpha disclosed herein. For example, alpha may be at most about 45°, 40°, 30°, 20°, 10°, 5°, 3°, 2°, 1°, or 0.5°. The angle alpha may be any value of the afore-mentioned values (e.g., at most about to about 0.5°, from about 45° to about 20°, or from about 20° to about 0.5°). Examples of an auxiliary support structure and auxiliary support feature spacing distance (e.g., the shortest distance between points B and C) can be found in Patent Application Serial No. PCT/US15/36802 filed on Jun. 19, 2015, titled “APPARATUSES, SYSTEMS AND METHODS FOR THREE-DIMENSIONAL PRINTING,” which is entirely incorporated herein by reference in its entirety. For example, the shortest distance BC (e.g., d_{BC}) may be at least about 0.1 millimeters (mm), 0.5 mm, 1 mm, 1.5 mm, 2 mm, 3 mm, 4 mm, 5 mm, 10 mm, 15 mm, 20 mm, 25 mm, 35 mm, 40 mm, 50 mm, 100 mm, 200 mm, 300 mm, 400 mm, or 500 mm. FIG. 11C shows an example of the shortest distance BC (e.g., 1190, d_{BC}). The bottom skin layer may be the first surface and/or the second surface. The bottom skin layer may be the first formed layer of the 3D object. The bottom skin layer may be a first formed hanging layer in the 3D object (e.g., that is separated by a gap from a previously formed layer of the 3D object). The vertical distance of the gap may be at least about 30 μm, 35 μm, 40 μm, 50 μm, 60 μm, 70 μm, 80 μm, 90 μm, 100 μm, 150 μm, 200 μm, 0.05 mm, 0.1 mm, 0.25 mm, 0.5 mm, 1 mm, 2 mm, 3 mm, 4 mm, 5 mm, 6 mm, 7 mm, 8 mm, 9 mm, 10 mm or 20 mm. The vertical distance of the gap may be any value between the afore-mentioned values (e.g., from about 30 μm to about 200 μm, from about 100 μm to about 200 μm, from about 30 μm to about 100 mm, from about 80 mm to about 150 mm, from about to about 20 mm, from about 0.05 mm to about 0.5 mm, from about 0.2 mm to about 3 mm, from about 0.1 mm to about 10 mm, or from about 3 mm to about 20 mm).

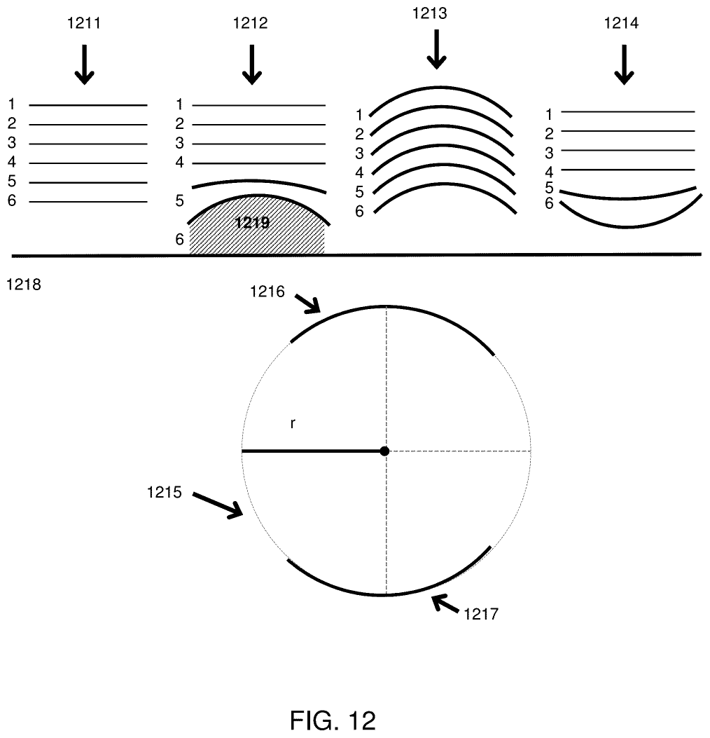

The one or more layers within the 3D object may be (e.g., substantially) planar (e.g., flat). The planarity of the layer may be (e.g., substantially) uniform. The height of the layer at a particular position may be compared to an average plane. The average plane may be defined by a least squares planar fit of the top-most part of the surface of the layer of hardened material. The average plane may be a plane calculated by averaging the material height at each point on the top surface of the layer of hardened material. The deviation from any point at the surface of the planar layer of hardened material may be at most 20% 15%, 10%, 5%, 3%, 1%, or 0.5% of the height (e.g., thickness) of the layer of hardened material. The (e.g., substantially) planar one or more layers may have a large radius of curvature. An example of a layering plane can be seen in FIG. 12 showing a vertical cross section of a 3D object 1211 that comprises layers 1 to 6, each of which are substantially planar. FIG. 12 shows an example of a vertical cross section of a 3D object 1212 comprising planar layers (layers numbers 1-4) and non-planar layers (e.g., layers numbers 5-6) that have a radius of curvature. The curvature can be positive or negative with respect to the platform and/or the exposed surface of the material bed. For example, layered structure 1212 comprises layer number 6 that has a curvature that is negative, as the volume (e.g., area in a vertical cross section of the volume) bound from the bottom of it to the platform 1218 is a convex object 1219. Layer number 5 of 1212 has a curvature that is negative. Layer number 6 of 1212 has a curvature that is more negative (e.g., has a curvature of greater negative value) than layer number 5 of 1212. Layer number 4 of 1212 has a curvature that is (e.g., substantially) zero. Layer number 6 of 1214 has a curvature that is positive. Layer number 6 of 1212 has a curvature that is more negative than layer number 5 of 1212, layer number 4 of 1212, and layer number 6 of 1214. Layer numbers 1-6 of 1213 are of substantially uniform (e.g., negative curvature). FIG. 12, 1216 and 1217 are super-positions of curved layer on a circle 1215 having a radius of curvature “r.” The one or more layers may have a radius of curvature equal to the radius of curvature of the layer surface. The radius of curvature may equal infinity (e.g., when the layer is flat). The radius of curvature of the layer surface (e.g., all the layers of the 3D object) may have a value of at least about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The radius of curvature of the layer surface (e.g., all the layers of the 3D object) may have a value of at most about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, 100 m, or infinity (i.e., flat, or planar layer). The radius of curvature of the layer surface (e.g., all the layers of the 3D object) may have any value between any of the afore-mentioned values of the radius of curvature (e.g., from about 10 cm to about 90 m, from about 50 cm to about 10 m, from about 5 cm to about 1 m, from about 50 cm to about 5 m, from about 5 cm to infinity, or from about 40 cm to about 50 m). In some embodiments, a layer with an infinite radius of curvature is a layer that is planar. In some examples, the one or more layers may be included in a planar section of the 3D object, or may be a planar 3D object (e.g., a flat plane). In some instances, part of at least one layer within the 3D object has the radius of curvature mentioned herein.

At times, one or more controllers are configured to control (e.g., direct) one or more apparatuses and/or operations. Control may comprise regulate, modulate, adjust, maintain, alter, change, govern, manage, restrain, restrict, direct, guide, oversee, manage, preserve, sustain, restrain, temper, or vary. The control configuration (e.g., “configured to”) may comprise programming. The controller may comprise an electronic circuitry, and electrical inlet, or an electrical outlet. The configuration may comprise facilitating (e.g., and directing) an action or a force. The force may be magnetic, electric, pneumatic, hydraulic, and/or mechanic. Facilitating may comprise allowing use of ambient (e.g., external) forces (e.g., gravity). Facilitating may comprise alerting to and/or allowing: usage of a manual force and/or action. Alerting may comprise signaling (e.g., directing a signal) that comprises a visual, auditory, olfactory, or a tactile signal.

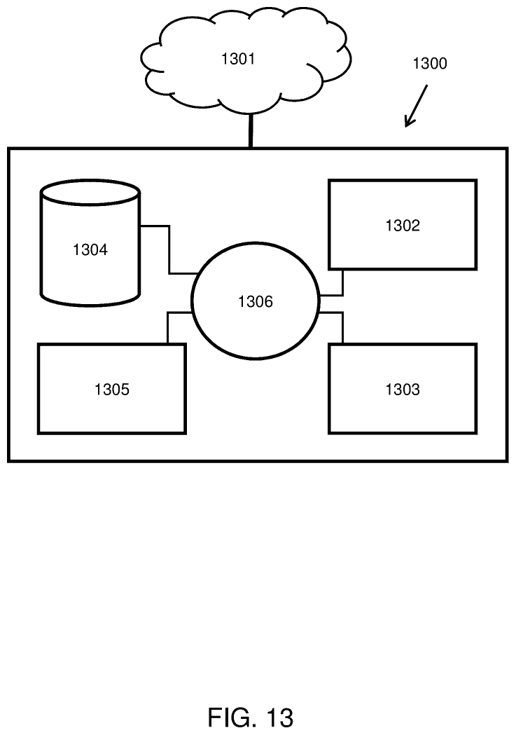

The controller may comprise processing circuitry (e.g., a processing unit). The processing unit may be central. The processing unit may comprise a central processing unit (herein “CPU”). The controllers or control mechanisms (e.g., comprising a computer system) may be configured to, e.g., programmed to implement methods of the disclosure. The controller may control at least one component of the systems and/or apparatuses disclosed herein. FIG. 13 is a schematic example of a computer system 1300 that is programmed or otherwise configured to facilitate the formation of a 3D object according to the methods provided herein. The computer system 1300 can control (e.g., direct and/or regulate) various features of printing methods, apparatuses and systems of the present disclosure, such as, for example, generation of forming instructions for formation of a 3D object. Generated forming instructions may comprise application of a pre-transformed material, application of an amount of energy (e.g., radiation) emitted to a selected location, a detection system activation and deactivation, sensor data and/or signal acquisition, image processing, process parameters (e.g., dispenser layer height, planarization, chamber pressure), or any combination thereof. The computer system 1300 can implement at least one data assurance measure. The data assurance measure may comprise a security (e.g., level) and/or error detection for at least a part of a file, e.g., that is related to forming instructions for a requested 3D object. The computer system 1300 can be part of, or be in communication with, a printing system or apparatus, such as a 3D printing system or apparatus of the present disclosure. The processor may be coupled to one or more mechanisms disclosed herein, and/or any parts thereof. For example, the computer may be coupled to one or more energy sources, optical elements, processing chamber, build module, platform, sensors, valves, switches, motors, pumps, or any combination thereof.

The computer system 1300 can include a processing unit 1306 (also “processor,” “computer” and “computer processor” used herein). The computer system may include memory or memory location 1302 (e.g., random-access memory, read-only memory, flash memory), electronic storage unit 1304 (e.g., hard disk), communication interface 1303 (e.g., network adapter) for communicating with one or more other systems, and peripheral devices 1305, such as cache, other memory, data storage and/or electronic display adapters. The memory 1302, storage unit 1304, interface 1303, and peripheral devices 1305 are in communication with the processing unit 1306 through a communication bus (solid lines), such as a motherboard. The storage unit can be a data storage unit (or data repository) for storing data. The computer system can be operatively coupled to a computer network (“network”) 1301 with the aid of the communication interface. The network can be the Internet, an Internet and/or extranet, or an intranet and/or extranet that is in communication with the Internet. The network in some cases is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 1302. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a system on module (SOM) a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 1300 can be included in the circuit.

The storage unit 1304 can store files, such as drivers, libraries, and saved programs. The storage unit can store user data, e.g., user preferences and user programs. The storage unit may store one or more geometric models. The storage unit may store encryption and/or decryption keys. The computer system in some cases can include one or more additional data storage units that are external to the computer system, such as located on a remote server that is in communication with the computer system through an intranet or the Internet.

The computer system can communicate with one or more remote computer systems through the network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system via the network.

Methods as described herein can be implemented by way of machine (e.g., computer processor) executable code stored on an electronic storage location of the computer system, such as, for example, on the memory 1302 or electronic storage unit 1304. The machine executable or machine-readable code can be provided in the form of software. During use, the processor 1306 can execute the code. In some cases, the code can be retrieved from the storage unit and stored on the memory for ready access by the processor. In some situations, the electronic storage unit can be precluded, and machine-executable instructions are stored on memory.

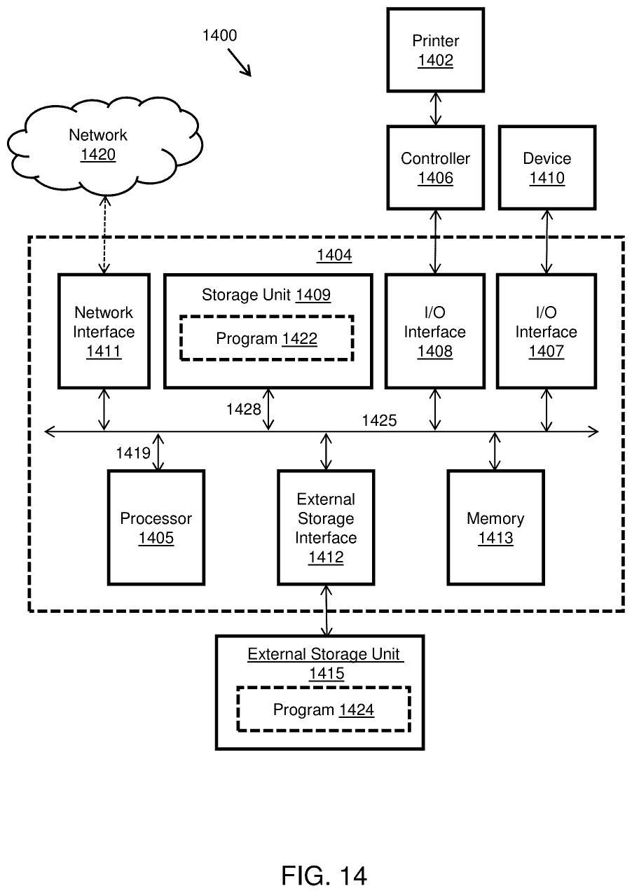

FIG. 14 shows an example computer system 1400, upon which the various arrangements described, can be practiced. The computer system (e.g., FIG. 14, 1400) can control and/or implement (e.g., direct and/or regulate) various features of printing methods, apparatus and/or system operations of the present disclosure. For example, the computer system can be used to instantiate a forming instructions engine. A forming instructions engine may generate instructions to control energy source parameters, processing chamber parameters (e.g., chamber pressure, gas flow and/or temperature), energy beam parameters (e.g., scanning rate, path and/or power), platform parameters (e.g., location and/or speed), layer forming apparatus parameters (e.g., speed, location and/or vacuum), or any combination thereof. A forming instructions engine may generate instructions for forming a 3D object in a layerwise (e.g., slice-by-slice) manner. The generated instructions may according to default and/or designated (e.g., override) forming (e.g., printing) processes. The forming instructions may be provided to at least one controller (e.g., FIG. 14, 1406). The at least one controller may implement at least one data assurance measure. The data assurance measure may comprise a security (e.g., level) and/or error detection for at least a part of a file, e.g., that is related to forming instructions for a requested 3D object. The computer system can be part of, or be in communication with, one or more 3D printers (e.g., FIG. 14, 1402) or any of their (e.g., sub-) components. The computer system can include one or more computers (e.g., FIG. 14, 1404). The computer(s) may be operationally coupled to one or more mechanisms of the printer(s). For example, the computer(s) may be operationally coupled to one or more sensors, valves, switches, actuators (e.g., motors), pumps, optical components, and/or energy sources of the printer(s). In some cases, the computer(s) controls aspects of the printer(s) via one or more controllers (e.g., FIG. 14, 1406). The controller(s) may be configured to direct one or more operations of the one or more printer(s). For example, the controller(s) may be configured to direct one or more actuators of printer(s). In some cases, the controller(s) is part of the computer(s) (e.g., within the same unit(s)). In some cases, the controller(s) is separate (e.g., a separate unit) from the computer(s). In some instances, the computer(s) communicates with the controller(s) via one or more input/output (I/O) interfaces (e.g., FIG. 14, 1408). The input/output (I/O) interface(s) may comprise one or more wired or wireless connections to communicate with the printer(s). In some embodiments, the I/O interface comprises Bluetooth technology to communicate with the controller(s).

The computer(s) (e.g., FIG. 14, 1404) may have any number of components. For example, the computer(s) may comprise one or more storage units (e.g., FIG. 14, 1409), one or more processors (e.g., FIG. 14, 1405), one or more memory units (e.g., FIG. 14, 1413), and/or one or more external storage interfaces (e.g., FIG. 14, 1412). In some embodiments, the storage unit(s) includes a hard disk drive (HDD), a magnetic tape drive and/or a floppy disk drive. In some embodiments, the memory unit(s) includes a random access memory (RAM) and/or read only memory (ROM), and/or flash memory. In some embodiments, the external storage interface(s) comprises a disk drive (e.g., optical or floppy drive) and/or a universal serial bus (USB) port. The external storage interface(s) may be configured to provide communication with one or more external storage units (e.g., FIG. 14, 1415). The external storage unit(s) may comprise a portable memory medium. The external storage unit(s) may be a non-volatile source of data. In some cases, the external storage unit(s) is an optical disk (e.g., CD-ROM, DVD, Blu-ray Disc™), a USB-RAM, a hard drive, a magnetic tape drive, and/or a floppy disk. In some cases, the external storage unit(s) may comprise a disk drive (e.g., optical or floppy drive). Various components of the computer(s) may be operationally coupled via a communication bus (e.g., FIG. 14, 1425). For example, one or more processor(s) (e.g., FIG. 14, 1405) may be operationally coupled to the communication bus by one or more connections (e.g., FIG. 14, 1419). The storage unit(s) (e.g., FIG. 14, 1409) may be operationally coupled to the communication bus one or more connections (e.g., FIG. 14, 1428). The communication bus (e.g., FIG. 14, 1425) may comprise a motherboard.

In some embodiments, methods described herein are implemented as one or more software programs (e.g., FIG. 14, 1422 and/or 1424). For example, a pre-formation environment may be implemented as a software program. The software program(s) may be executable within the one or more computers (e.g., FIG. 14, 1404). The software may be implemented on a non-transitory computer readable media. The software program(s) may comprise machine-executable code. The machine-executable code may comprise program instructions. The program instructions may be carried out by the computer(s) (e.g., FIG. 14, 1404). The machine-executable code may be stored in the storage device(s) (e.g., FIG. 14, 1409). The machine-executable code may be stored in the external storage device(s) (e.g., FIG. 14, 1415). The machine-executable code may be stored in the memory unit(s) (e.g., FIG. 14, 1413). The storage device(s) (e.g., FIG. 14, 1409) and/or external storage device(s) (e.g., FIG. 14, 1415) may comprise a non-transitory computer-readable medium. The processor(s) may be configured to read the software program(s) (e.g., FIG. 14, 1422 and/or 1424). In some cases, the machine-executable code can be retrieved from the storage device(s) and/or external storage device(s), and stored on the memory unit(s) (e.g., FIG. 14, 1406) for access by the processor (e.g., FIG. 14, 1405). In some cases, the access is in real-time (e.g., during printing). In some situations, the storage device(s) and/or external storage device(s) can be precluded, and the machine-executable code is stored on the memory unit(s). The machine-executable code may be pre-compiled and configured for use with a machine have a processer adapted to execute the machine-executable code, or can be compiled during runtime (e.g., in real-time). The machine-executable code can be supplied in a programming language that can be selected to enable the machine-executable code to execute in a pre-compiled or as-compiled fashion.

In some embodiments, the computer(s) is operationally coupled with, or comprises, one or more devices (e.g., FIG. 14, 1410). In some embodiments, the device(s) (e.g., FIG. 14, 1410) is configured to provide one or more (e.g., electronic) inputs to the computer(s). In some embodiments, the device(s) (e.g., FIG. 14, 1410) is configured to receive one or more (e.g., electronic) outputs from the computer(s). The computer(s) may communicate with the device(s) via one or more input/output (I/O) interfaces (e.g., FIG. 14, 1407). The input/output (I/O) interface(s) may comprise one or more wired or wireless connections. The device(s) can include one or more user interfaces (UI). The UI may include one or more keyboards, one or more pointer devices (e.g., mouse, trackpad, touchpad, or joystick), one or more displays (e.g., computer monitor or touch screen), one or more sensors, and/or one or more switches (e.g., electronic switch). In some cases, the UI may be a web-based user interface. At times, the UI provides a model design or graphical representation of a 3D object to be printed. The sensor(s) may comprise a light sensor, a thermal sensor, an audio sensor (e.g., microphone), and/or a tactile sensor. In some cases, the sensor(s) are part of the printer(s) (e.g., FIG. 14, 1402). For example, the sensor(s) may be located within a processing chamber of a printer (e.g., to monitor an atmosphere therein). The sensor(s) may be configured to monitor one or more signals (e.g., thermal and/or light signal) that is generated during a printing operation. In some cases, the sensor(s) are part of a component or apparatus that is separate from the printer(s). In some cases, the device(s) is a pre-printing processing apparatus. For example, in some cases, the device(s) can be one or more scanners (e.g., 2D or 3D scanner) for scanning (e.g., dimensions of) a 3D object. In some cases, the device(s) is a post-printing processing apparatus (e.g., a docking station, unpacking station, and/or a hot isostatic pressing apparatus). In some embodiments, the I/O interface comprises Bluetooth technology to communicate with the device(s).

In some embodiments, the computer(s) (e.g., FIG. 14, 1404), controller(s) (e.g., FIG. 14, 1406), printer(s) (e.g., FIG. 14, 1402) and/or device(s) (e.g., FIG. 14, 1410) comprises one or more communication ports. For example, one or more I/O interfaces (e.g., FIG. 14, 1407 or 1408) can comprise communication ports. The communication port(s) may be a serial port or a parallel port. The communication port(s) may be a Universal Serial Bus port (i.e., USB). The USB port can be micro or mini USB. The USB port may relate to device classes comprising 00h, 01h, 02h, 03h, 05h, 06h, 07h, 08h, 09h, 0Ah, 0Bh, 0Dh, 0Eh, 0Fh, 10h, 11h, DCh, E0h, EFh, FEh, or FFh. The communication port(s) may comprise a plug and/or a socket (e.g., electrical, AC power, DC power). The communication port(s) may comprise an adapter (e.g., AC and/or DC power adapter). The communication port(s) may comprise a power connector. The power connector can be an electrical power connector. The power connector may comprise a magnetically coupled (e.g., attached) power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

In some embodiments, the computer(s) is configured to communicate with one or more networks (e.g., FIG. 14, 1420). The network(s) may comprise a wide-area network (WAN) or a local area network (LAN). In some cases, the computer(s) includes one or more network interfaces (e.g., FIG. 14, 1411) that is configured to facilitate communication with the network(s). The network interface(s) may include wired and/or wireless connections. In some embodiments, the network interface(s) comprises a modulator demodulator (modem). The modem may be a wireless modem. The modem may be a broadband modem. The modem may be a “dial up” modem. The modem may be a high-speed modem. The WAN can comprise the Internet, a cellular telecommunications network, and/or a private WAN. The LAN can comprise an intranet. In some embodiments, the LAN is operationally coupled with the WAN via a connection, which may include a firewall security device. The WAN may be operationally coupled the LAN by a high capacity connection. In some cases, the computer(s) can communicate with one or more remote computers via the LAN and/or the WAN. In some instances, the computer(s) may communicate with a remote computer(s) of a user (e.g., operator). The user may access the computer(s) via the LAN and/or the WAN. In some cases, the computer(s) (e.g., FIG. 14, 1404) store and/or access data to and/or from data storage unit(s) that are located on one or more remote computers in communication via the LAN and/or the WAN. The remote computer(s) may be a client computer. The remote computer(s) may be a server computer (e.g., web server or server farm). The remote computer(s) can include desktop computers, personal computers (e.g., portable PC), slate or tablet PC's (e.g., Apple® iPad, Samsung® Galaxy Tab), telephones, smart phones (e.g., Apple® iPhone, Android-enabled device, Blackberry®), or personal digital assistants.

At times, the processor (e.g., FIG. 14, 1405) includes one or more cores. The computer system may comprise a single core processor, a multiple core processor, or a plurality of processors for parallel processing. The processor may comprise one or more central processing units (CPU) and/or graphic processing units (GPU). The multiple cores may be disposed in a physical unit (e.g., Central Processing Unit, or Graphic Processing Unit). The processor may be a single physical unit. The physical unit may be a die. The physical unit may comprise cache coherency circuitry. The processor may include multiple physical units. The physical unit may comprise an integrated circuit chip. The integrated circuit chip may comprise one or more transistors. The integrated circuit chip may comprise at least about 0.2 billion transistors (BT), 0.5 BT, 1BT, 2 BT, 3 BT, 5 BT, 6 BT, 7 BT, 8 BT, 9 BT, 10 BT, 15 BT, 20 BT, 25 BT, 30 BT, 40 BT, or 50 BT. The integrated circuit chip may comprise at most about 7 BT, 8 BT, 9 BT, 10 BT, 15 BT, 20 BT, 25 BT, 30 BT, 40 BT, 50 BT, 70 BT, or 100 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at least about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of at most about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of any value between the afore-mentioned values (e.g., from about 50 mm² to about 800 mm², from about 50 mm² to about 500 mm², or from about 500 mm² to about 800 mm²). The multiple cores may be disposed in close proximity. The close proximity may allow substantial preservation of communication signals that travel between the cores. The close proximity may diminish communication signal degradation. A core as understood herein is a computing component having independent central processing capabilities. The computing system may comprise a multiplicity of cores, which are disposed on a single computing component. The multiplicity of cores may include two or more independent central processing units. The independent central processing units may constitute a unit that read and execute program instructions. The independent central processors may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. The multiplicity of cores may include at least about 2, 10, 40, 100, 400, 1000, 2000, 3000, 4000, 5000, 6000, 7000, 8000, 9000, 10000, 11000, 12000, 13000, 14000 or 15000 cores. The multiplicity of cores may include at most about 1000, 2000, 3000, 4000, 5000, 6000, 7000, 8000, 9000, 10000, 11000, 12000, 13000, 14000, 15000, 20000, 30000, or 40000 cores. The multiplicity of cores may include cores of any number between the afore-mentioned numbers (e.g., from about 2 to about 40000, from about 2 to about 400, from about 400 to about 4000, from about 2000 to about 4000, from about 4000 to about 10000, from about 4000 to about 15000, or from about 15000 to about 40000 cores). In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS). The number of FLOPS may be at least about 1 Tera Flops (T-FLOPS), 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 5 T-FLOPS, 6 T-FLOPS, 7 T-FLOPS, 8 T-FLOPS, 9 T-FLOPS, 10 T-FLOPS, 20 T-FLOPS, 30 T-FLOPS, 50 T-FLOPS, 100 T-FLOPS, 1 P-FLOPS, 2 P-FLOPS, 3 P-FLOPS, 4 P-FLOPS, 5 P-FLOPS, 10 P-FLOPS, 50 P-FLOPS, 100 P-FLOPS, 1 EXA-FLOP, 2 EXA-FLOPS, or 10 EXA-FLOPS. The number of FLOPS may be any value between the afore-mentioned values (e.g., from about 0.1 T-FLOP to about 10 EXA-FLOPS, from about 0.1 T-FLOPS to about 1 T-FLOPS, from about 1 T-FLOPS to about 4 T-FLOPS, from about 4 T-FLOPS to about 10 T-FLOPS, from about 1 T-FLOPS to about 10 T-FLOPS, or from about 10 T-FLOPS to about 30 T-FLOPS, from about 50 T-FLOPS to about 1 EXA-FLOP, or from about 0.1 T-FLOP to about 10 EXA-FLOPS). In some processors (e.g., FPGA), the operations per second may be measured as (e.g., Giga) multiply-accumulate operations per second (e.g., MACs or GMACs). The MACs value can be equal to any of the T-FLOPS values mentioned herein measured as Tera-MACs (T-MACs) instead of T-FLOPS respectively. The FLOPS can be measured according to a benchmark. The benchmark may be a HPC Challenge Benchmark. The benchmark may comprise mathematical operations (e.g., equation calculation such as linear equations), graphical operations (e.g., rendering), or encryption/decryption benchmark. The benchmark may comprise a High Performance LINPACK, matrix multiplication (e.g., DGEMM), sustained memory bandwidth to/from memory (e.g., STREAM), array transposing rate measurement (e.g., PTRANS), Random-access, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). LINPACK may refer to a software library for performing numerical linear algebra on a digital computer. DGEMM may refer to double precision general matrix multiplication. STREAM benchmark may refer to a synthetic benchmark designed to measure sustainable memory bandwidth (in MB/s) and a corresponding computation rate for four simple vector kernels (Copy, Scale, Add and Triad). PTRANS benchmark may refer to a rate measurement at which the system can transpose a large array (global). MPI refers to Message Passing Interface.

At times, the computer system includes hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by NVidia, ATI Technologies, S3 Graphics, Advanced Micro Devices (AMD), or Matrox. The processor(s) may be able to process algorithms comprising a matrix or a vector. The core may comprise a complex instruction set computing core (CISC), or reduced instruction set computing (RISC).

At times, the computer system includes an electronic chip that is reprogrammable (e.g., field programmable gate array (FPGA), e.g., application programming unit (APU)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise an algorithm.

At times, the computer system includes configurable computing, partially reconfigurable computing, reconfigurable computing, or any combination thereof. The computer system may include a FPGA. The computer system may include an integrated circuit that performs the algorithm. For example, the reconfigurable computing system may comprise FPGA, APU, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration.

At times, the computing system includes an integrated circuit that performs the algorithm (e.g., control algorithm). The physical unit (e.g., the cache coherency circuitry within) may have a clock time of at least about 0.1 Gigabits per second (Gbit/s), 0.5 Gbit/s, 1 Gbit/s, 2 Gbit/s, 5 Gbit/s, 6 Gbit/s, 7 Gbit/s, 8 Gbit/s, 9 Gbit/s, 10 Gbit/s, or 50 Gbit/s. The physical unit may have a clock time of any value between the afore-mentioned values (e.g., from about 0.1 Gbit/s to about 50 Gbit/s, or from about 5 Gbit/s to about 10 Gbit/s). The physical unit may produce the algorithm output in at most about 0.1 microsecond (μs), 1 μs, 10 μs, 100 μs, or 1 millisecond (ms). The physical unit may produce the algorithm output in any time between the afore-mentioned times (e.g., from about 0.1 μs, to about 1 ms, from about 0.1 μs, to about 100 μs, or from about 0.1 μs to about 10 μs).

In some instances, the controller(s) (e.g., FIG. 14, 1406) uses real time measurements and/or calculations to regulate one or more components of the printer(s). In some cases, the controller(s) regulate characteristics of the energy beam(s). The sensor(s) (e.g., on the printer) may provide a signal (e.g., input for the controller and/or processor) at a rate of at least about 0.1 KHz 1 KHz, 10 KHz, 100 KHz, 1000 KHz, or 10000 KHz). The sensor(s) may be a temperature and/or positional sensor(s). The sensor(s) may provide a signal at a rate between any of the above-mentioned rates (e.g., from about 0.1 KHz to about 10000 KHz, from about 0.1 KHz to about 1000 KHz, or from about 1000 KHz to about 10000 KHz). The memory bandwidth of the processor(s) may be at least about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processor(s) may be at most about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processor(s) may have any value between the afore-mentioned values (e.g., from about 1 Gbytes/s to about 1000 Gbytes/s, from about 100 Gbytes/s to about 500 Gbytes/s, from about 500 Gbytes/s to about 1000 Gbytes/s, or from about 200 Gbytes/s to about 400 Gbytes/s). The sensor measurements may be real-time measurements. The real-time measurements may be conducted during at least a portion of the 3D printing process. The real-time measurements may be in-situ measurements in the 3D printing system and/or apparatus. The real-time measurements may be during at least a portion of the formation of the 3D object. In some instances, the processor(s) may use the signal obtained from the at least one sensor to provide a processor(s) output, which output is provided by the processing system at a speed of at most about 100 minute (min), 50 min, 25 min, 15 min, 10 min, 5 min, 1 min, 0.5 min (i.e., 30 seconds (sec)), 15 sec, 10 sec, 5 sec, 1 sec, 0.5 sec, 0.25 sec, 0.2 sec, 0.1 sec, 80 milliseconds (ms), 50 ms, 10 ms, 5 ms, or 1 ms. In some instances, the processor(s) may use the signal obtained from the at least one sensor to provide a processor(s) output, which output is provided at a speed of any value between the aforementioned values (e.g., from about 100 min to about 1 ms, from about 100 min to about 10 min, from about 10 min to about 1 min, from about 5 min to about 0.5 min, from about 30 sec to about 0.1 sec, or from about 0.1 sec to about 1 ms). The processor(s) output may comprise an evaluation of the attribute (e.g., temperature) at a location, position at a location (e.g., vertical and/or horizontal), or a map of locations. The location may be on the target surface. The map may comprise a topological and/or attribute (e.g., temperature) related map.

At times, the processor(s) (e.g., FIG. 14, 1405) uses the signal obtained from one or more sensors (e.g., on the printer) in an algorithm that is used in controlling the energy beam. The algorithm may comprise the path of the energy beam. In some instances, the algorithm may be used to alter the path of the energy beam on the target surface. The path may deviate from a cross section of a model corresponding to the requested 3D object. The processor may use the output in an algorithm that is used in determining the manner in which a model of the requested 3D object may be sliced. The processor may use the signal obtained from the at least one sensor in an algorithm that is used to configure one or more parameters and/or apparatuses relating to the 3D printing procedure. The parameters may comprise a characteristic of the energy beam. The parameters may comprise movement of the platform and/or material bed. The parameters may include characteristics of the gas flow system. The parameters may include characteristics of the layer forming apparatus. The parameters may comprise relative movement of the energy beam and the material bed. In some instances, the energy beam, the platform (e.g., material bed disposed on the platform), or both may translate. Alternatively, or additionally, the controller(s) (e.g., FIG. 14, 1410) may use historical data for the control. Alternatively, or additionally, the processor may use historical data in its one or more algorithms. The parameters may comprise the height of the layer of pre-transformed material disposed in the enclosure and/or the gap by which the cooling element (e.g., heat sink) is separated from the target surface. The target surface may be the exposed layer of the material bed.

At times, the memory (e.g., FIG. 14, 1406) comprises a random-access memory (RAM), dynamic random access memory (DRAM), static random access memory (SRAM), synchronous dynamic random access memory (SDRAM), ferroelectric random access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may be complement to that of the AND gate. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

At times, all or portions of the software program(s) (e.g., FIG. 14, 1427) are communicated through the WAN or LAN networks. Such communications, for example, may enable loading of the software program(s) from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software program(s). As used herein, unless restricted to non-transitory, tangible “storage” media, terms such as computer or machine “readable medium” refer to any medium that participates in providing instructions to a processor for execution. Hence, a machine-readable medium, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases. Volatile storage media can include dynamic memory, such as main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and/or infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from device, such as a Universal Serial Bus (USB) memory stick, or/and a hard disk. Many of these forms of computer readable media may be involved in carrying one or more sequences of one or more instructions to a processor for execution.

At times, the computer system monitors and/or controls various aspects of the 3D printer(s). In some cases, the control is via controller(s) (e.g., FIG. 14, 1406). The control may be manual and/or programmed. The control may comprise an open loop control or a closed loop control (e.g., including feed forward and/or feedback) control scheme. The closed loop control may utilize signals from the one or more sensors. The control may utilize historical data. The control scheme may be pre-programmed. The control scheme may consider an input from one or more sensors (described herein) that are connected to the control unit (i.e., control system or control mechanism) and/or processor(s). The computer system (including the processor(s)) may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., monitor) may output various parameters of the 3D printing system (as described herein) in real time or in a delayed time. The output unit may output the current 3D printed object, the ordered 3D printed object, or both. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may output a (e.g., current, or historical) state of at least one control variable that is controlled via integrated and/or adaptive control. The output may comprise an indication of (e.g., which of) at least two control variables that are controlled via integrated control. The output may comprise an indication of (e.g., any) processing operation that comprises adaptive control. The output may comprise an indication of (e.g., a duration) of an adaptive timing for the processing operation that is under adaptive control. The computer may generate a report comprising various parameters of the 3D printing system, method, and or objects at predetermined time(s), on a request (e.g., from an operator), and/or at a whim. The output unit may comprise a screen, printer, a light source (e.g., lamp), or speaker. The control system may provide a report. The report may comprise any items recited as optionally output by the output unit.

At times, the systems, methods, and/or apparatuses disclosed herein comprise providing data assurance for instruction data related to forming a requested 3D object. The instructions data may be generated considering a requested 3D object. The request can include a geometric model (e.g., a CAD file) of the requested 3D object. Alternatively, or additionally, a model of the requested 3D object may be generated. The model may be used to generate (e.g., 3D forming) instructions. The software program(s) (e.g., FIG. 14, 1422 and/or 1424) may comprise the 3D forming instructions. The 3D forming instructions may exclude the 3D model. The 3D forming instructions may be based on the 3D model. The 3D forming instructions may take the 3D model into account. The 3D forming instructions may be alternatively or additionally based on simulations (e.g., a control model). The 3D forming instructions may use the 3D model. The 3D forming instructions may comprise using a calculation (e.g., embedded in a software program(s)) that considers the 3D model, simulations, historical data, sensor input, or any combination thereof. The 3D forming instructions may be provided to at least one controller (e.g., FIG. 14, 1406) that implements at least one data assurance (e.g., measure). The data assurance measure may comprise a security (e.g., level) and/or error detection for at least a part of a file, e.g., that is related to forming instructions for a requested 3D object. The data assurance measure may comprise computing a calculation (e.g., a hash value). The at least one controller may compute the calculation during generation of forming instructions, during generation of layout instructions, prior to the 3D forming procedure, after the 3D forming procedure, or any combination thereof. The at least one controller may compute the calculation during the 3D forming procedure (e.g., in real-time), during the formation of the 3D object, prior to the 3D forming procedure, after the 3D forming procedure, or any combination thereof. The at least one controller may compute a calculation in the interval between activations of a transforming agent. For example, between pulses of an energy beam, during the dwell time of the energy beam, before the energy beam translates to a new position, while the energy beam is not translating, while the energy beam does not impinge upon the target surface, while the (e.g., at least one) energy beam impinges upon the target surface, or any combination thereof. For example, between depositions of a binding agent, during a persistence time of the binding agent, before a dispenser (e.g., that provides the binding agent) translates to a new position, while the dispenser is not translating, while the binding agent is not provided to the target surface, while the binding agent is provided to the target surface, or any combination thereof. The processor may compute a calculation in the interval between a movement of at least one guidance (e.g., optical) element from a first position to a second position, while the at least one optical element moves (e.g., translates) to a new (e.g., second) position. For example, the processor(s) may compute a calculation while the energy beam translates and does substantially not impinge upon the exposed surface. For example, the processor(s) may compute the calculation while the energy beam does not translate and impinges upon the exposed surface. For example, the processor(s) may compute the calculation while the energy beam does not substantially translate and does substantially not impinge upon the exposed surface. For example, the processor(s) may compute the calculation while the energy beam does translate and impinges upon the exposed surface. The transforming agent may be provided along a path that corresponds to a cross section of the model of the 3D object. For example, a translation of the energy beam may be translation along at least one energy beam path. For example, a dispenser movement may be along at least one dispenser path.

### EXAMPLES

The following are illustrative and non-limiting examples of methods of the present disclosure.

### Example 1

For a first virtual geometric model of a first requested 3D object having dimensions of 5 centimeters (cm) in width×20 cm in length×5 cm in height (e.g., FIG. 2A, 205), a pre-print environment application was used to generate a printing instructions file for printing the first requested 3D object. The pre-print environment application included a first stage (e.g., FIG. 2A, 200) in which the printing instructions file was generated comprising printing procedures for transforming layers of material using a layerwise manufacturing process as described herein. This process was repeated for a second requested 3D object (e.g., 255) and for a third requested 3D object (e.g., 257). The second requested 3D object and the third requested 3D object each had dimensions (at the base) of 8.65 cm in width×8.65 cm in length×5.5 cm in height (e.g., FIG. 2B, 255 and 257). The 3D printing included layer-wise melting of powder material disposed in sequential layers to form a powder bed. Each of the powder layers had an average thickness of about 50 μm. The pre-print environment application included a second stage (e.g., FIG. 2B, 250) comprising a representation of a build volume of the 3D printer. The first virtual geometric model (e.g., FIG. 2B, 270), having the printing instructions file from the first stage associated therewith, was arranged alongside the second and the third virtual geometric models (e.g., FIG. 2B, 255 and 257). The arrangement of the three (3) virtual geometric models was used to form a layout instructions file for printing the three requested 3D objects in a print cycle of the 3D printer in the second stage. The layout instructions file and the printing instructions file were stored as an instructions data file that was encrypted. The encrypted instructions data file was transmitted to a 3D printer. The 3D printer had a 320 mm diameter and 400 mm maximal height container, in which Inconel 718 powder of average particle size 35 μm was deposited to form a powder bed. The container was disposed in an enclosure to separate the powder bed from an ambient environment. The enclosure was purged with Argon gas. The 3D printer was authenticated according to its manufacturing model number, and granted access to the encrypted instructions data file. A controller was used to command a 1000 W fiber laser beam to melt portions of the powder bed to form respective portions of the 3D objects above a platform, according to a portion of the encrypted instructions data file that was read by the 3D printer. The controller included the functionality depicted in FIG. 13, 1300. The respective portions of the 3D objects were printed using the layer-wise melting of powder material that was disposed in sequential layers. Selected portions of the sequentially deposited powder layers were melted in accordance with respective slices of one or more virtual models of the three requested 3D objects.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1.-12. (canceled)

13. An apparatus for printing at least one three-dimensional object, the apparatus comprising:
one or more controllers configured to operatively couple with a transforming agent generator configured to generate a transforming agent to transform a starting material to a transformed material to print at least a portion of the at least one three-dimensional object, the one or more controllers comprising a power connector, the one or more controllers being collectively or individually configured to:
(i) authenticate, or direct authentication of, an identity of an accessing party, the accessing party excluding (a) an owning party of a printer configured to print the at least one three-dimensional object, (b) a controlling party of the printer, and/or (c) an operating party of the printer;
(ii) process at least one encrypted file to yield instructions for printing the at least one three-dimensional object, the accessing party being able to access the at least one encrypted file; and
(iii) at least in part by using the instructions, direct the transforming agent generator to generate the transforming agent to transform the starting material to the transformed material to print the at least one three-dimensional object in a printing cycle.

14. (canceled)

15. (canceled)

16. (canceled)

17. (canceled)

18. The apparatus of claim 13, wherein the one more controllers are configured to process the at least one encrypted file, wherein at least a portion of the at least one encrypted file is generated by a pre-print application software; and wherein the one or more controllers are configured to utilize an output of the pre-print application software to yield the instructions.

19. (canceled)

20. (canceled)

21. The apparatus of claim 18, wherein the pre-print application software is configured to perform operations associated with: (A) a region of interest designation in a model of the at least one three-dimensional object requested, (B) an estimation of a likelihood of print failure of the requested three-dimensional object model, and/or (C) a simulation of printing the requested three-dimensional object model, wherein the requested three-dimensional object model is associated with a three-dimensional object of the at least one three-dimensional object.

22. The apparatus of claim 18, wherein the pre-print application software is configured to perform operations associated with: (A) a requested three-dimensional object model, and/or (B) the instructions for the printer to print the requested three-dimensional object model, wherein the requested three-dimensional object model is associated with a three-dimensional object of the at least one three-dimensional object.

23. The apparatus of claim 13, wherein the one or more controllers are configured to process the at least one encrypted file to yield the instructions that comprise a geometric model of the at least one three-dimensional object requested.

24. The apparatus of claim 23, wherein the one or more controllers are configured to process the at least one encrypted file to yield layout instructions comprising commands for the printer to print the at least one three-dimensional object (i) according to a requested arrangement comprising placement of the at least one three-dimensional object in a build volume in which the at least one three-dimensional object is printed during the printing, (ii) according to a specified sequence with which one or more transforming agents of the printer are operated, the one or more transforming agents comprising the transforming agent, and/or (iii) to incorporate requested marking on the at least one three-dimensional object during the printing.

25. The apparatus of claim 13, wherein the one or more controllers are configured to authenticate, or direct authentication of, the identity of the accessing party that is an entity that (i) develops a pre-print application software, (ii) owns the pre-print application software, (iii) controls the pre-print application software, and/or (iv) operates the pre-print application software; and wherein the one or more controllers are configured to utilize an output of the pre-print application software to yield the instructions.

26. The apparatus of claim 13, wherein the printer is configured to embed identification information comprising a type of the printer, or a location of the printer.

27. The apparatus of claim 13, wherein the one or more controllers are configured to authenticate, or direct authentication of, the identity of the accessing party at least in part by considering a system type and/or a system version, the system being a three-dimensional printing system configured to print the at least one three-dimensional object.

28. The apparatus of claim 13, wherein the one or more controllers are configured to authenticate, or direct authentication of, the identity of the accessing party, the authentication being granted at least in part by considering a system type and/or a system version, the system being a pre-print environment application.

29. The apparatus of claim 13, wherein the one or more controllers are configured to authenticate, or direct authentication of, the identity of the accessing party, the authentication being granted for at least one manufacturing device of manufacturing devices configured for the printing of the at least one three-dimensional object.

30. The apparatus of claim 13, wherein the one or more controllers are configured to authenticate, or direct authentication of, the identity of the accessing party, the authentication being granted for a pre-print environment application that is of a same type, same version, and/or that is developed by an entity.

31. The apparatus of claim 13, wherein the one or more controllers are configured to authenticate, or direct authentication of, the identity of the accessing party, the authentication being granted for a pre-print environment application that is controlled, owned, and/or operated by an entity.

32. The apparatus of claim 13, wherein the one or more controllers are configured to process the at least one encrypted file at least in part by decrypting at least a portion of the at least one encrypted file via use of a decryption key, wherein the decryption key is provided by a pre-print environment.

33. The apparatus of claim 13, wherein the one or more controllers are configured to process the at least one encrypted file at least in part by decrypting at least a portion of the at least one encrypted file via use of a decryption key, wherein the decryption key is provided by a manufacturing device configured for the printing of the at least one three-dimensional object.

34. The apparatus of claim 13, wherein the one or more controllers are configured to authenticate, or direct authentication of, the identity of the accessing party, the authentication being related to a date.

35. The apparatus of claim 13, wherein the one or more controllers are configured to authenticate, or direct authentication of, the identity of the accessing party, the authentication being configured to protect from damage to an intellectual property (i) of a design of the at least one three-dimensional object, (ii) of the at least one three-dimensional object printed, and/or (iii) of the instructions for the printing of the at least one three-dimensional object.

36. The apparatus of claim 35, wherein the one or more controllers are configured to authenticate, or direct authentication of, the identity of the accessing party, the authentication being configured to protect from damage to the intellectual property of the instructions for the printing of the at least one three-dimensional object, the instructions including one or more process parameters of the printing.

37. The apparatus of claim 35, wherein the one or more controllers are configured to authenticate, or direct authentication of, the identity of the accessing party, the authentication being configured to protect from damage to the intellectual property of the design of the at least one three-dimensional object.

38. A method for printing at least one three-dimensional object, the method comprising (a) providing the apparatus of claim 13; and (b) using the apparatus to print the at least one three-dimensional object.

39. Non-transitory computer readable printing instructions, the printing instructions, when read by one or more processors operatively coupled with, or include, the apparatus of claim 13, are configured to execute one or more operations associated with the apparatus to print the at least one three-dimensional object, the non-transitory computer readable printing instructions being inscribed on one or more media.
